(19) United States
(12) Patent Application Publication
(10) Pub. No.: US 2009/0086126 A1
(43) Pub. Date: Apr. 2, 2009

(54) Polarizing plate and liquid crystal display device using the same

(75) Inventors: Ikuko Ohgaru, Kanagawa (JP); Eiichiro Aminaka, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 11/991,423

(22) PCT Filed: Sep. 5, 2006
(86) PCT No.: PCT/JP2006/317933

§ 371 Date: Mar. 4, 2008

(30) Foreign Application Priority Data
Sep. 5, 2005 (JP) 2005-256808

(51) Int. Cl. G02F 1/1335; G02B 5/30

(52) U.S. Cl. 349/96; 359/483

(57) ABSTRACT

A polarizing plate comprising: a first protective film; a polarizer; and a second protective film, in this order, wherein at least one of the first protective film and the second protective film has an adhesive layer, and wherein the at least one of the first protective film and the second protective film has a modulus of elasticity E satisfying numerical formula (1), and the adhesive layer undergoes creep deformation of less than 70 μm when a piece of which having a size of 10 mm in width and 10 mm in length is stuck on an alkali-free glass plate and a load of 200 g is applied thereto in an atmosphere of 50° C. for 1 hour: numerical formula (1): 500 MPa≦E≦3000 MPa.

### TECHNICAL FIELD

The present invention relates to a polarizing plate having a high optical compensatory performance and excellent reworkability and being so improved as to prevent leakage of light at the periphery of the screen generated by change in temperature and humidity or when a liquid crystal display device is in a state of being continuously switched on, and a liquid crystal display device using the same.

### BACKGROUND ART

Liquid crystal display devices are widely used as monitors for personal computers or mobile devices and for TV sets due to their various advantages of being operable at a low voltage, consuming little power and permitting to reduce the thickness. As such liquid crystal display devices, there have been proposed liquid crystal display devices of various modes different from each other in the state of alignment of liquid crystal molecules within the liquid crystal cell. TN mode has so far been the main mode wherein molecules are aligned in a state of being twisted about 90° from the lower substrate of the liquid crystal cell toward the upper substrate.

A liquid crystal display device is generally constituted by a liquid crystal cell, an optical compensatory sheet and a polarizer. The optical compensatory sheet is used for removing coloration of an image or for enlarging the viewing angle and, as the sheet, a stretched birefringence film or a film comprising a transparent film having coated thereon a liquid crystal is used.

For example, Japanese Patent No. 2587398 discloses the technique of applying to a TN mode liquid crystal cell an optical compensatory sheet prepared by coating a discotic liquid crystal on a triacetyl cellulose film, aligning the liquid crystal and fixing the alignment, to thereby enlarge the viewing angle. With liquid crystal display devices for TV set use which are of a large size and expected to be viewed at various angles requirement for viewing angle dependence is so severe that even the above-mentioned technique fails to satisfy the severe requirement. Thus, there have been studied liquid crystal display devices different from the TN mode liquid crystal display devices, such as IPS (In-Plane Switching) mode, OCB (Optically Compensatory Bend) mode or VA (Vertically Aligned) mode ones. In particular, the VA mode liquid crystal display device gives a high contrast and can be produced in a high yield; thus being noted as liquid crystal display devices for TV set use.

Now, a cellulose acylate film has a special feature that, in comparison with other polymer films, it has a high optical isotropy (low retardation value). Therefore, it usually finds application to uses which require optical isotropy, such as a polarizing plate.

On the other hand, an optical compensatory sheet (retardation film) for a liquid crystal display device is reversely required to have optical anisotropy (high retardation value). In particular, an optical compensatory sheet for VA mode is required to have a retardation in plane (Re₅₉₀) of from 20 to 200 nm and a retardation along the thickness of the film (Rth₅₉₀) of from 0 to 400 nm. Therefore, as the optical compensatory sheet, synthetic polymer films having a high retardation value, such as a polycarbonate film and a polysulfone film, have commonly been used.

As is described above, it has been a general principle in the technical field of optical material that synthetic polymer films be used where an optical anisotropy (high retardation value) is required for polymer films whereas a cellulose acylate film be used where an optical isotropy (low retardation value) is required.

Reversing this conventional general principle, EP 911656A proposes a cellulose acetate film having an enough high retardation value to find application to the use which requires the optical anisotropy. In this proposal, in order to realize a high retardation value with cellulose triacetate, an aromatic compound having at least 2 aromatic rings, in particular, a compound having 1,3,5-triazine rings, is added thereto, followed by stretching treatment. It is generally known that cellulose triacetate is a high molecular material which is so difficult to stretch that it is difficult to increase its birefringence index. In the proposal, however, birefringence index is increased by aligning the additive simultaneously upon the stretching treatment, thus realizing a high retardation value. This film has the advantage that, since it can also function as the protective film of the polarizing plate, it can provide an inexpensive, thin liquid crystal display device.

JP-A-2002-71957 discloses an optical film containing cellulose ester which has an acyl group containing from 2 to 4 carbon atoms as a substituent and satisfies the formulae 2.0≦A+B≦3.0 and A<2.4 wherein A represents the substitution degree of acetyl group and B represents the substitution degree of propionyl group or butyryl group.

JP-A-2003-270442 discloses a polarizing plate for use in a VA mode liquid crystal display device, which plate has a polarizer and an optically biaxial film of mixed fatty acid ester of cellulose and in which device the optically biaxial film of mixed fatty acid ester of cellulose is disposed between a liquid crystal cell and the polarizer.

Techniques disclosed in the above-mentioned literature are effective in that they provide an inexpensive and thin liquid crystal display device. In recent years, however, liquid crystal display devices have rapidly become large-sized and, with it, there have arisen a problem of panel loss due to lamination failure upon laminating a polarizing plate onto a panel. This problem can be solved by a polarizing plate having a good reworkability which, even when wrongly laminated onto a panel, can easily be peeled from the panel. Thus, it has increasingly been desired to impart a good reworkability to a polarizing plate.

As to techniques for imparting the above-described reworkability, there are illustrated those which are described in JP-A-8-34963, JP-A-2003-232926, JP-A-2004-191906 and JP-A-2004-206038. JP-A-8-34963 discloses a technique of improving reworkability by properly selecting formulation of an adhesive. Also, JP-A-2003-232926, JP-A-2004-191906 and JP-A-2004-206038 disclose techniques of improving reworkability by selecting physical properties, such as modulus of elasticity upon absorption of water or tear strength, of a protective film.

On the other hand, there has arisen a problem of leakage of light at the periphery of a screen upon black display due to shrinkage stress of a polarizing plate. The polarizing plate tends to shrink due to change in environmental temperature and humidity but, since it is fixed to a liquid crystal cell by an adhesive layer, a stress is generated locally (particularly at the periphery of a screen) in the protective layer of the polarizing plate, the adhesive layer and the glass substrate of a liquid crystal cell, and leakage of light occurs due to change in birefringence based on photoelasticity of each of them.

### DISCLOSURE OF THE INVENTION

A subject of the invention is to provide a polarizing plate which has a high optical compensatory performance and excellent reworkability and which does not suffer leakage of light at the periphery of the screen generated by change in temperature and humidity or when a liquid crystal display device is in a state of being continuously switched on, and a liquid crystal display device using the polarizing plate.

The present inventor has found that the above-mentioned problems can be solved by adjusting modulus of elasticity of an adhesive layer for sticking the polarizing plate to the glass plate of a liquid crystal cell and modulus of elasticity of a protective film of the polarizing plate to specific levels.

The present invention is as follows.

(1) A polarizing plate comprising:

a first protective film;

a polarizer; and

a second protective film, in this order,

wherein at least one of the first protective film and the second protective film has an adhesive layer, and

wherein the at least one of the first protective film and the second protective film has a modulus of elasticity E satisfying numerical formula (1), and the adhesive layer undergoes creep deformation of less than 70 μm when a piece of which having a size of 10 mm in width and 10 mm in length is stuck on an alkali-free glass plate and a load of 200 g is applied thereto in an atmosphere of 50° C. for 1 hour:

500 MPa≦E≦3000 MPa. numerical formula (1)

(2) The polarizing plate as described in (1) above,

wherein the adhesive layer undergoes creep deformation of less than 40 μm when a piece of which having a size of 10 mm in width and 10 mm in length is stuck on an alkali-free glass plate and a load of 200 g is applied thereto in an atmosphere of 25° C. for 1 hour.

(3) The polarizing plate as described in (1) or (2) above,

wherein at least one of the first protective film and the second protective film has a retardation in plane of the film Re_{λ} and a retardation along a thickness of the film Rth_{λ} satisfying numerical formulae (2) and (3):

0≦Re₅₉₀≦200 numerical formula (2)

0≦Rth₅₉₀≦400 numerical formula (3)

wherein Re_{λ} and Rth_{λ} each represents a value at a wavelength of λ nm (unit: nm).

(4) The polarizing plate as described in any of (1) to (3) above,

wherein at least one of the first protective film and the second protective film is a film comprising a cellulose acylate obtained by substituting hydroxyl groups of glucose unit constituting cellulose with an acyl group containing 2 or more carbon atoms, and satisfying formulae (6) and (7):

2.0≦DS₂+DS₃+DS₆≦3.0 (6)

DS₆/(DS₂+DS₃+DS₆)≧0.315 (7)

wherein DS₂ represents a substitution degree of hydroxyl groups at 2-position of the glucose unit by the acyl group;

DS₃ represents a substitution degree of hydroxyl groups at 3-position of the glucose unit by the acyl group; and

DS₆ represents a substitution degree of hydroxyl groups at 6-position of the glucose unit by the acyl group.

(5) The polarizing plate as described in (4) above,

wherein the acyl group is an acetyl group.

(6) The polarizing plate as described in any of (1) to (3) above,

wherein at least one of the first protective film and the second protective film is a film comprising a mixed fatty acid ester of a cellulose obtained by substituting hydroxyl groups of cellulose with an acetyl group and an acyl group containing 3 or more carbon atoms, and satisfying formulae (8) and (9):

2.0≦A+B≦3.0 (8)

0<B (9)

wherein A and B each represents a substitution degree of an acyl group substituting the hydroxyl groups of cellulose;

A represents a substitution degree by an acetyl group; and

B represents a substitution degree by an acyl group containing 3 or more carbon atoms.

(7) The polarizing plate as described in any of (1) to (3) above,

wherein at least one of the first protective film and the second protective film is a film comprising a cyclic polyolefin film.

(8) The polarizing plate as described in any of (1) to (7) above,

wherein the at least one of the first protective film and the second protective film comprises at least one retardation increasing agent comprising a rod-like compound or a discotic compound.

(9) The polarizing plate as described in any of (1) to (8) above,

wherein an optically anisotropic layer is provided on the at least one of the first protective film and the second protective film.

(10) The polarizing plate as described in any of (1) to (9) above,

wherein the at least one of the first protective film and the second protective film comprises at least one of a plasticizer, an ultraviolet ray absorbent, a peeling accelerator, a dye and a matt agent.

(11) The polarizing plate as described in any of (1) to (10) above,

wherein the at least one of a hard coat layer, an anti-glare layer and an anti-reflection layer is provided on the at least one of the first protective film and the second protective film.

(12) A liquid crystal display device comprising:

a liquid crystal cell; and

a pair of polarizing plates sandwiching the liquid crystal cell,

wherein the pair of polarizing plates includes a polarizing plate as described in any of (1) to (11) above.

(13) The liquid crystal display device as described in (12) above,

wherein the first protective film, which is provided on a liquid crystal cell side of the polarizing plate, has a modulus of elasticity E satisfying the numerical formula (1).

(14) The liquid crystal display device as described in (12) or (13) above,

wherein the pair of polarizing plates is disposed so that transparent axes of the pair of polarizing plates cross at right angles with each other, and the transparent axes cross at right angles with, or are parallel to, sides of the polarizing plate.

(15) The liquid crystal display device as described in any of (12) to (14) above,

wherein the liquid crystal cell is of VA mode.

### BRIEF DESCRIPTION OF THE DRAWING

FIG. 1 is a schematic diagram showing one example of the method of laminating a cellulose acylate film upon preparation of a polarizing plate relating to the invention;

FIG. 2 is a schematic diagram showing one example of a cross-sectional structure of the polarizing plate of the invention;

FIG. 3 is a schematic diagram showing one example of a cross-sectional structure of a liquid crystal display device of the invention; and

FIGS. 4A and 4B illustrate the method of measuring the degree of creep of the adhesive of the invention,

wherein 1 represents a polarizer; 2 represents a transmission axis; 3 represents cellulose acylate film; 4 represents a slow axis; 11 represents a polarizer; 12 represents protective film (on the liquid crystal cell side); 13 represents protective film (on the side opposite to the liquid crystal cell); 14 represents a functional film (hard coat layer, anti-glare layer, anti-reflection layer); 21 represents a polarizer; 22 represents TAC1: protective film on the liquid crystal cell side; 23 represents TAC2: protective film on the side opposite to the liquid crystal cell; 31 represents a polarizer; 32 represents TAC3: protective film on the liquid crystal cell side; 33 represents TAC2: protective film on the side opposite to the liquid crystal cell; 40 represents a VA mode liquid crystal cell; 50 represents viewing side; 60 represents backlight side; 70 represents a glass plate; 80 represents an adhesive layer; and 90 represents a polarizing plate

### BEST MODE FOR CARRYING OUT THE INVENTION

The invention will be described in more detail below.

Additionally, in this specification, the phrase “(numerical value 1) to (numerical value 2)” used for representing physical values or characteristic values means “(numerical value 1) to (numerical value 2) inclusive”. Also, the term “(meth)acrylate” as used in this specification means “at least either of acrylate and methacrylate”. The same applies to the term “(meth)acrylic acid” or the like.

### <Adhesive Layer>

First, an adhesive layer relating to the invention will be described below.

In the case when a liquid crystal display device is left at a high temperature, when the environment of the liquid crystal display device is changed from high temperature and high humidity to low temperature and low humidity, or when a backlight is displayed continuously, the polarizing plate undergoes change in dimension and, with this dimensional change, there tends to arise foaming of the adhesive layer or delamination of the liquid crystal cell from its adherend. With conventional adhesive layers, molecular mass or degree of cross-linking of the adhesive is increased to resist the severe using conditions as described above.

Thus, in the invention, foaming or delamination to be generated under severe conditions and dimensional change of the polarizing plate as described above are prevented by making the adhesive layer harder by three-dimensional cross-linking (gelation), whereas adhesion force is preferably secured by using a monomer whose homopolymer shows a low Tg, i.e., soft (meth)acrylate. Such adjustment can be attained also through molecular mass distribution (ratio of a high molecular component to a low molecular component).

The balance between adhesion performance and hardness can be adjusted by selecting the constituting ratio of a monomer component constituting the copolymer (low Tg or high Tg) and the degree of three-dimensional cross-linking (gel fraction).

### [(Meth)Acrylic Copolymer: (A) {and A₁ and A₂}]

(a₁)(a₁₁)(a₂₁)

(Meth)acrylate monomers whose homopolymers have a Tg of less than −30° C.

In order to relax the internal stress, (meth)acrylate monomers whose homopolymers have a are used. It is preferred to use monomers whose homopolymers have a Tg of less than −40° C., with homopolymers having a Tg of less than −50° C. being more preferred. Examples of (meth)acrylates whose homopolymers have a Tg of less than −30° C. include ethyl acrylate, propyl acrylate, n-butyl acrylate, n-pentyl acrylate, n-hexyl acrylate, n-heptyl acrylate, n-octyl acrylate, n-nonyl acrylate, n-decyl acrylate, n-methoxyethyl acrylate, ethoxymethyl acrylate, 2-ethoxyethyl acrylate, 3-ethoxypropyl acrylate, n-octyl methacrylate, n-nonyl methacrylate, n-decyl methacylate, n-undecyl methacrylate, n-dodecyl methacrylate and n-tridecyl methacrylate.

(a₂)(a₁₂)(a₂₂)

Vinyl group-having compounds whose homopolymers have a Tg of less than −30° C.

Examples of vinyl group-having compounds whose homopolymers have a Tg of −30° C. or more include (meth)acrylates such as methyl acrylate, i-butyl acrylate, t-butyl acrylate, cyclohexyl acrylate, benzyl acrylate, n-undecyl acrylate, n-dodecyl acrylate, n-tridecyl acrylate, n-tetradecyl acrylate, n-pentadecyl acrylate, n-hexadecyl acrylate, methyl methacrylate, ethyl methacrylate, propyl methacylate, n-butyl methacrylate, i-butyl methacrylate, t-butyl methacrylate, n-pentyl methacrylate, n-hexyl methacrylate, cyclohexyl methacrylate, benzyl methacrylate, n-heptyl methacrylate, n-tetradecyl methacrylate, n-pentadecyl methacrylate and n-hexadecyl methacrylate. As other vinyl compounds, there can be illustrated vinyl acetate, styrene, methylstyrene, vinyltoluene, acrylonitrile, (meth)acrylamide and N-methylacrylamide.

### [Measurement of Tg]

Measurement of Tg of the homopolymer was performed by using a differential scanning calorimeter (DSC2910; manufactured by TA Instruments Co.). A sample polymer was placed in an aluminum-made pan and heated from −160° C. to +100° C. at a rate of 10° C./min, then cooled from +100° C. to −160° C. at a rate of 10° C./min, and Tg was determined from the data obtained during the temperature-decreasing process.

In the invention, the proportion of the repeating unit RU_{S} derived from the above-described (meth)acrylate whose homopolymer has a Tg of less than −30° C. to the repeating unit RU_{H} derived from the above-described vinyl compound whose homopolymer has a Tg of −30° C. or more is: 75 parts by mass of RU_{S} to 25 parts by mass or less of RU_{H} in terms of monomer units. Although the content of RU_{S} may be 100 parts by mass and the content of RU_{H} may be 0 part by mass, it is preferred in the invention to use a copolymer of the (meth)acrylate whose homopolymer has a Tg of less than −30° C. and the vinyl compound whose homopolymer has a Tg of −30° C. or more. Such copolymer serves to increase agglomerating properties of the adhesive layer to thereby improve the performance of the adhesive layer such as adhesion properties, water resistance, transparency and workability.

Further, it is preferred that the content of RU_{S} is 85 parts by mass or more and the content of RU_{H} is 15 parts by mass or less and, most preferably, the content of RU_{S} is 95 parts by mass or more and the content of RU_{H} is 5 parts by mass or less. (In this specification, mass ratio is equal to weight ratio.)

(a₃)(a₁₃)(a₂₃)

Monomers Having a Functional Group Capable of Reacting with a Multi-Functional Compound (B)

Examples of the monomer having a functional group capable of reacting with a multi-functional compound include monomers having a carboxyl group such as (meth)acrylic acid, β-carboxyethyl acrylate, itaconic acid, crotonic acid, maleic acid, maleic anhydride and butyl maleate; monomers having a hydroxyl group such as 2-hydroxyethyl (meth)acrylate, 2-hydroxypropyl (meth)acrylate, 4-hydroxybutyl (meth)acrylate, chloro-2-hydroxypropyl (meth)acrylate, diethylene glycol mono(meth)acrylate and allyl alcohol; monomers having an amino group such as aminomethyl (meth)acrylate, dimethylaminomethyl (meth)acrylate, dimethylaminoethyl (meth)acrylate, dimethylaminopropyl (meth)acrylate and vinylpyridine; monomers having an epoxy group such as glycidyl (meth)acrylate; and monomers having an acetacetyl group such as acetacetoxyethyl (meth)acrylate. These may be used independently or in combination thereof.

Of these, monomers having a carboxyl group and monomers having a hydroxyl group are preferred.

The (meth)acrylic copolymer (A) {and (A1) and (A₂)} to be described hereinafter} to be used in the invention as a major component of the composition of (meth)acrylic copolymer forming the adhesive layer is a copolymer of the above-described (meth)acrylate (a₁){or (a₁₁) or (a₂₁)} whose homopolymer has a Tg of less than −30° C., the vinyl compound (a₂){or (a₁₂) or (a₂₂)} whose homopolymer has a Tg of −30° C. or more, and 10 parts by mass or less, preferably 0.5 to 10 parts by mass, per 100 parts by mass of the sum of (a₁){or (a₁₁) or (a₂₁)} and (a₂){or (a₁₂) or (a₂₂)}, of the monomer (a₃){or (a₁₃) or (a₂₃)} having a functional group capable of reacting with the multi-functional compound (B) to be described hereinafter.

### [Multi-Functional Compound: (B)]

The adhesive layer for the polarizing plate of the invention contains the multi-functional compound (B) having a reactive functional group. The functional group this compound has is a group capable of reacting with the reactive functional group of the (meth)acrylic polymer (A) {and (A₁) and (A₂)}, and the compound has at least one, preferably 2 to 4, functional groups within the molecule.

Examples of such multi-functional compound (B) include isocyanate series compounds, epoxy series compounds, amine series compounds, metal chelate series compounds and aziridine series compounds.

Examples of the isocyanate series compounds include trilene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylenepolyphenyl isocyanate and adducts thereof with a polyol such as trimethylolpropane.

Also, examples of the epoxy series compounds include bisphenol A, epichlorohydrin type epoxy resin, ethylene glycol glycidyl ether, polyethylene glycol diglycidyl ether, glycerin diglycidyl ether, glycerin triglycidyl ether, 1,6-hexanediol diglycidyl ether, trimethylolpropane triglycidyl ether, diglycidylaniline, diglycidylamine. N,N,N′,N′-tetraglycidyl-m-xylenediamine and 1,3-bis(N,N′-diglycidylaminomethyl)cyclohexane.

Further, examples of the amine series compounds include hexamethylenediamine, triethyldiamine, polyethyleneimine, hexamethylenetetramine, diethylenetriamine, triethyltetramine, isophoronediamine, urea resin, amino resins such as melamine resin, and methylene resin.

Still further, examples of the metal chelate compounds include those compounds wherein a polyvalent metal such as aluminum, iron, copper, zinc, tin, titanium, nickel, antimony, magnesium, vanadium, chromium and zirconium coordinates with acetylacetone or ethyl acetacetate.

Yet further, examples of the aziridine compounds include N,N′-diphenylmethane-4,4′-bis(1-aziridinecarboxide), N,N′-toluene-2,4-bis(1-aziridinecarboxamide), triethylenemelamine, bisisophthaloyl-1-(2-methylaziridine), tri-1-aziridinylphosphinoxide, N,N′-hexamethylene-1,6-bis(1-aziridinecarboxide), trimethylolpropane-tri-β-aziridinyl propionate and tetramethylolmethane-tri-β-aziridinyl propionate.

In addition, dialdehydes, methylol polymers, acids, acid anhydrides and amino acids can be used as well.

Such multi-functional compound (B) is used in an amount of usually from 0.005 to 5 parts by mass, preferably from 0.01 to 3 parts by mass, per 100 parts by mass of the above-mentioned high molecular (meth)acrylic copolymer (A){or (A₁) or (A₂)}. An adequate three-dimensional cross-linked structure is formed between the multi-functional compound (B) and the high molecular (meth)acrylic copolymer by using the multifunctional compound (B) in such amount. Additionally, the multi-functional compounds (B) may be used independently or in combination thereof.

### [Production of (Meth)Acrylic Copolymer]

Any known method can be employed for producing the (meth)acrylic copolymer (A) constituting the adhesive layer for the polarizing plate of the invention.

For example, a high molecular (meth)acrylic copolymer (A₁) having a mass-average molecular mass of 1,000,000 or more is synthesized by using 0.01 to 1 part by mass of a polymerization initiator (e.g., an azo series polymerization initiator such as azobisisobutyronitrile or azobiscyclohexanecarbonitrile, a peroxide such as benzoyl peroxide or acetyl peroxide, or a photo polymerization initiator such as diphenyl ketone or 2-hydroxy-2-methyl-1-phenyl-propan-1-one) per 100 parts by mass of the starting monomer according to a process such as a process of bulk polymerization, solution polymerization, emulsion polymerization or suspension polymerization, with a process of solution polymerization being preferred for synthesizing the copolymer.

In the solution polymerization process, ethyl acetate, toluene, hexane or acetone is used as a polymerization solvent, the reaction temperature is from 50 to 150° C., preferably from 50 to 110° C., and the reaction time is from 3 to 15 hours, preferably from 5 to 10 hours.

Also, like the high molecular acrylic copolymer (A₁), a low molecular (meth)acrylic (co)polymer (A₂) having a mass-average molecular mass of 100,000 or less is synthesized by a process of bulk polymerization, solution polymerization, emulsion polymerization or suspension polymerization, with a process of solution polymerization being preferred for synthesizing the copolymer. However, in order to adjust the mass-average molecular mass to 100,000 or less, the polymerization initiator is used in an amount of from 10 to 100 times as much as the amount in the case of synthesizing the high molecular acrylic copolymer and, further, a chain transfer agent such as a mercaptan (e.g., laurylmercaptan, n-dodecylmercaptan or n-octylmercaptan), α-methylstyrene dimer or limonene is preferably used.

### [Adhesive for Polarizing Plate]

An adhesive for the polarizing plate of the invention can be produced by mixing the (meth)acrylic copolymer (A) with the multi-functional compound (B) produced as described above. As (A), either of (A₁) and (A₂) may be employed.

The adhesive for the polarizing plate of the invention can also be prepared by mixing the high molecular (meth)acrylic copolymer (A₁), the low molecular (meth)acrylic (co)polymer (A₂) and the multi-functional compound (B) produced as described above. That is, both (A₁) and (A₂) may simultaneously be used as (A).

In this occasion, the low molecular (meth)acrylic (co)polymer (A₂) is contained in an amount of from 20 to 200 parts by mass, preferably from 30 to 150 parts by mass, per 100 parts by mass of the high molecular (meth)acrylic copolymer (A₁), and the multi-functional compound (B) is contained in an amount of from 0.005 to 5 parts by mass, preferably from 0.01 to 3 parts by mass, per 100 parts by mass of the high molecular (meth)acrylic copolymer (A₁).

It is described in Japanese Patent No. 3,533,589 that relaxation of internal stress can be attained by forming a three-dimensional cross-linked structure using the high molecular (meth)acrylate copolymer (A₁) in which structure the low molecular (meth)acrylate copolymer (A₂) can move (slide) in the three-dimensional cross-linked structure as well as by using a (meth)acrylate whose homopolymer has a low Tg. In the invention, degree of such relaxation of the internal stress can be adjusted by controlling the amounts of repeating units derived from the functional group-having monomers (a₁₃) and (a₂₃) in the high molecular (meth)acrylic copolymer (A₁) (having a mass-average molecular mass of 1,000,000 or more and the low molecular (meth)acrylic copolymer (A₂) (having a mass-average molecular mass of 100,000 or less). It is preferred to adjust the functional group distribution ratio defined by the following numerical formula (12) to be 0 to 15% by mass, with 0 to 10% by mass being more preferred.

Numerical formula (12)=[mass of the repeating unit derived from the functional group-having monomer (a₂₃) in the (meth)acrylic polymer (A₂)/mass of the repeating unit derived from the functional group-having monomer (a₁₃) in the (meth)acrylic copolymer (A₁)]×100

Degree of three-dimensional cross-linking (gel fraction) in the adhesive is from 40% by mass to 90% by mass, preferably from 60% by mass to 90% by mass, more preferably from 70% by mass to 90% by mass.

The adhesion performance and relaxation can be well balanced by adjusting the degree within the above-described scope, thus such scope being preferred. The degree of three-dimensional cross-linking can be adjusted by selecting the amount of the polymerizable monomer having reactivity with the multi-functional compound and the amount of the multi-functional compound.

As is described above, the adhesive for the polarizing plate of the invention contains as a major component a (meth)acrylic copolymer composition comprising the (meth)acrylic copolymer (A) (or the high molecular (meth)acrylic copolymer (A₁) and the low molecular (meth)acrylic (co)polymer (A₂)} and the multi-functional compound (B). Further, components commonly incorporated in an adhesive, such as a weathering agent, a tackifier, a plasticizer, a softening agent, a dye, a pigment, a silan coupling agent and an inorganic filler (e.g., electrically conductive fine particles or light-scattering fine particles), can be incorporated in the adhesive for the polarizing plate.

As to creep deformation value of the adhesive, it is preferred for the adhesive layer to undergo creep deformation of less than 70 μm when a piece of which having a size of 10 mm in width and 10 mm in length is stuck on an alkali-free glass plate and a load of 200 g is applied thereto in an atmosphere of 50° C. for 1 hour, with creep deformation of less than 60 μm being more preferred, and creep deformation of less than 50 μm being particularly preferred. Also, it is preferred for the adhesive layer to undergo creep deformation of less than 40 μm when a piece of which having a size of 10 mm in width and 10 mm in length is stuck on an alkali-free glass plate and a load of 200 g is applied thereto in an atmosphere of 25° C. for 1 hour, with creep deformation of less than 35 μm being more preferred, and creep deformation of less than 30 μm being particularly preferred.

### <Protective Film>

Next, the protective film of the invention will be described below.

The polarizing plate of the invention has a protective film on each side of a polarizer. In the invention, it is preferred to use a cellulose acylate film or a cyclic polyolefin film. The protective films on both sides of the polarizer may be the same or different from each other. For example, of the protective films on both sides of the polarizer, one protective film on one side of the polarizer may be the aforesaid cellulose acylate film, and the other protective film on the other side may be the cyclic polyolefin film. It is also possible to use films different from each other in formulation or optical characteristics. Further, a polymer layer may be provided on the cellulose acylate film or the cyclic polyolefin film to constitute the protective layer. For example, a polyimide layer may be provided on the cellulose acylate film to form the protective layer.

### {Cellulose Acylate Film}

Next, the cellulose acylate film to be preferably used in the invention will be described below.

The cellulose acylate film to be preferably used in the invention is formed by using a specific cellulose acylate as a starting material. Different cellulose acylates are used between the case of increasing optical anisotropy and the case of decreasing optical anisotropy.

### [Cellulose Acylate for the Case of Increasing Optical Anisotropy]

First, cellulose acylate to be used in the invention for the case of increasing optical anisotropy will be described in detail below.

In the invention, different two or more cellulose acylates may be mixed to use.

The specific cellulose acylate is a mixed fatty acid ester of cellulose obtained by substituting the hydroxyl groups of cellulose with an acetyl group and an acyl group having 3 or more carbon atoms, and is preferably a cellulose acylate which has substitution degrees of the hydroxyl groups of cellulose satisfying the following numerical formulae (4) and (5):

2.0≦A+B≦3.0 numerical formula (4)

0<B. numerical formula (5)

wherein A and B each represents a substitution degree of the acyl group substituting the hydroxyl group of cellulose, with A being a substitution degree of acetyl group and B being a substitution degree of the acyl group containing 3 or more carbon atoms.

Glucose units connected to each other through β-1,4 bond to constitute cellulose have free hydroxyl groups at 2-, 3- and 6-positions. Cellulose acylate is a polymer obtained by esterifying part or whole of these hydroxyl groups with an acyl group. The acyl substitution degree means the proportion of esterified hydroxyl group of cellulose at the 2-, 3- or 6-position (substitution degree for 100% esterification being 1).

In the invention, the sum (A+B) of the substitution degree A and the substitution degree B of hydroxyl groups is preferably from 2.0 to 3.0 as shown by the above numerical formula (4), more preferably from 2.2 to 2.9, particularly preferably from 2.40 to 2.85. Also, the substitution degree B is more than 0 as shown by the above numerical formula (5), more preferably 0.6 or more. In case where (A+B) is 2.0 or more, there does not arise the problem of a large susceptibility to the influence of surrounding humidity due to too strong hydrophilicity, thus such substitution degree being preferred.

Further, with B in the numerical formula (5), it is preferred that 28% or more of B corresponds to the substituent for the 6-position hydroxyl group, with the proportion being more preferably 30% or more, still more preferably 31% or more, particularly preferably 32% or more.

Still further, the sum of the substitution degrees A and B at 6-position of cellulose is preferably 0.75 or more, more preferably 0.80 or more, particularly preferably 0.85 or more. A solution for preparing a film having a favorable solubility and a favorable filterable property can be prepared from such cellulose acylate, which permits to prepare a good solution using a chlorine-free organic solvent. Further, it becomes possible to prepare a solution having a low viscosity and a good filterable property.

Also, in the case where the cellulose acylate film is a protective film to be disposed on the liquid crystal cell side of the polarizing plate, it is preferred for the cellulose acylate film to satisfy the following numerical formulae (6) and (7):

2.0≦DS₂+DS₃+DS₆≦3.0 numerical formula (6)

DS₆/(DS₂+DS₃+DS₆)≧0.315 numerical formula (7)

(wherein DS₂ represents a substitution degree of hydroxyl group at 2-position of the cellulose-constituting glucose unit by the acyl group, DS₃ represents a substitution degree of hydroxyl group at 3-position of the glucose unit by the acyl group, and DS₆ represents a substitution degree of hydroxyl group at 6-position of the glucose unit by the acyl group.

A cellulose acylate film satisfying the numerical formulae (6) and (7) has an improved solubility into a solvent and a reduced humidity dependence of optical anisotropy, thus being preferred.

Further, the acyl group is preferably an acetyl group in the point that saponification proceeds with ease and that the film undergoes less dimensional change, has a high durability and can be produced at a low cost.

The acyl group having 3 or more carbon atoms is not particularly limited, and may be an aliphatic group or an aromatic hydrocarbon group. Examples thereof include alkylcarbonyl esters, alkenylcarbonyl esters, aromatic carbonyl esters and aralkyl carbonyl esters of cellulose, which may further have a substituent or substituents.

Preferred examples of the acyl group having 3 or more carbon atoms include propionyl, butanoyl, heptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl and cinnamoyl. Of these, propionyl, butanoyl, dodecanoyl, octadecanoyl, t-butanoyl, oleoyl, benzoyl, naphthylcarbonyl and cinnamoyl are more preferred, with propionyl and butanoyl being particularly preferred.

Also, in the case where the acyl group is a propionyl group, the substitution degree B is preferably 1.3 or more.

As the mixed fatty acid cellulose acylate, there are specifically illustrated cellulose acetate propionate and cellulose acetate butyrate.

### [Cellulose Acylate for the Case of Decreasing Optical Anisotropy]

In the case where optical anisotropy is to be decreased, the acyl substitution degree of hydroxyl groups of cellulose is preferably from 2.50 to 3.00, more preferably, from 2.75 to 3.00, still more preferably from 2.85 to 3.00.

The acyl group having from 2 to 22 carbon atoms which substitutes at the hydroxyl group of cellulose is not particularly limited and may be an aliphatic group or an aryl group, and may be a single group or a mixture of two or more thereof. Examples thereof include alkylcarbonyl esters, alkenylcarbonyl esters, aromatic carbonyl esters and aralkyl carbonyl esters of cellulose, which may further have a substituent or substituents.

Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl and cinnamoyl. Of these, acetyl, propionyl, butanoyl, dodecanoyl, octadecanoyl, t-butanoyl, oleoyl, benzoyl, naphthylcarbonyl and cinnamoyl are more preferred, with acetyl, propionyl and butanoyl being still more preferred.

In the case where the acyl substituents substituting at the hydroxyl groups of cellulose substantially comprise at least two of the acetyl group, the propionyl group and the butanoyl group, the whole substitution degree is preferably from 2.50 to 3.00, more preferably from 2.75 to 3.00, still more preferably from 2.85 to 3.00. When the substitution degree is within the above-described scope, optical anisotropy of the cellulose acylate film can be sufficiently decreased, thus such scope being preferred.

### [Process for Synthesizing Cellulose Acylate]

The fundamental principle of a process for synthesizing cellulose acylate is described in Migita et al., Mokuzai Kagaku, pp 180-190 (Kyoritsu Shuppan, 1968). A typical synthesizing process is a liquid phase acetylating process using a carboxylic acid anhydride-acetic acid-sulfuric acid catalyst.

In obtaining the cellulose acylate, a cellulose raw material such as cotton fiber linter or wood pulp is pretreated with a suitable amount of acetic acid, then added to a previously cooled mixed solution for carboxylation to conduct esterification, thus a complete cellulose acylate (wherein the sum of acyl substitution degrees at 2-, 3- and 6-positions is approximately 3.00) being synthesized.

The mixed solution for carboxylation generally includes acetic acid as a solvent, a carboxylic acid anhydride as an esterifying agent, and sulfuric acid as a catalyst. The carboxylic acid anhydride is commonly used in a stoichiometrically excess amount based on the sum of the amount of cellulose and the amount of moisture existing within the system, which react with the carboxylic acid anhydride. After completion of the esterification reaction, an aqueous solution of a neutralizing agent (e.g., carbonate, acetate or oxide of calcium, magnesium, iron, aluminum or zinc) is added thereto in order to hydrolyze the excess carboxylic acid anhydride remaining within the system and neutralize part of the esterification catalyst.

Next, the thus-obtained complete cellulose acylate is kept at 50 to 90° C. in the presence of a small amount of an acetylation reaction catalyst (generally, remaining sulfuric acid) to saponify and ripen in order to change the acyl substitution degree and the polymerization degree of the cellulose acylate to desired levels. At the point where a desired cellulose acylate is obtained, the catalyst remaining within the system is completely neutralized with the neutralizing agent such as is described hereinbefore or, without neutralization, the cellulose acylate solution is thrown into water or dilute sulfuric acid (or water or dilute sulfuric acid is thrown into the cellulose acylate solution) to separate cellulose acylate, followed by washing and conducting a stabilizing treatment, thus the specific cellulose acylate being obtained.

With the aforesaid cellulose acylate film, the polymer component constituting the film preferably comprises substantially the specific cellulose acylate.

The term “substantially” as used herein means 55% by mass or more (preferably 70% by mass or more, more preferably 80% by mass or more) of the polymer component.

The cellulose acylate is preferably used in a particulate form. 90% by mass or more of the particles to be used preferably have a particle size of from 0.5 to 5 mm. Also, 50% by mass or more of the particles to be used preferably have a particle size of from 1 to 4 mm. The cellulose acylate particles preferably have a shape as spherical as possible.

The polymerization degree of cellulose acylate to be preferably used in the invention is preferably from 200 to 700, more preferably from 250 to 550, still more preferably from 250 to 400, particularly preferably from 250 to 350, in terms of viscosity-average polymerization degree. The average polymerization degree can be measured by the limiting viscosity method of Uda et-al. (Kazuo Uda & Hideo Saito; Sen'i Gakkaishi, vol. 18, No. 1, pp. 105-120, 1962). Further, detailed descriptions are given in JP-A-9-95538.

Removal of a low molecular component increases the average molecular mass (polymerization degree), but lowers the viscosity in comparison with common cellulose acylate. Therefore, as the aforesaid cellulose acylate, those from which a low molecular component has been removed are useful.

Such cellulose acylate containing a less amount of the low molecular component can be obtained by removing the low molecular component from cellulose acylate synthesized according to the usual process. Removal of the low molecular component can be performed by washing the cellulose acylate with a suitable organic solvent. Additionally, in the case of producing cellulose acylate containing a less amount of the low molecular component, it is preferred to adjust the amount of the sulfuric acid catalyst in the acetylation reaction to 0.5 to 25 parts by mass per 100 parts by mass of cellulose acylate. When the amount of the sulfuric acid catalyst is adjusted to the above-mentioned range, there can be synthesized a cellulose acylate also favorable in the point of molecular mass distribution (having a uniform molecular weigh distribution).

In the case of using the cellulose acylate for producing a film, its water content is preferably 2% by mass or less, more preferably 1% by mass or less, particularly preferably 0.7% by mass or less. Cellulose acylate generally contains water, and the content of water is known to be from 2.5 to 5% by mass. In the invention, drying of the film is required in order to adjust the water content of cellulose acylate to a level within the above-described preferred range. The drying method is not particularly limited as long as the water content can be adjusted to the intended level.

As to the raw cotton and synthesizing process of the cellulose acylate, those raw cottons and synthesizing processes can be employed which are described in detail in Hatsumei Kyokai Kokai Giho, Kogi No. 2001-1745 (published on Mar. 15, 2001 by Hatsumei Kyokai), pp. 7-12.

A cellulose acylate film which can preferably be used in the invention can be obtained by forming a film using a solution of the specific cellulose acylate and, if necessary, additives in an organic solvent.

In order to reduce modulus of elasticity, it is preferred to use as a raw material wood pulp having a shorter fiber length than that of cotton linter. It is also preferred to use those which have a low polymerization degree of cellulose acylate.

### [Additives]

Examples of additives to be used in the invention in the cellulose acylate solution include a plasticizer, a UV ray absorbent, a deterioration-preventing agent, a retardation (optical anisotropy) increasing agent, a retardation (optical anisotropy) decreasing agent, a wavelength dispersion-adjusting agent, a dye, fine particles, a peeling accelerator and an infrared ray absorbent. In the invention, use of a retardation increasing agent is preferred. Also, use of at least one of a plasticizer, a UV ray absorbent, a peeling accelerator, a dye and a matt agent is preferred.

They may be a solid or an oily material. That is, they are not particularly limited as to their melting points or boiling points. For example, it is possible to mix a UV ray absorbent having a melting point of 20° C. or less with a UV ray absorbent having a melting point of 20° C. or more to use. Likewise, plasticizers may be mixed to use. Descriptions thereon are given in, for example, JP-A-2001-151901.

The modulus of elasticity E of the protective film is adjusted to be preferably from 500 to 3,000 MPa, more preferably from 600 to 2,500 MPa, particularly more preferably 600 to 2,000 MPa measured by a tensile strength tester “Strography R2” (manufactured by Toyo Seiki Seisaku-sho, Ltd.).

### [UV Ray Absorbent]

As the UV ray absorbent, any kind of UV ray absorbents may be selected according to purpose. There may be used salicylate series, benzophenone series, benzotriazole series, benzoate series, cyanoacrylate series and nickel complex salt series UV ray absorbents. Of these, benzophenone series, benzotriazole series and salicylate series UV ray absorbents are preferred.

Examples of the benzophenone series UV ray absorbent include 2,4-dihydroxybenzophenone, 2-hydroxy-4-acetoxybenzophen one, 2-hydroxy-4-methoxybenzophenone, 2,2′-di-hydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone.

Examples of the benzotriazole series UV ray absorbent include 2(2′-hydroxy-3′-tert-butyl-5′-methylphenyl)-5-chlorobenzotriazole, 2(2′-hydroxy-5′-t-butylphenyl)benzotriazole, 2(2′-hydroxy-3′,5′-di-t-amylphenyl)benzotriazole, 2(2′-hydroxy-3′,5′-di-t-butylphenyl)-5-chlorobenzotriazole and 2(2′-hydroxy-5′-t-octylphenyl)benzotriazole.

Examples of the salicylate series UV ray absorbent include phenyl salicylate, p-octylphenyl salicylate and p-tert-butylphenyl salicylate.

Of these illustrative UV ray absorbents, 2-hydroxy-4-methoxybenzophenone, 2,2′-di-hydroxy-4,4′-methoxybenzophenone, 2(2′-hydroxy-3′-t-butyl-5′-methylphenyl)-5-chlorobenzotriazole, 2(2′-hydroxy-5′-t-butylphenyl)benzotriazole, 2(2′-hydroxy-3′,5′-di-t-amylphenyl)benzotriazole and 2(2′-hydroxy-3′,5′-di-t-butylphenyl)-5-chlorobenzotriazole are particularly preferred.

Use of a mixture of plural UV ray absorbents different from each other in absorption wavelength is preferred because a high shielding effect is obtained over a wide wavelength region. As a UV ray absorbent for a liquid crystal, those which have an excellent ability of absorbing UV rays of 370 nm or shorter in wavelength and less absorb visible light of 400 nm or longer in wavelength are preferred in view of preventing deterioration of liquid crystal and in view of liquid crystal display performance, respectively. Particularly preferred UV ray absorbents are the aforementioned benzotriazole series compounds, benzophenone series compounds and salicylate series compounds. Among them, benzotriazole series compounds are preferred since they cause less coloration of cellulose which coloration is unnecessary.

Also, as the UV ray absorbents, those compounds can be used as well which are described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173.

The addition amount of the UV ray absorbent is preferably from 0.001 to 5% by mass, more preferably from 0.01 to 1% by mass. An addition amount equal to or more than 0.001% by mass is preferred because the additive can fully exert its effects, and an addition amount equal to or less than 5% by mass is preferred because breed-out of the UV ray absorbent onto the surface of the film can be suppressed.

It is also possible to add the UV ray absorbent simultaneously with dissolution of cellulose acylate, or may be added to a dope after dissolution. In particular, an embodiment is preferred wherein a solution of a UV ray absorbent is added immediately before casting using a static mixer, because it facilitates adjustment of spectral absorption characteristics.

### [Deterioration-Preventing Agent]

The deterioration-preventing agent can prevent deterioration and decomposition of cellulose triacetate or the like. As the deterioration-preventing agent, there are illustrated butylamine, hindered amine compounds (JP-A-8-325537), guanidine compounds (JP-A-5-271471), benzotriazole series UV ray absorbents (JP-A-6-235819) and benzophenone series UV ray absorbents (JP-A-6-118233).

As the plasticizer, phosphates and carboxylates are preferred. Examples of the phosphate series plasticizer include triphenyl phosphate (TPP), tricresyl phosphate (TCP), cresyldiphenyl phosphate, octyldiphenyl phosphate, biphenyldiphenyl phosphate (BDP), trioctyl phosphate and tributyl phosphate; and examples of the carboxylate include dimethyl phthalate (DMP), diethyl phthalate (DEP), dibutyl phthalate (DBP), dioctyl phthalate (DOP), diphenyl phthalate (DPP), diethylhexyl phthalate (DEHP), tributyl O-acetylcitrate (OACTB), triethyl acetylcitrate, tributyl acetylcitrate, butyl oleate, methyl acetyllicinolate, dibutyl sebacate, triacetin, tributyrin, butylphthalylbutyl glycolate, ethylphthalylethyl glycolate, methylphthalylethyl glycolate and butylphthalylbutyl glycolate. The plasticizer to be used in the invention is preferably selected from among these illustrated plasticizers. Further, the plasticizer is preferably a (di)pentaerythritol ester, a glycerol ester or a diglycerol ester.

Addition of a plasticizer is preferred for decreasing the modulus of elasticity. However, addition of the plasticizer in a too much amount would cause a problem that the plasticizer precipitates from the film.

Thus, the addition amount is preferably from 0.1 to 20 parts by mass, more preferably from 3 to 18 parts by mass, particularly preferably from 5 to 15 parts by mass, per 100 parts by mass of the polymer components including cellulose acylate.

### [Peeling Accelerator]

As the peeling accelerator, there is illustrated ethyl citrate.

### [Infrared Ray Absorbing Agent]

Further, examples of the infrared ray absorbing agent are described in, for example, JP-A-2001-194522.

### [Stage of Addition]

As to the stage of adding the additives, they may be added in any stage of the dope-preparing step or, alternatively, a step of adding the additives may be additionally provided after the final stage of the dope-preparing step. Further, the addition amount of each material is not particularly limited as long as its function can be obtained.

In the case where the cellulose acylate film has a multi-layered structure, kinds and addition amounts of the additives for respective layers may be different. For example, related descriptions are given in JP-A-2001-151902, which are conventionally known techniques.

It is preferred to adjust the glass transition point Tg of the cellulose acylate film measured by means of a dynamic viscoelasticity-measuring machine “Vibron DVA-225” (manufactured by IT Keisoku Seigyo K.K.) to 70 to 150° C. and the modulus of elasticity of the cellulose acylate film measured by means of a tensile tester “Storograph-R2” (manufactured by K.K. Toyo Seiki Seisakusho) to 500 to 3000 MPa. The glass transition point is more preferably 80 to 135° C., and the modulus of elasticity is more preferably 600 to 2500. That is, the cellulose acylate film to be preferably used in the invention has a glass transition point Tg and a modulus of elasticity within the above-mentioned ranges, respectively.

As to the additives, those which are described in Hatsumei Kyokai Kokai Giho, Kogi No. 2001-1745 (published by Hatsumei Kyokai on Mar. 15, 2001), p. 16 et seq. may properly be used.

### [Retardation Increasing Agent]

In the invention, in the case of largely increasing optical anisotropy, it is preferred to use a retardation increasing agent to obtain a preferred retardation value. As a retardation increasing agent to be used in the invention, there may be illustrated those which comprise a rod-like or discotic compound. As the rod-like or discotic compound, those which have at least two aromatic rings may be used.

The addition amount of the retardation increasing agent comprising a rod-like compound is preferably from 0.1 to 30 parts by mass, more preferably from 0.5 to 20 parts by mass, per 100 parts by mass of the polymer component including cellulose acylate.

The discotic retardation increasing agent is used in an amount of preferably from 0.05 to 20 parts by mass, more preferably from 0.1 to 10 parts by mass, still more preferably from 0.2 to 5 parts by mass, most preferably from 0.5 to 2 parts by mass, per 100 parts by mass of the polymer component including cellulose acylate.

In the case where a particularly large Rth retardation is required, the discotic compound it preferably used because it has a more excellent Rth retardation increasing ability than that of the rod-like compound.

Two or more kinds of retardation increasing agents may be used in combination thereof.

The retardation increasing agent comprising the rod-like or discotic compound has the maximum absorption in the wavelength region of preferably 250 to 400 nm and preferably has substantially no absorption in the visible region.

### (Discotic Compound)

The discotic compound will be described below.

As the discotic compound, those compounds may be used which have at least two aromatic rings.

The term “aromatic ring” as used herein includes aromatic hetero rings in addition to aromatic hydrocarbon rings.

The aromatic hydrocarbon ring is particularly preferably a 6-membered ring (i.e., benzene ring). In general, the aromatic hetero ring is an unsaturated hetero ring. The aromatic hetero ring is preferably a 5-, 6- or 7-membered ring, with a 5- or 6-membered ring being more preferred.

The aromatic hetero ring generally has the maximum double bonds.

As the hetero atom, nitrogen atom, oxygen atom and sulfur atom are preferred, with nitrogen atom being particularly preferred. Examples of the aromatic hetero ring include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring. As the aromatic ring, a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring are preferred, with a 1,3,5-triazine ring being particularly preferably used. Specifically, compounds disclosed in, for example, JP-A-2001-166144 are preferably used as the discotic compound.

The number of aromatic rings the discotic compound has is preferably from 2 to 20, more preferably from 2 to 12, still more preferably from 2 to 8, most preferably from 2 to 6.

Binding relations of two aromatic rings can be classified into (a) the case of forming a condensed ring system, (b) the case of the two aromatic rings being directly connected to each other through a single bond, and (c) the case of the two aromatic rings being connected to each other through a linking group (spiro-union not being formed since the two rings are aromatic rings). The binding relation may be any of (a) to (c).

Examples of the condensed ring system (a) (condensed ring system containing two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathine ring, a phenoxazine ring and a thianthrene ring. Of these, a naphthalene ring, an azulene ring, an indole ring, a benzoxazole ring, a benzothiazole ring, a benzimidazole ring, a benzotriazole ring and a quinoline ring are preferred.

The single bond (b) is preferably a bond between carbon atoms of two aromatic rings. Two aromatic rings may be connected to each other by two or more single bonds to form an alicyclic ring or a non-aromatic hetero ring between the two aromatic rings.

The linking group (c) is preferably a group connecting carbon atoms of two aromatic rings as well. The linking group is preferably an alkylene group, an alkenylene group, an alkynylene group, —CO—, —O—, —NH—, —S— or the combination thereof.

Examples of the linking group comprising the combination are shown below. Additionally, the relation between the right side and the left side of each example of the linking group may be reversed.

c₁: —CO—O—
c₂: —CO—NH—
c₃: -alkylene-O—
c₄: —NH—CO—NH—
c₅: —NH—CO—O—
c₆: —O—CO—O
c₇: —O-alkylene-O—
c₈: —CO-alkenylene-
c₉: —CO-alkenylene-NH—
c₁₀: —CO-alkenylene-O—
c₁₁: -alkylene-CO—O-alkylene-O—CO-alkylene-
c₁₂: —O-alkylene-CO—O-alkylene-O—CO-alkylene-O—
c₁₃: —O—CO-alkylene-CO—O—
c₁₄: —NH—CO-alkenylene-
c₁₅: —O—CO-alkenylene-

The aromatic ring and the linking group may have a substituent.

Examples of the substituent include a halogen atom (F, Cl, Br or I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amido group, an aliphatic sulfonamido group, an aliphatic substituted amino group, an aliphatic substituted carbamoyl group, an aliphatic substituted sulfamoyl group, an aliphatic substituted ureido group and a non-aromatic hetero ring group.

The alkyl group preferably has 1 to 8 carbon atoms. A chain alkyl group is more preferred than a cyclic alkyl group, with a straight-chain alkyl group being particularly preferred. The alkyl group may further have a substituent (e.g., a hydroxyl group, a carboxyl group, an alkoxy group or an alkyl-substituted amino group). Examples of the alkyl group (including substituted alkyl groups) include a methyl group, an ethyl group, a n-butyl group, a n-hexyl group, a 2-hydroxyethyl group, a 4-carboxybutyl group, a 2-methoxyethyl group and a 2-diethylaminoethyl group.

The alkenyl group preferably has 2 to 8 carbon atoms. A chain alkenyl group is more preferred than a cyclic alkenyl group, with a straight-chain alkenyl group being particularly preferred. The alkenyl group may further have a substituent. Examples of the alkenyl group include a vinyl group, an allyl group and a 1-hexenyl group.

The alkynyl group preferably has 2 to 8 carbon atoms. A chain alkynyl group is more preferred than a cyclic alkynyl group, with a straight-chain alkynyl group being particularly preferred. The alkynyl group may further have a substituent. Examples of the alkynyl group include an ethynyl group, a 1-butynyl group and a 1-hexynyl group.

The aliphatic acyl group preferably has 1 to 10 carbon atoms. Examples of the aliphatic acyl group include an acetyl group, a propanoyl group and a butanoyl group.

The aliphatic acyloxy group preferably has 1 to 10 carbon atoms. Examples of the aliphatic acyloxy group include an acetoxy group.

The alkoxy group preferably has 1 to 8 carbon atoms. The alkoxy group may further have a substituent (e.g., an alkoxy group). Examples of the alkoxy group (including substituted alkoxy groups) include a methoxy group, an ethoxy group, a butoxy group and a methoxyethoxy group.

The alkoxycarbonyl group preferably has 2 to 10 carbon atoms. Examples of the alkoxycarbonyl group include a methoxycarbonyl group and an ethoxycarbonyl group.

The alkoxycarbonylamino group preferably has 2 to 10 carbon atoms. Examples of the alkoxycarbonylamino group include a methoxycarbonylamino group and an ethoxycarbonylamino group.

The alkylthio group preferably has 1 to 12 carbon atoms. Examples of the alkylthio group include a methylthio group, an ethylthio group and an octylthio group.

The alkylsulfonyl group preferably has 1 to 8 carbon atoms. Examples of the alkylsulfonyl group include a methanesulfonyl group and an ethanesulfonyl group.

The aliphatic amido group preferably has 1 to 10 carbon atoms. Examples of the amido group include an acetamido group.

The aliphatic sulfonamido group preferably has 1 to 8 carbon atoms. Examples of the sulfonamido group include a methanesuolfonamido group, a butanesulfonamido group and a n-octanesulfonamido group.

The aliphatic substituted amino group preferably has 1 to 10 carbon atoms. Examples of the aliphatic substituted amino group include a dimethylamino group, a diethylamino group and a 2-carboxyethylamino group.

The aliphatic substituted carbamoyl group preferably has 2 to 10 carbon atoms. Examples of the aliphatic substituted carbamoyl group include a methylcarbamoyl group and a diethylcarbamoyl group.

The aliphatic substituted sulfamoyl group preferably has 1 to 8 carbon atoms. Examples of the aliphatic substituted sulfamoyl group include a methylsulfamoyl group and a diethylsulfamoyl group.

The aliphatic substituted ureido group preferably has 2 to 10 carbon atoms. Examples of the aliphatic substituted ureido group include a methylureido group.

Examples of the non-aromatic hetero ring include a piperidino group and a morpholino group.

The molecular mass of the retardation increasing agent comprising the discotic compound is preferably 300 to 800.

### (Rod-Like Compound)

In the invention, rod-like compounds having a linear molecular structure also can preferably be used as well as the aforesaid discotic compounds.

The phrase “linear molecular structured” as used herein means that the molecular structure of the rod-like compound in the thermodynamically most stable structure is linear. The thermodynamically most stable structure can be determined by structural analysis of crystal or by calculating molecular orbital. For example, the molecular orbital calculation can be conducted by using a molecular orbital-calculating soft {for example, “WinMOPAC2000” manufactured by Fujitsu K.K.} to determine the molecular structure with which heat of formation of the compound becomes minimum. The phrase “the molecular structure is linear” as used herein means that, in the thermodynamically most stable structure which can be calculated as described above, the angle formed by the main chain of the molecular structure is 140° or more.

As the rod-like compound, those compounds are preferred which have at least two aromatic rings. The rod-like compounds having at least two aromatic rings are preferably compounds represented by the following formula (1):

Ar¹-L1-Ar² Formula (1)

In the above formula (1), Ar¹ and Ar² each independently represents an aromatic group.

In this specification, the aromatic group includes an aryl group (aromatic hydrocarbon group), a substituted aryl group, an aromatic hetero ring group and a substituted aromatic hetero ring group. The aryl group and the substituted aryl group are more preferred than the aromatic hetero ring group and the substituted aromatic hetero ring group.

The aromatic ring of the aromatic hetero ring group is generally unsaturated. The aromatic hetero ring is preferably a 5-, 6- or 7-membered ring, more preferably a 5- or 6-membered ring. The aromatic hetero ring generally has the maximum number of double bonds. As the hetero atom, nitrogen atom, oxygen atom or sulfur atom is preferred, with nitrogen atom or sulfur atom being more preferred.

As the aromatic ring of the aromatic group, a benzene ring, a furan ring, a thiophene ring, a pyrrole, ring, an oxazole ring, a thiazole ring, an imidazole ring, a triazole ring, a pyridine ring, a pyrimidine ring and a pyrazine ring are preferred, with a benzene ring being particularly preferred.

Examples of the substituent for the substituted aryl group and the substituted aromatic hetero ring group include a halogen atom (F, Cl, Br or I), a hydroxyl group, a carboxyl group, a cyano group, an amino group, an alkylamino group (e.g., a methylamino group, an ethylamino group, a butylamino group or a dimethylamino group), a nitro group, a sulfo group, a carbamoyl group, an alkylcarbamoyl group (e.g., an N-methylcarbamoyl group, an N-ethylcarbamoyl group or an N,N-dimethylcarbamoyl group), a sulfamoyl group, an alkylsulfamoyl group (e.g., an N-methylsulfamoyl group, an N-ethylsulfamoyl group or an N,N-dimethylsulfamoyl group), a ureido group, an alkylureido group (e.g., an N-methylureido group, an N,N-dimethylureido group or an N,N,N-trimethylureido group), an alkyl group (e.g., a methyl group, an ethyl group, a propyl group, a butyl group, a pentyl group, a heptyl group, an octyl group, an isopropyl group, a s-butyl group, a t-amyl group, a cyclohexyl group or a cyclopentyl group), an alkenyl group (e.g., a vinyl group, an allyl group or a hexenyl group), an alkynyl group (e.g., an ethynyl group or a butynyl group), an acyl group (e.g., a formyl group, an acetyl group, a butyryl group, a hexanoyl group or a lauryl group), an acyloxy group (e.g., an acetoxy group, a butyryloxy group, a hexanoyloxy group or a lauryloxy group), an alkoxy group (e.g., a methoxy group, an ethoxy group, a propoxy group, a butoxy group, a pentyloxy group, a heptyloxy group or an octyloxy group), an aryloxy group (e.g., a phenoxy group), an alkoxycarbonyl group (e.g., a methoxycarbonyl group, an ethoxycarbonyl group, a propoxycarbonyl group, a butoxycarbonyl group, a pentyloxycarbonyl group or a heptyloxycarbonyl group), an aryloxycarbonyl group (e.g., a phenoxycarbonyl group), an alkoxycarbonylamino group (e.g., a butoxycarbonylamino group or a hexyloxycarbonylamino group), an alkylthio group (e.g., a methylthio group, an ethylthio group, a propylthio group, a butylthio group, a pentylthio group, a heptylthio group or an octylthio group), an arylthio group (e.g., a phenylthio group), an alkylsulfonyl group (e.g., a methylsulfonyl group, an ethylsulfonyl group, a propylsulfonyl group, a butylsulfonyl group, a pentylsulfonyl group, a heptylsulfonyl group or an octylsulfonyl group), an amido group (e.g., an acetamido group, a butyramido group, a hexanoylamido group or a lauroylamido group) and a non-aromatic hetero ring group (e.g., a morpholino group or a pyrazinyl group).

As the substituent of the substituted aryl group and the substituted aromatic hetero ring group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferred.

The alkyl moiety of the alkylamino group, alkoxycarbonyl group, alkoxy group and alkylthio group and the alkyl group may further have a substituent. Examples of the substituent for the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an acylamino group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic hetero ring group. As the substituent for the alkyl moiety and the alkyl group, a halogen atom, a hydroxyl group, an amino group, an alkylamino group, an acyl group, an acyloxy group, an acylamino group, an alkoxycarbonyl group and an alkoxy group are preferred.

In the foregoing formula (1), L¹ is a divalent linking group selected from among an alkylene group, an alkenylene group, an alkynylene group, —O—, —CO— and the combination thereof.

The alkylene group may have a cyclic structure. As the cyclic alkylene group, cyclohexylene is preferred, with 1,4-cyclohexylene being particularly preferred. As a chain alkylene group, a straight-chain alkylene group is more preferred than an alkylene group having a branch. The alkylene group preferably has 1 to 20 carbon atoms, more preferably 1 to 15 carbon atoms, still more preferably 1 to 10 carbon atoms, yet more preferably 1 to 8 carbon atoms, most preferably 1 to 6 carbon atoms.

It is more preferred for the alkenylene group and the alkynylene group to have a chain structure than to have a cyclic structure, and it is still more preferred for them to have a straight chain structure than to have a branched chain structure. The alkenylene group and the alkynylene group preferably have 2 to 10 carbon atoms, more preferably 2 to 8 carbon atoms, still more preferably 2 to 6 carbon atoms, yet more preferably 2 to 4 carbon atoms, most preferably 2 carbon atoms (vinylene or ethynylene).

The arylene group preferably has 6 to 20 carbon atoms, more preferably 6 to 16 carbon atoms, still more preferably 6 to 12 carbon atoms.

In the molecular structure of formula (1), the angle formed by Ar¹ and Ar² is preferably 140° or more.

As the rod-like compounds, those compounds are more preferred that are represented by the following formula (2):

Ar¹-L²-X-L³-Ar³ Formula (2)

In the above formula (2), Ar¹ and Ar² each independently represents an aromatic group.

Definition and examples of the aromatic group are the same as with Ar¹ and Ar² in the formula (1). L² and L³ each independently represents a divalent group selected from among an alkylene group, —O—, —CO— and the combination thereof.

It is more preferred for the alkylene group to have a chain structure than to have a cyclic structure, and it is still more preferred for the alkylene group to have a straight chain structure than to have a branched chain structure. The alkylene group preferably has 1 to 10 carbon atoms, more preferably 1 to 8 carbon atoms, still more preferably 1 to 6 carbon atoms, yet more preferably 1 to 4 carbon atoms, most preferably 1 or 2 carbon atoms (methylene or ethylene).

L² and L³ are particularly preferably —O—CO— or —CO—O—.

In formula (2), X is 1,4-cyclohexylene, vinylene or ethynylene.

As specific examples of the compounds represented by formula (1) or (2), there are illustrated compounds described in JP-A-2004-109657, [Ka1] to [Ka11].

In addition, compounds represented by the following formula (3) are also preferred.

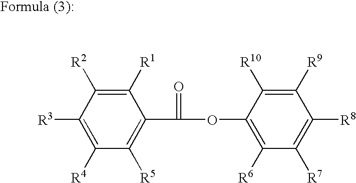

In the above formula, R¹, R², R³, R⁴, R⁵, R⁶, R⁷, R⁹ and R¹⁰ each independently represents a hydrogen atom or a substituent, with at least one of R¹, R², R¹, R⁴ and R⁵ being an electron donative group. R⁸ represents a hydrogen atom, an alkyl group containing from 1 to 4 carbon atoms, an alkenyl group containing from 2 to 6 carbon atoms, an alkynyl group containing from 2 to 6 carbon atoms, an aryl group containing from 6 to 12 carbon atoms, an alkoxy group containing from 1 to 12 carbon atoms, an aryloxy group containing from 6 to 12 carbon atoms, an alkoxycarbonyl group containing from 2 to 12 carbon atoms, an acylamino group containing from 2 to 12 carbon atoms, a cyano group or a halogen atom.

Of the retardation increasing agents, specific examples of the rod-like compound represented by formula (3) are shown below.

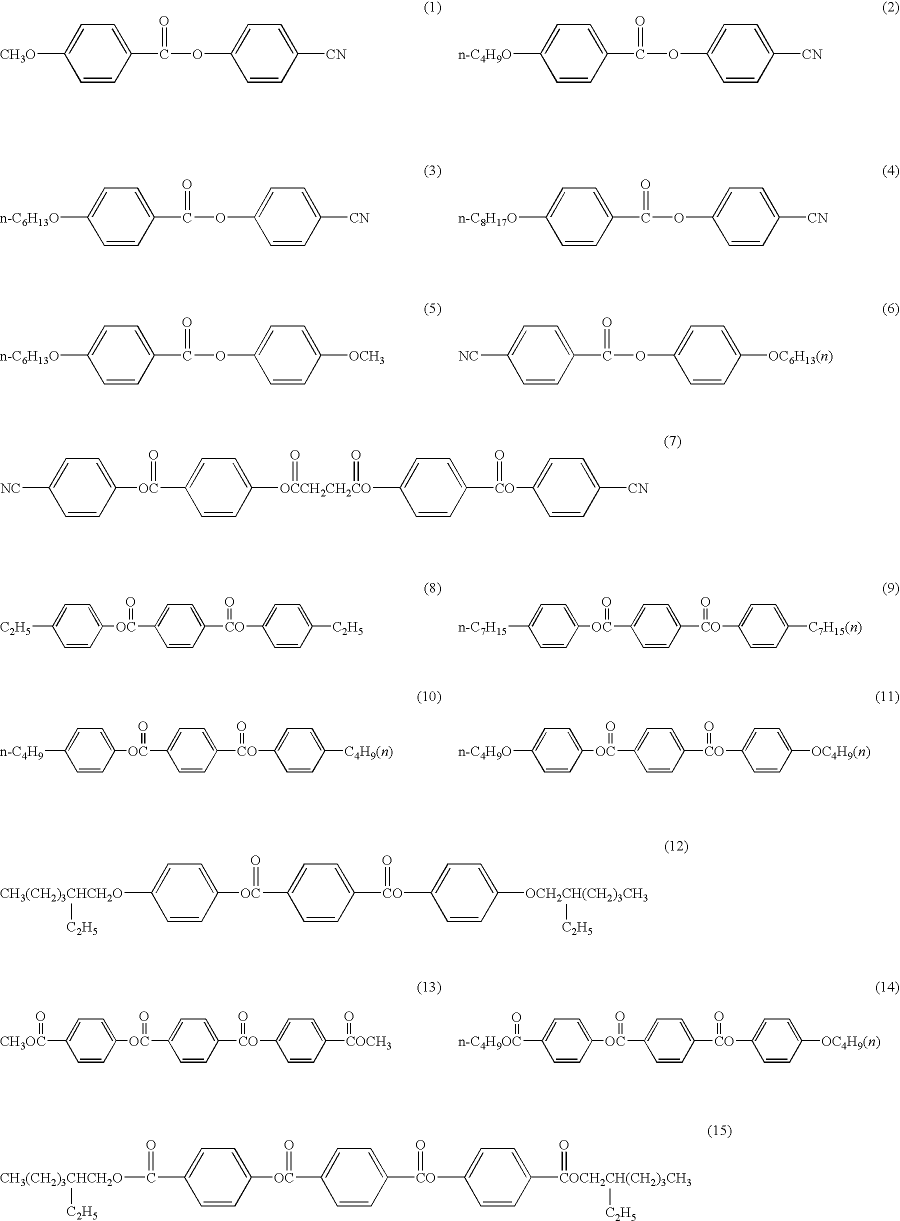

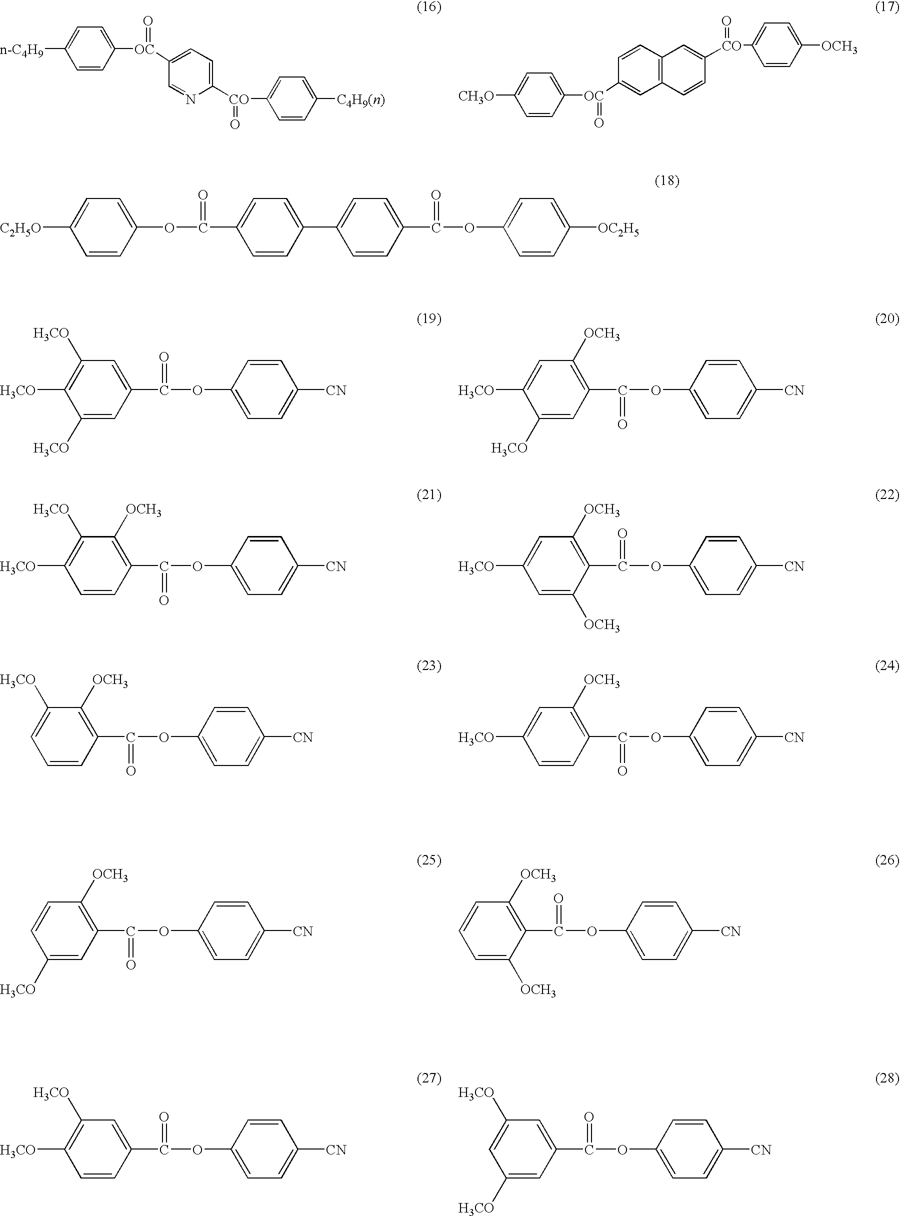

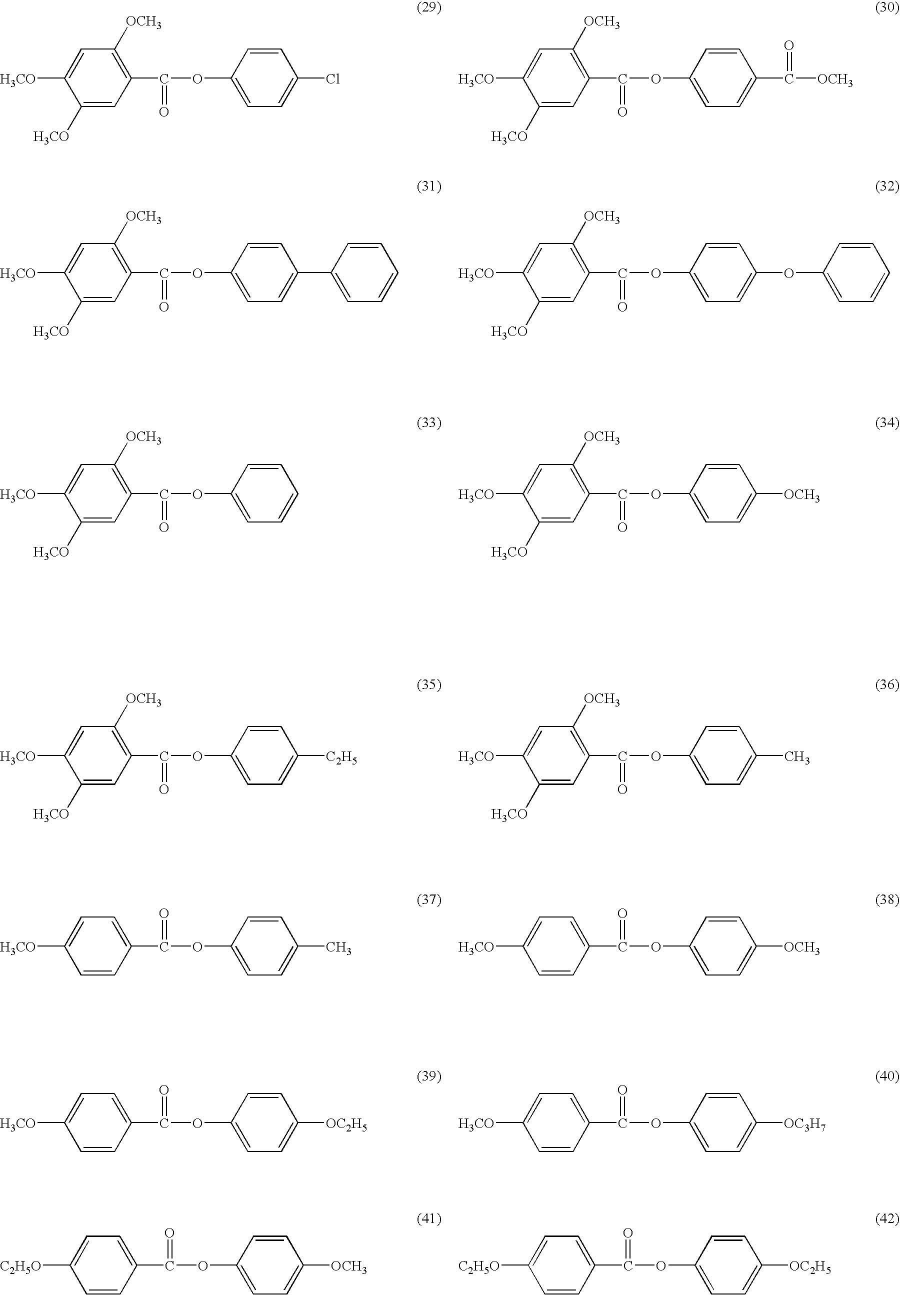

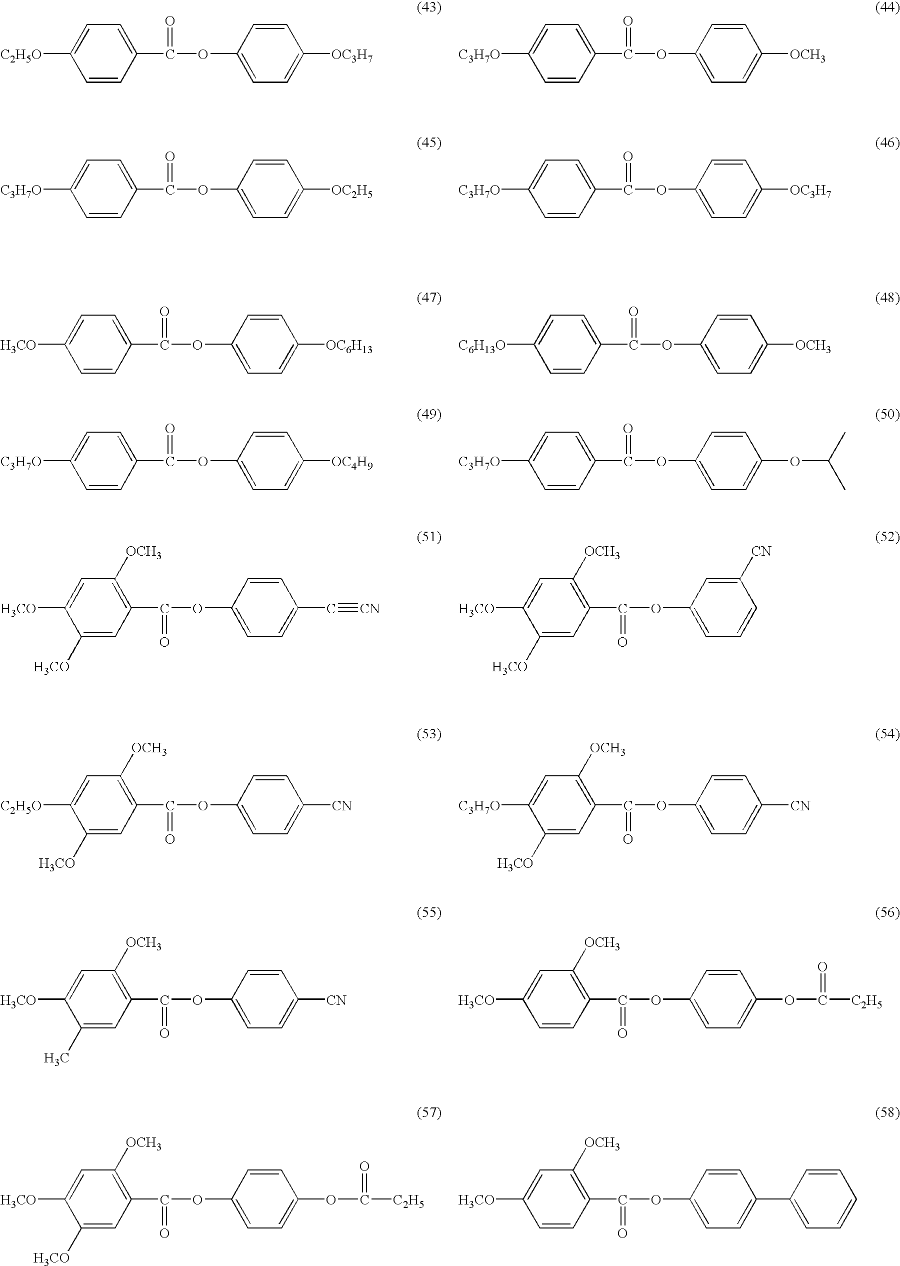

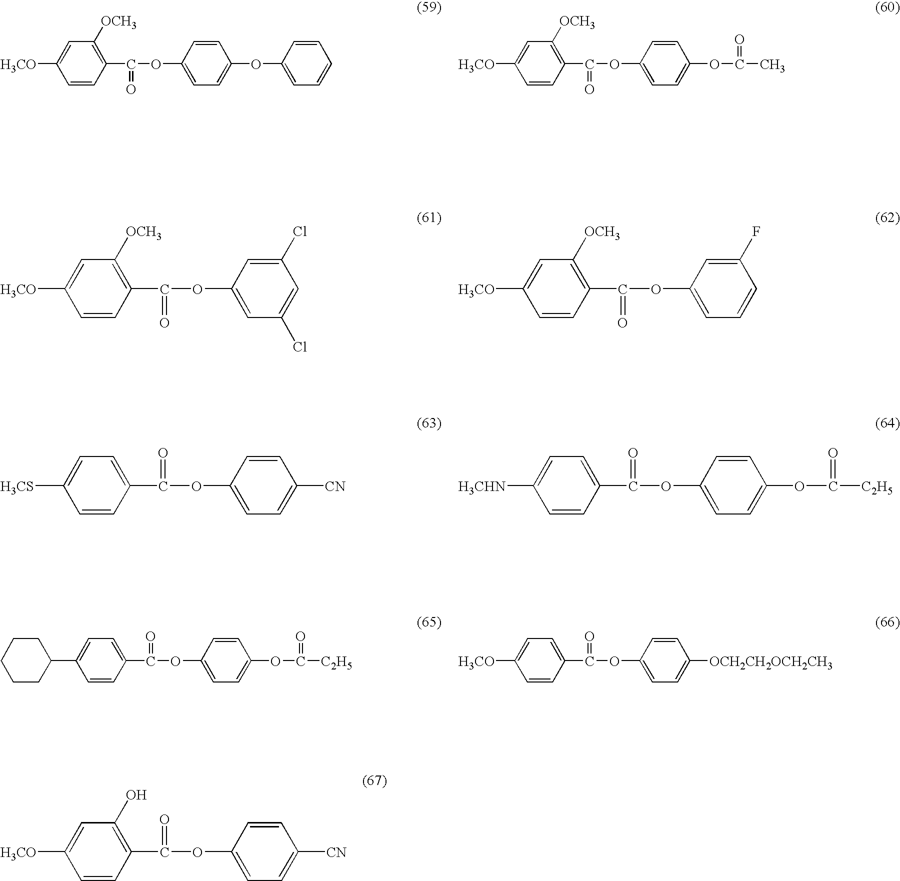

Two or more of the rod-like compounds whose solution has the maximum absorption wavelength (λₘₐₓ) of 250 nm or shorter in the UV ray absorption spectrum may be used in combination thereof.

The rod-like compounds can be synthesized according to processes described in literatures.

Examples of such literatures include Mol. Cryst. Liq. Cryst., 53, 229 (1979); ibid., 89, 93 (1982); ibid., 145, 111 (1987); ibid., 170, 43 (1989); J. Am. Chem. Soc., 113, 1349 (1991); ibid., 118, 5346 (1996); ibid., 92, 1582 (1970); J. Org. Chem., 40, 420 (1975); and Tetrahedron, 48, No. 16, p. 3437 (1992).

### [Retardation Decreasing Agent]

A retardation decreasing agent to be used in the case of decreasing optical anisotropy of a cellulose acylate film will be described below.

Re and Rth can be reduced to zero or approximately zero by sufficiently decreasing optical anisotropy of a film by using a compound which suppresses alignment of cellulose acylate in the film in the in-plane direction and the film thickness direction. For such purpose, it is advantageous for the compound capable of decreasing optical anisotropy to have a sufficient compatibility with cellulose acylate and not to have a rod-like structure or a planar structure. Specifically, in the case where the compound has a plurality of plane functional groups such as aromatic groups, the compound advantageously has a structure wherein the functional groups are not in the same plane but in the non-planar relation with each other.

### (Log P Value)

In preparing a cellulose acylate film having a low optical anisotropy, of the compounds which suppress alignment of cellulose acylate in the film in the in-plane direction and in the film thickness direction, those compounds are preferred which have an octanol-water distribution coefficient (log P value) of from 0 to 7. Compounds having a log P value of 7 or less have a good compatibility with cellulose acylate and scarcely cause troubles such as whitening or blooming of the film, thus being preferred.

Also, compounds having a log P value of 0 or more do not have a too high hydrophilicity and do not deteriorate water resistance of the cellulose acylate film, thus being preferred. The log P value is more preferably in the range of from 1 to 6, particularly preferably from 1.5 to 5.

The octanol-water distribution coefficient (log P value) can be measured according to the flask-shaking method described in JIS Z-7260-107 (2000). It is also possible to estimate the octanol-water distribution coefficient (log P value) by a calculative chemical method or an empirical method in place of actual measurement.

As a calculating method, Crippen's fragmentation method (J. Chem. Inf. Comput. Sci., 27, 21 (1987); Viswanadhan's fragmentation method (J. Chem. Inf. Comput. Sci., 29, 163 (1989); and Broto's fragmentation method (Eur. J. Med. Chem.-Chim. Theor., 19, 71 (1984) are preferably employed, with Crippen's fragmentation method (J. Chem. Inf. Comput. Sci., 27, 21) being more preferred.

In the case where the log P value of a particular compound varies according to the measuring method or the calculating method, it is preferably judged based on Crippen's fragmentation method whether the log P value of the compound is within the above-mentioned range or not.

### (Physical Properties of Compound Capable of Decreasing Optical Anisotropy)

The compound capable of decreasing optical anisotropy may or may not have an aromatic group. Also, the compound capable of decreasing optical anisotropy has a molecular mass of preferably from 150 to 3,000, more preferably from 170 to 2,000, particularly preferably from 200 to 1,000. The compound may be of a specific monomer structure or an oligomer or polymer structure wherein a plurality of the monomer units are connected to each other, as long as the molecular mass is within the range.

The compound capable of decreasing optical anisotropy is preferably liquid at 25° C. or a solid having a melting point of from 25 to 250° C., more preferably liquid at 25° C. or a solid having a melting point of from 25 to 200° C. Also, the compound capable of decreasing optical anisotropy preferably does not evaporate away during the step of casting a dope and the step of drying for preparing the cellulose acylate film.

The addition amount of the compound capable of decreasing optical anisotropy is preferably from 0.01 to 30% by mass, more preferably from 1 to 25% by mass, particularly preferably from 5 to 20% by mass, based on the mass of cellulose acylate.

The compounds capable of decreasing optical anisotropy may be used alone or as a mixture of two or more thereof with any mixing ratio.

As to the stage of adding the compound capable of decreasing optical anisotropy, the compound may be added in any step of the dope-preparing process or may be added in the final stage of the dope-preparing process.

The average content of the compound capable of decreasing optical anisotropy in the portion from the surface to the depth of 10% of the whole film thickness on at least one side is preferably 80 to 99% of the average content of the compound in the central portion of the film. The existing amount of the compound capable of decreasing optical anisotropy in the surface portion and the central portion can be determined according to the method of using an infrared absorption spectrum as described in, for example, JP-A-8-57879.

### (Specific Examples of Compound Capable of Decreasing Optical Anisotropy)

Specific examples of the compound capable of decreasing optical anisotropy of the cellulose acylate film, which are preferably used in the invention, are shown below. However, the invention is not limited only to these compounds.

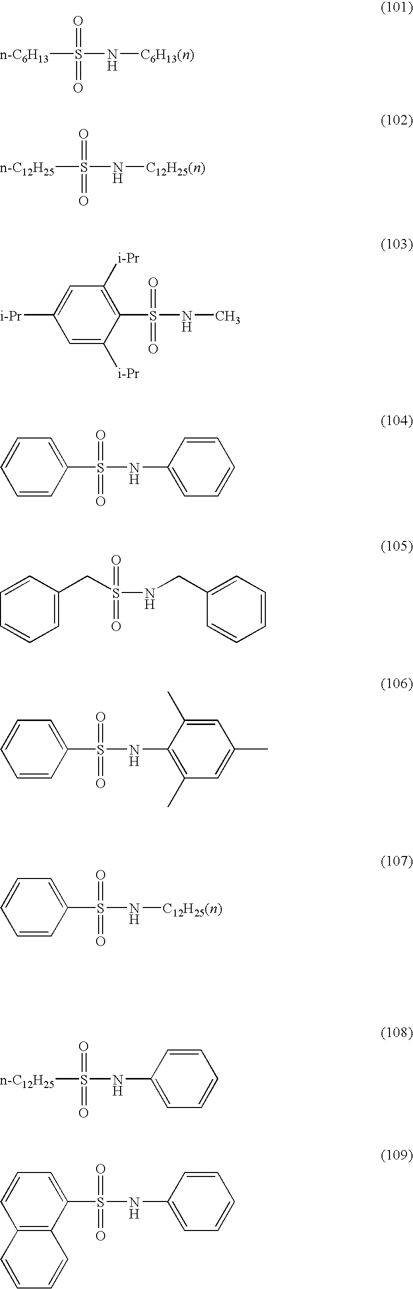

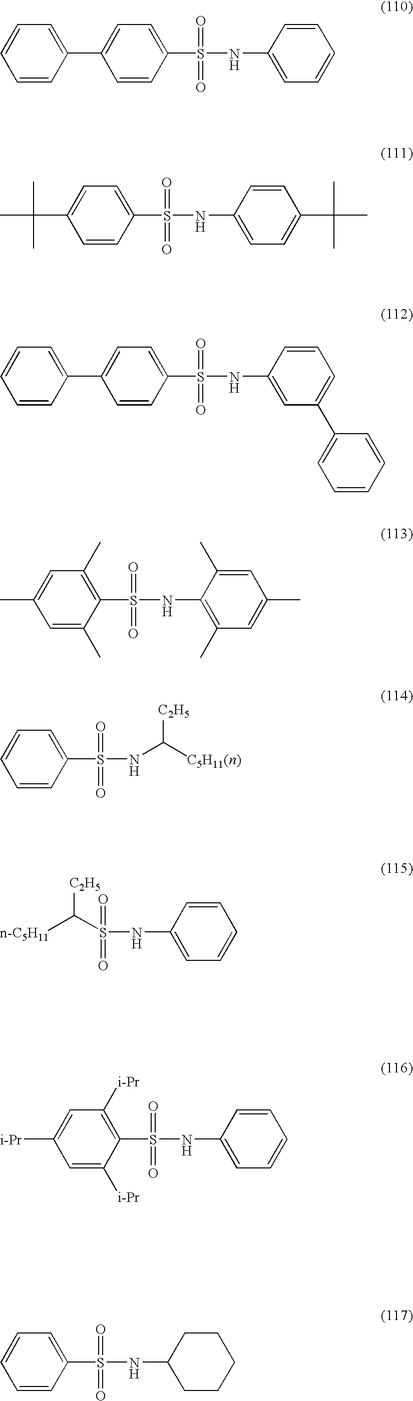

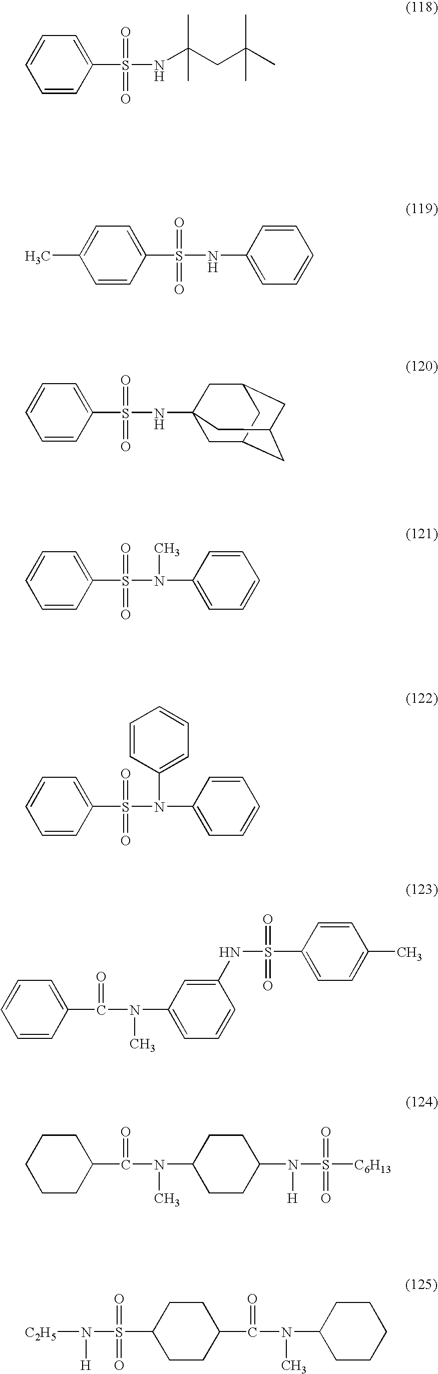

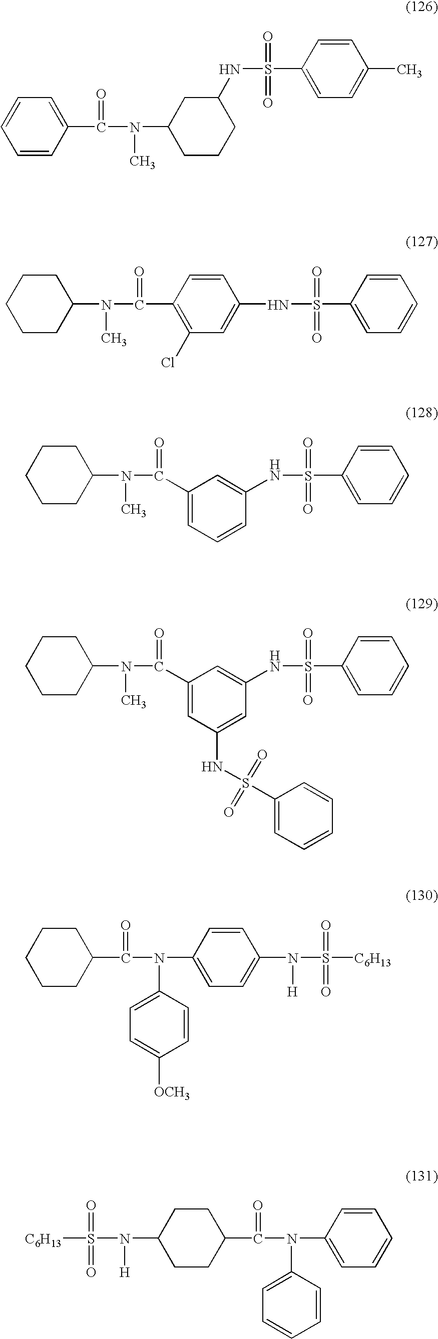

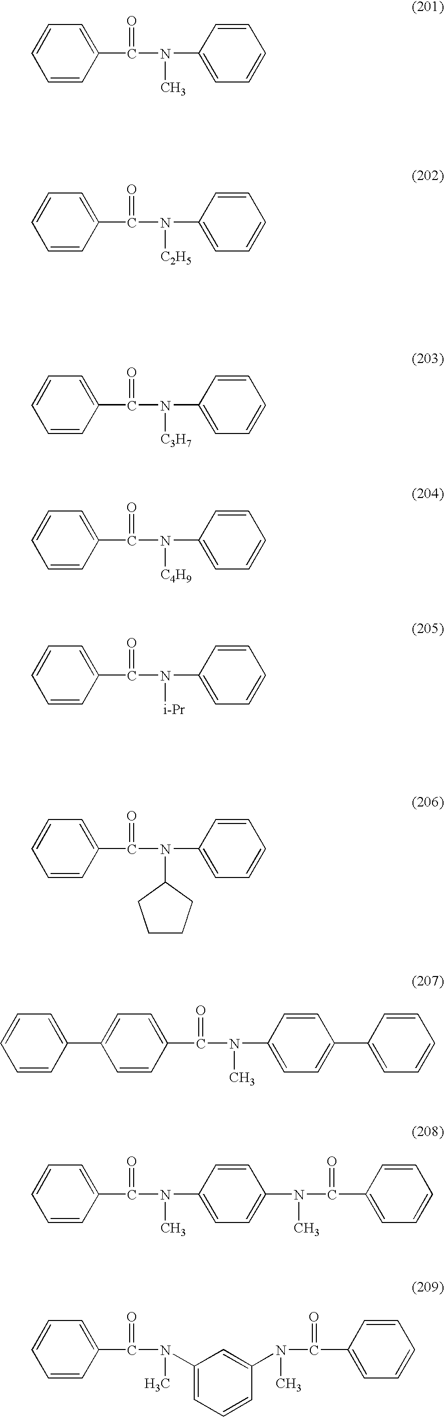

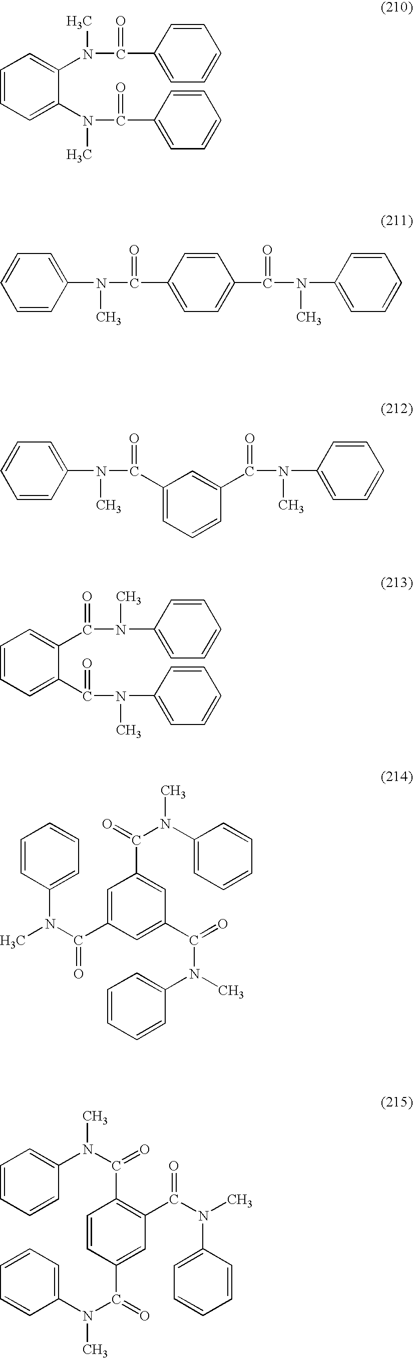

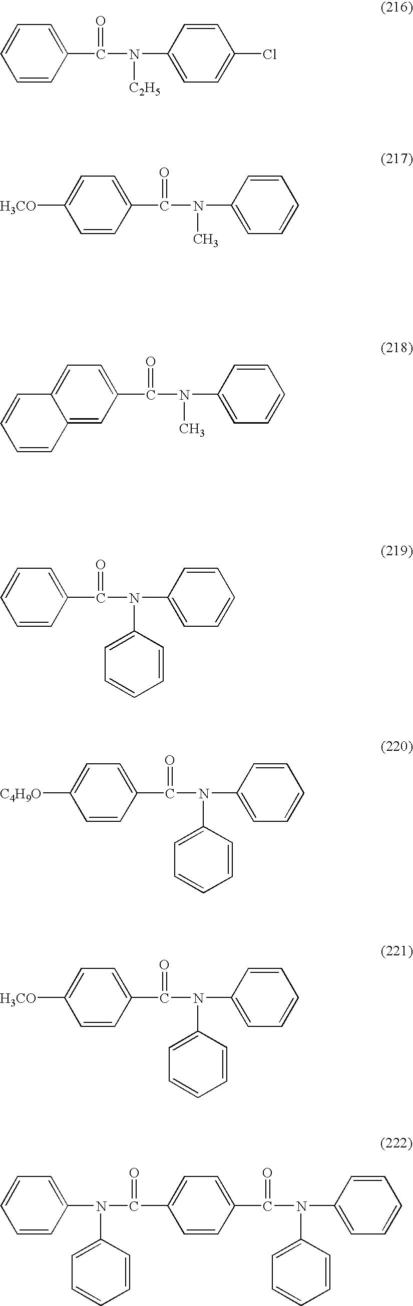

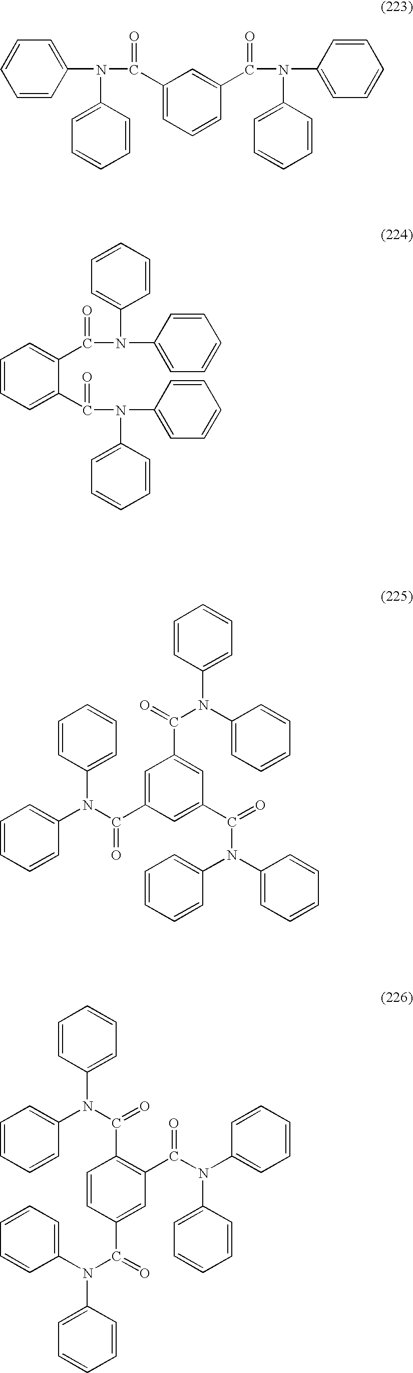

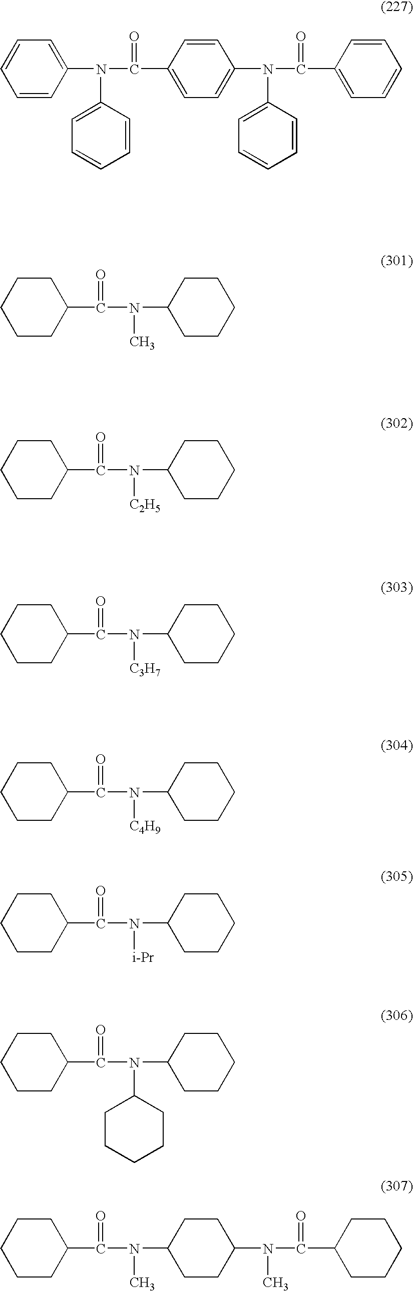

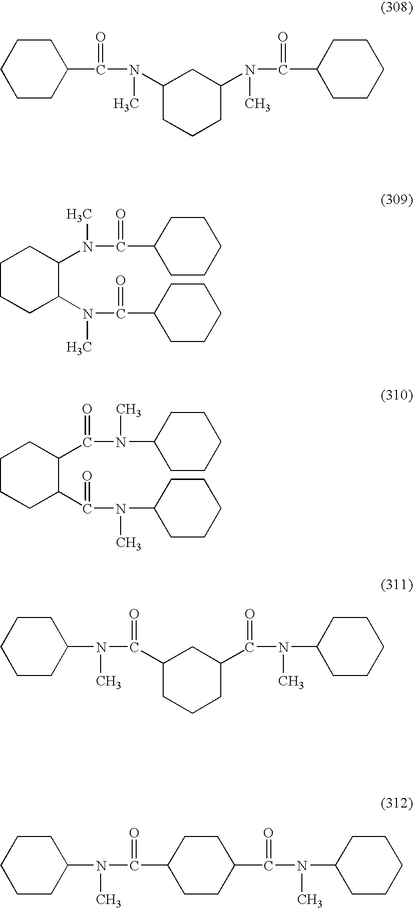

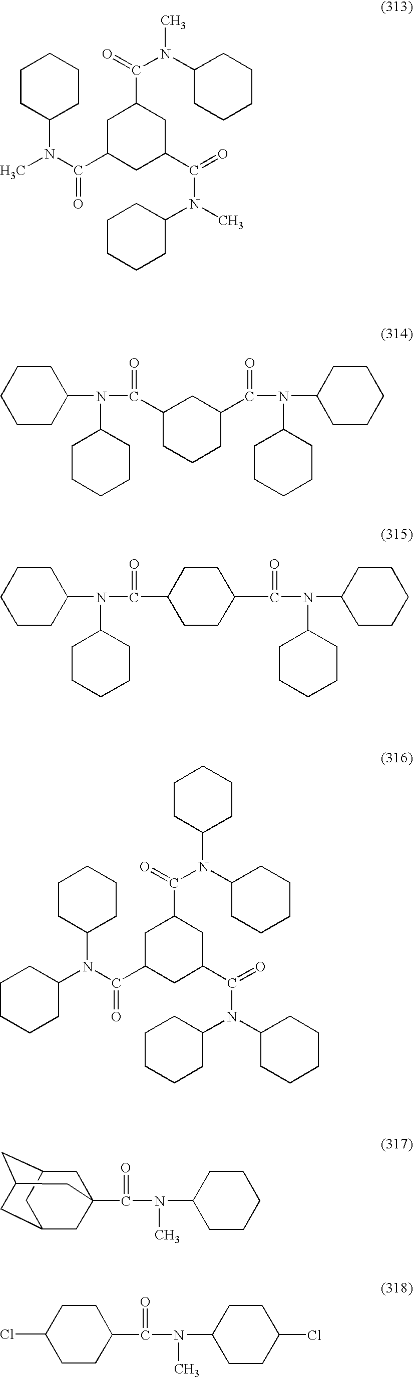

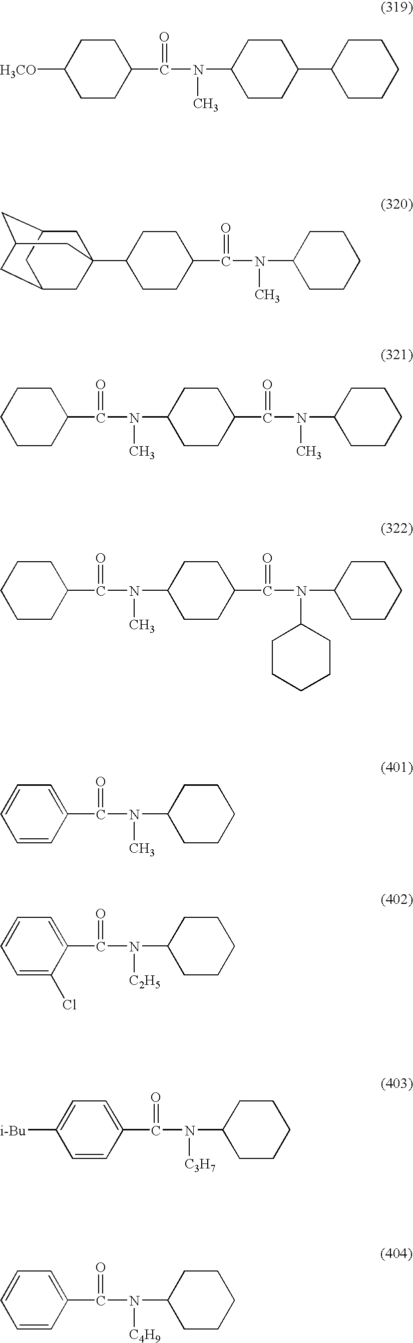

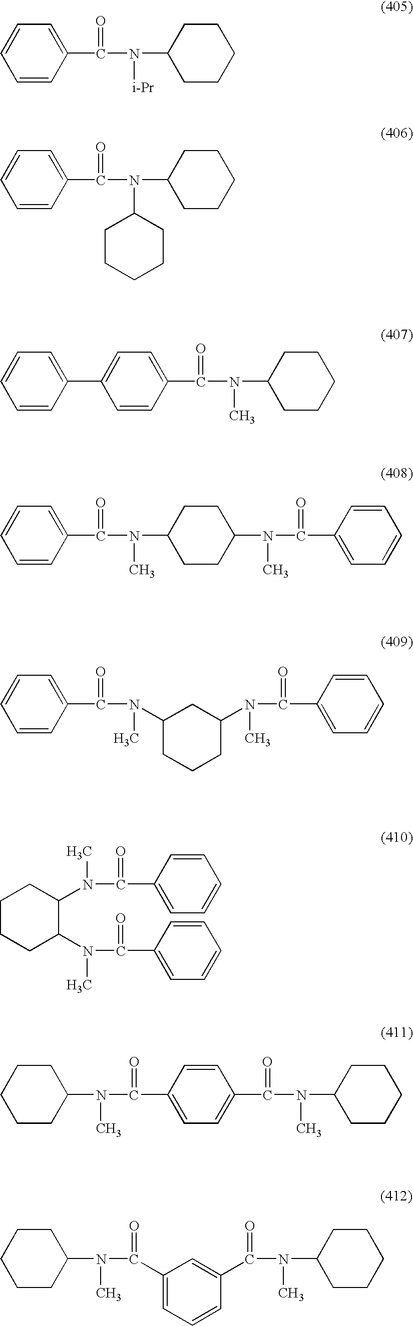

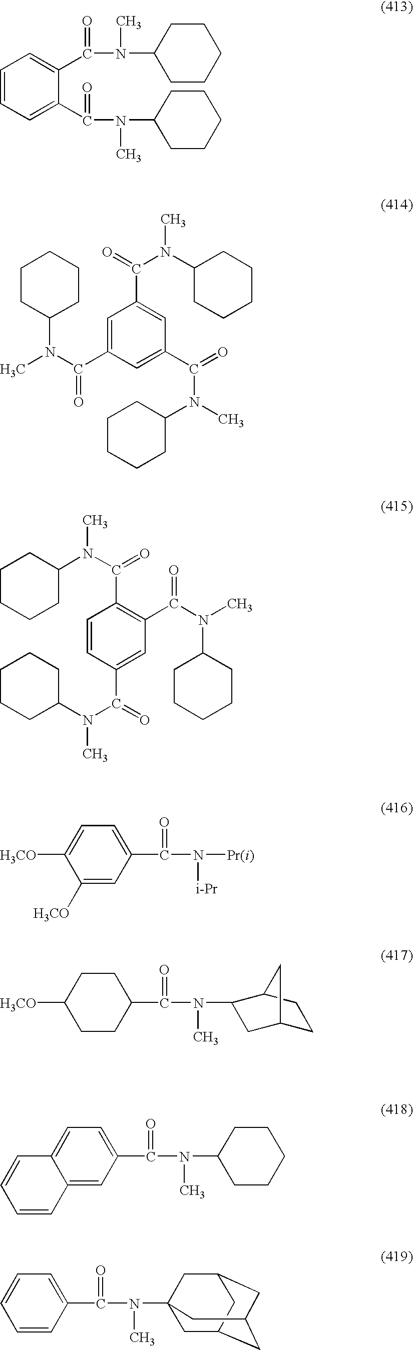

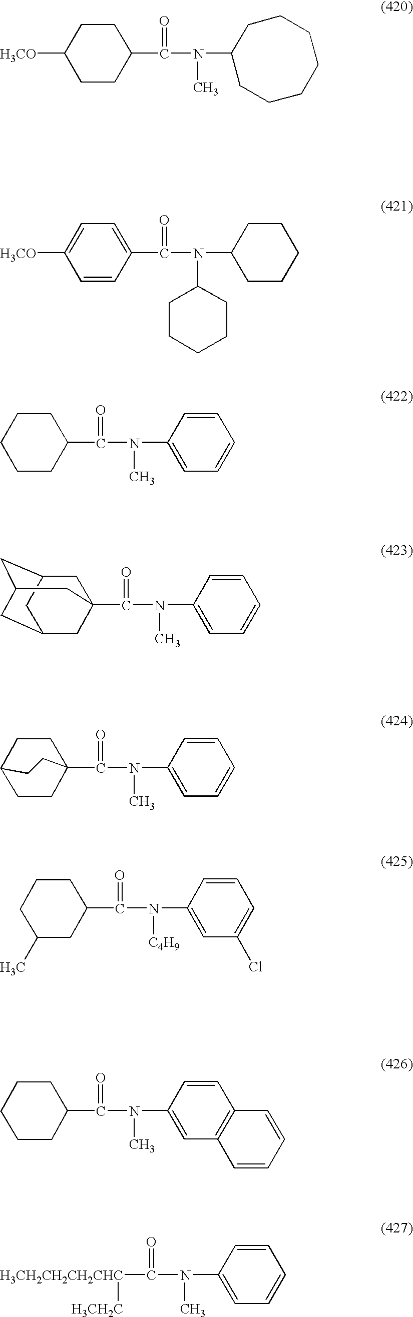

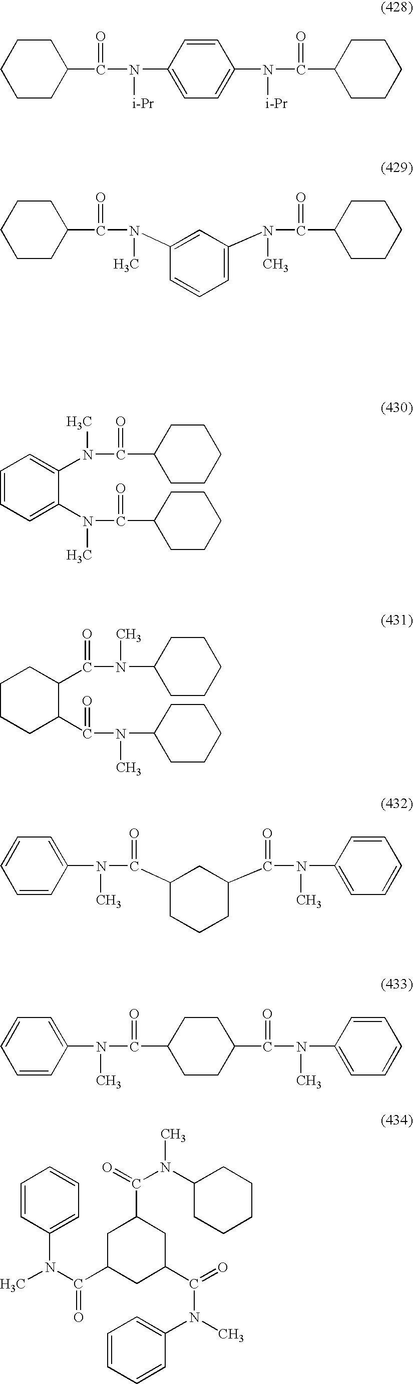

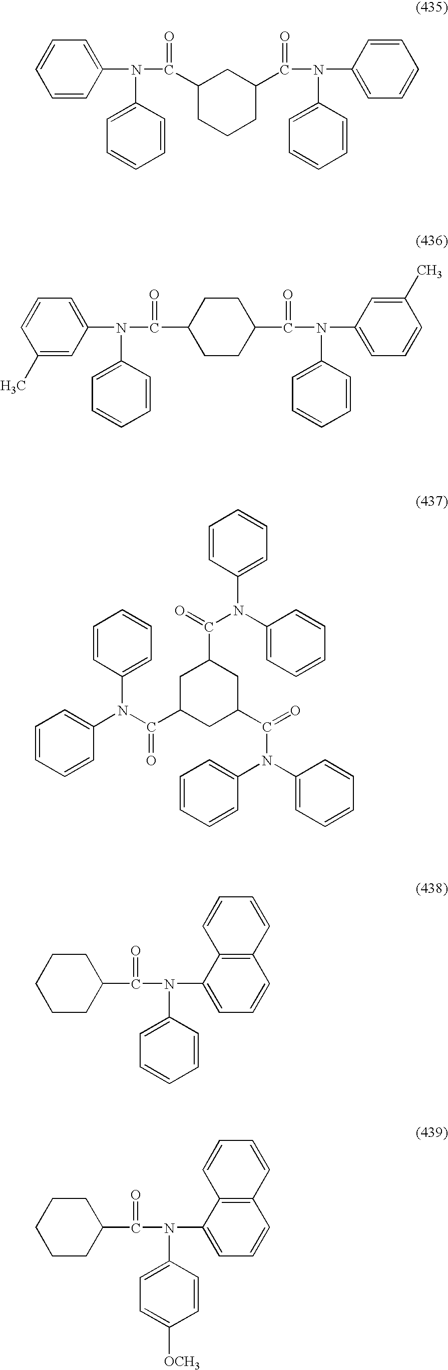

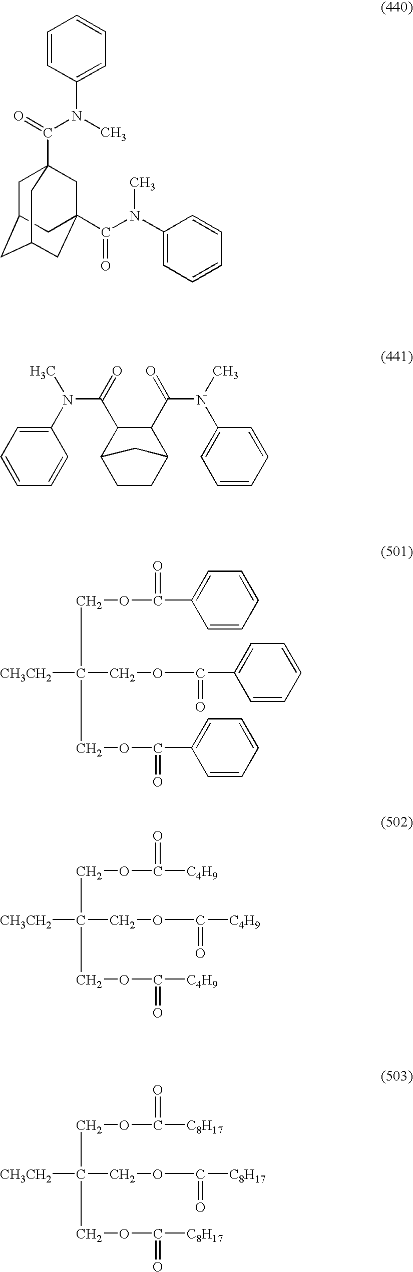

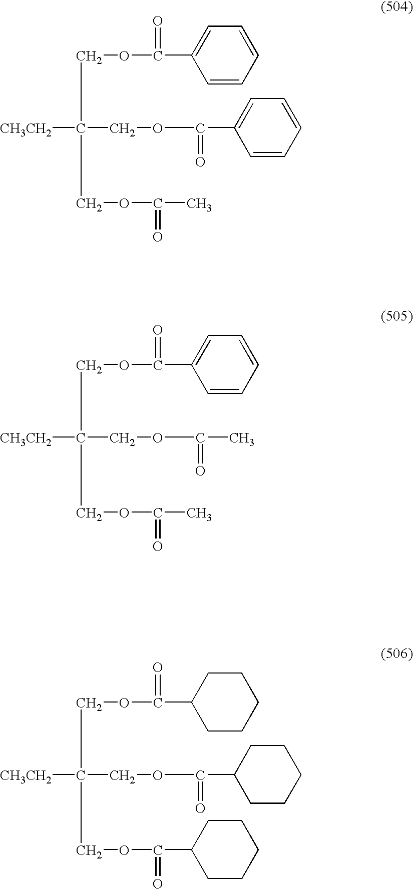

### [Wavelength Distribution Controlling Agent]

Next, compounds capable of reducing wavelength distribution of a cellulose acylate film will be described below. It is preferred to incorporate a compound showing an absorption in the UV ray region of 200 to 400 nm and capable of reducing |Re₄₀₀-Re₇₀₀| and |Rth₄₀₀-Rth₇₀₀| of the film in an amount of from 0.01 to 30% by mass based on the mass of a solid component of cellulose acylate. Wavelength distribution of Re and Rth of a cellulose acylate film can be controlled by incorporating the wavelength distribution controlling agent. Here, Re400 and Rth400 each represents a value at a wavelength λ of 400 nm, and Re700 and Rth700 each represents a value at a wavelength λ of 700 (unit: nm in both cases). The wavelength distribution of Re and Rth of the cellulose acylate film can be controlled by incorporating the compound in an amount of 0.1 to 30% by mass.

The values of Re and Rth of the cellulose acylate film are generally of such wavelength characteristics that they are larger in the longer wavelength side than in the shorter wavelength side. Therefore, it is required to render flat the wavelength distribution by increasing relatively smaller Re and Rth on the shorter wavelength side. On the other hand, a compound having an absorption in the UV ray region of 200 to 400 nm has such wavelength distribution characteristics that it shows a larger absorption in the longer wavelength side than in the shorter wavelength side. It is expected that, if this compound itself exists isotropically within the cellulose acylate film, birefringent properties of the compound itself and, therefore, wavelength distribution of Re and Rth, are larger in the shorter wavelength side as is the same with wavelength distribution of absorption.

Accordingly, the wavelength distribution of Re and Rth of the cellulose acylate film can be controlled by using a compound which has an absorption in the UV ray region of 200 to 400 and which is expected to show a larger wavelength distribution of Re and Rth of the compound itself on the shorter wavelength side. For controlling it, the compound capable of controlling wavelength distribution is required to be sufficiently uniformly compatible with cellulose acylate. The absorption range in the UV ray region of the compound is preferably from 200 to 400 nm, more preferably from 220 to 395 nm, still more preferably from 240 to 390 nm.

In addition, with liquid crystal display devices for a TV set, a notebook personal computer or a mobile terminal, it has been required in recent years for an optical member for use in the liquid crystal display devices to have an excellent transmittance. From this standpoint, in the case of adding the compound having an absorption in the UV ray region of 200 to 400 nm and capable of reducing |Re₄₀₀-Re₇₀₀| and |Rth₄₀₀-Rth₇₀₀| of the film to a cellulose acylate film, the compound is required to have an excellent spectral transmittance. In the cellulose acylate film to be preferably used in the invention, the spectral transmittance at a wavelength of 380 nm is desirably 45% to 95%, and the spectral transmittance at a wavelength of 350 nm is desirably 10% or less.

In view of evaporating properties, the molecular mass of the wavelength distribution controlling agent to be preferably used in the invention is preferably from 250 to 1,000, more preferably from 260 to 800, still more preferably from 270 to 800, particularly preferably from 300 to 800. The compound may be of a specific monomer structure or of an oligomer or polymer structure wherein a plurality of the monomer units are connected to each other, as long as the molecular mass is within the range.

The wavelength distribution controlling agent preferably does not evaporate away during the dope-casting and drying step for preparing the cellulose acylate film.

### (Addition Amount of the Wavelength Distribution Controlling Agent)

The addition amount of the wavelength distribution controlling agent to be preferably used in the invention is preferably from 0.01 to 30% by mass, more preferably from 0.1 to 20% by mass, particularly preferably from 0.2 to 10% by mass, based on the mass of a solid component of cellulose acylate.

### (Method of Adding the Wavelength Distribution Controlling Agent)

Also, these wavelength distribution controlling agents may be used independently or as a mixture of two or more thereof with any mixing ratio.

As to the stage of adding the wavelength distribution controlling agent, the agent may be added in any step of the dope-preparing process or may be added in the final stage of the dope-preparing process.

Specific examples of the wavelength distribution controlling agent to be preferably used in the invention include benzotriazole series compounds, benzophenone series compounds, cyano group-containing compounds, hydroxybenzophenone series compounds, salicylate series compounds and nickel complex salt series compounds which, however, do not limit the invention in any way.

### [Dyes]

In the invention, a dye for adjusting hue may be added. The content of the dye is preferably from 10 to −1,000 ppm, more preferably from 50 to 500 ppm, based on the mass of cellulose acylate. Incorporation of such dye serves to reduce light piping of the cellulose acylate film and prevent formation of yellowish tint. Such compound may be added together with cellulose acylate or a solvent upon preparation of the cellulose acylate solution or may be added during or after preparation of the solution. It is also possible to add to a UV ray absorbent solution to be added in an in-line manner. Dyes described in JP-A-5-34858 can be used.

### [Fine Particles of Matt Agent]

It is preferred to add fine particles as a matt agent to the cellulose acylate film to be preferably used in the invention. As the fine particles to be used in the invention, fine particles of silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate and calcium phosphate. Fine particles containing silicon are preferred in the point that they give a reduced turbidity, with silicon dioxide being particularly preferred.

As the fine particles of silicon dioxide, those which have a primary average particle size of 20 nm or less and an apparent specific gravity of 70 g/L or more are preferred. Those which have a primary average particle size as small as 5 to 16 nm are more preferred because they can reduce a haze value of the resulting film. The apparent specific gravity is preferably from 90 to 200 g/L or more, more preferably from 100 to 200 g/L or more. A higher apparent specific gravity permits preparation of a more concentrated dispersion, which serves to reduce haze and prevent formation of agglomerates, thus being preferred.

In the case of using fine particles of silicon dioxide as the matt agent, the amount thereof to use is preferably from 0.01 to 0.3 part by mass per 100 parts by mass of a polymer component including cellulose acylate.

These fine particles usually form secondary particles of 0.1 to 3.0 μm in average particle size but, in the film, they exist as agglomerates of primary particles, forming unevenness of 0.1 to 3.0 μm on the film surface. The average particle size of the secondary particles is preferably from 0.2 μm to 1.5 μm, more preferably from 0.4 μm to 1.2 μm, most preferably from 0.6 μm to 1.1 μm. When the average particle size is 1.5 μm or less, there does not result too strong haze and, when the average particle size is 0.2 μm or more, there can be obtained a sufficient effect of preventing squeak, thus such particle size being preferred.

As to the size of primary and secondary particles of the fine particles, particles in the film are observed by means of a scanning type electron microscope, and a diameter of a circle circumscribing each particle is taken as a particle size. Also, regarding average particle size, 200 particles in different portions are observed, and the diameters are averaged to determine the average particle size.

As the fine particles of silicon dioxide, commercially available products such as “AEROSIL” R972, R972V, R974, R812, 200, 200V, 300, R202, OX50 and TT600 (these being manufactured by Nippon Aerosil K.K.) can be used. Fine particles of zirconium oxide are commercially available under the trade name of, for example, “AEROSIL” R976 and R811 (these being manufactured by Nippon Aerosil K.K.) and can be used.

Of these, “AEROSIL 200V” and “AEROSIL R972V” are particularly preferred, because they are fine particles of silicon dioxide having an average particle size of primary particles of 20 nm or less and an apparent specific gravity of 70 g/L or more and exhibit the effect of reducing the friction factor while keeping turbidity of the film at a low level.

In the invention, in order to obtain a cellulose acylate film containing particles having a small average particle size of secondary particles, there can be considered several methods for preparing a dispersion of the fine particles. For example, there is a method of previously preparing a dispersion of fine particles by stirring a solvent and fine particles to mix, adding this fine particle dispersion to a small amount of a separately prepared cellulose acylate solution, stirring them to mix, and mixing the resulting mixture with a main cellulose acylate dope solution. This method is a preferred preparation method in that good dispersibility of the silicon dioxide fine particles can be obtained and that the silicon dioxide fine particles difficultly agglomerate again. In addition, there is a method of adding a small amount of cellulose ester to a solvent and, after stirring to dissolve, adding thereto fine particles and conducting dispersing operation in a dispersing machine to prepare a solution for adding fine particles, and sufficiently mixing this solution with the dope solution in an in-line mixer. The invention is not limited only to these methods. The concentration of silicon dioxide upon mixing with a solvent to disperse is preferably from 5 to 30% by mass, more preferably from 10 to 25% by mass, most preferably from 15 to 20% by mass.

A higher dispersion concentration serves to reduce turbidity of the solution for a particular addition amount and reduce haze and formation of agglomerates, thus being preferred. The addition amount of the matt agent in the final cellulose acylate dope solution is preferably from 0.01 to 1.0 g, more preferably from 0.03 to 0.3 g, most preferably from 0.08 to 0.16 g, per m².

As the solvent to be used, there are illustrated lower alcohols, preferably methyl alcohol, ethyl alcohol, propyl alcohol, isopropyl alcohol and butyl alcohol. As to other solvents than the lower alcohols, there are no particular restrictions, but a solvent used upon formation of a film of cellulose ester is preferred to use.

Next, the organic solvent to be preferably used in the invention in which cellulose acylate is dissolved will be described below.

In the invention, either of a chlorine-containing solvent containing a chlorine-containing organic solvent as a major component and a chlorine-free solvent not containing a chlorine-containing organic solvent may be used.

### [Chlorine-Containing Solvent]

In preparing a cellulose acylate solution to be preferably used in the invention, a chlorine-containing organic solvent is preferably used as a main solvent. The kind of the chlorine-containing organic solvent is not particularly limited as long as it can dissolve cellulose acylate and permit casting and filming. Such chlorine-containing organic solvents are preferably dichloromethane and chloroform, with dichloromethane being particularly preferred. It does not cause any particular problem to mix with other organic solvent than the chlorine-containing organic solvent. In such cases, dichloromethane is preferably used in an amount of at least 50% by mass based on the whole mass of the organic solvents.

Other organic solvents to be used in the invention in combination with the chlorine-containing organic solvent will be described below.

That is, as other organic solvents, those solvents are preferred which are selected from among esters, ketones, ethers, alcohols and hydrocarbons containing from 3 to 12 carbon atoms. The esters, ketones, ethers and alcohols may have a cyclic structure. Compounds having two or more of the functional groups of ester, ketone and ester (i.e., —O—, —CO— and —COO—) can also be used as the solvents. They may have at the same time other functional groups such as a hydroxyl group. With solvents having two or more functional groups, it suffices for the number of carbon atoms to be within the range for one of the functional group. Examples of esters containing from 3 to 12 carbon atoms include ethyl formate, propyl formate, pentyl formate, methyl acetate, ethyl acetate and pentyl acetate. Examples of ketones containing from 3 to 12 carbon atoms include acetone, methyl ethyl ketone, diethyl ketone, diisopropyl ketone, cyclopentanone, cyclohexanone and methylcyclohexanone. Examples of ethers containing from 3 to 12 carbon atoms include diisopropyl ether, dimethoxymethane, dimethoxyethane, 1,4-dioxane, 1,3-dioxolan, tetrahydrofuran, anisole and phenetole. Examples of organic solvents having two or more functional groups include 2-ethoxyethyl acetate, 2-methoxyethanol and 2-butoxyethanol.

Alcohols to be used in combination with the chlorine-containing organic solvent may be straight, branched or cyclic, with saturated aliphatic hydrocarbons being preferred. The hydroxyl group of the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. Additionally, fluorine-containing alcohols may also be used. Examples thereof include 2-fluoroethanol, 2,2,2-trifluoroethanol and, 2,2,3,3-tetrafluoro-1-propanol. Further, the hydrocarbons may be straight, branched or cyclic. Either of aromatic hydrocarbons and aliphatic hydrocarbons may be used. The aliphatic hydrocarbons may be saturated or unsaturated. Examples of the hydrocarbons include cyclohexane, hexane, benzene, toluene and xylene.

Examples of a combination of the chlorine-containing organic solvent and other organic solvent are illustrated below which, however, are not limitative at all.

Dichloromethane/methanol/ethanol/butanol=80/10/5/5 (parts by mass)
Dichloromethane/acetone/methanol/propanol=80/10/5/5 (parts by mass)
Dichloromethane/methanol/butanol/cyclohexane=80/10/5/5 (parts by mass)
Dichloromethane/methyl ethyl ketone/methanol/butanol=80/10/5/5 (parts by mass)
Dichloromethane/acetone/methyl ethyl ketone/ethanol/isopropanol=75/8/5/5/7 (parts by mass)
Dichloromethane/cyclopentanone/methanol/isopropanol=80/7/5/8 (parts by mass)
Dichloromethane/methyl acetate/butanol=80/10/10 (parts by mass)
Dichloromethane/cyclohexanone/methanol/hexane=70/20/5/5 (parts by mass)
Dichloromethane/methyl ethyl ketoned/acetoned/methanol/ethanol=50/20/20/5/5 (parts by mass)
Dichloromethane/1,3-dioxolan/methanol/ethanol=70/20/5/5 (parts by mass)
Dichloromethane/dioxane/acetone/methanol/ethanol=60/20/10/5/5 (parts by mass)
Dichloromethaneacetone/cyclopentanone/ethanol/iso-propanol/cycloexane 65/10/110/5/515 (parts by mass)
Dichloromethane/methyl ethyl ketoned/acetone/methanol/ethanol=70/10/10/5/5 (parts by mass)
Dichloromethane/acetone/ethyl acetate/ethanol/butanol/hexane=65/10/5/5/5 (parts by mass)
Dichloromethane/methyl acetacetate/methanolo/ethanol=65/20/10/5 (parts by mass)
Dichloromethane/cyclopentanone/ethanol/butanol=65/20/10/5 (parts by mass)

### [Chlorine-Free Solvent]

Next, chlorine-free organic solvents to be preferably used in preparing a cellulose acylate solution which is preferably used in the invention will be described below. In the invention, the kind of the chlorine-free organic solvent is not particularly limited as long as it can dissolve cellulose acylate and permit casting and filming. As the chlorine-free organic solvent to be used in the invention, those solvents are preferred which are selected from among esters, ketones and ethers containing from 3 to 12 carbon atoms. The esters, ketones and ethers may have a cyclic structure. Compounds having two or more of the functional groups of ester, ketone and ester (i.e., —O—, —CO— and —COO—) can also be used as a main solvent. They may have other functional groups such as a hydroxyl group. With main solvents having two or more functional groups, it suffices for the number of carbon atoms to be within the range for one of the functional group. Examples of esters containing from 3 to 12 carbon atoms include ethyl formate, propyl formate, pentyl formate, methyl acetate, ethyl acetate and pentyl acetate. Examples of ketones containing from 3 to 12 carbon atoms include acetone, methyl ethyl ketone, diethyl ketone, diisopropyl ketone, cyclopentanone, cyclohexanone, methylcyclohexanone and methyl acetylacetate. Examples of ethers containing from 3 to 12 carbon atoms include diisopropyl ether, dimethoxymethane, dimethoxyethane, 1,4-dioxane, 1,3-dioxolan, tetrahydrofuran, anisole and phenetole. Examples of organic solvents having two or more functional groups include 2-ethoxyethyl acetate, 2-methoxyethanol and 2-butoxyethanol.

The chlorine-free organic solvents to be used for cellulose acylate are selected from the aforesaid various viewpoints, and are preferably as described below.

That is, as the chlorine-free solvent, a mixed solvent containing the above-described chlorine-free organic solvent as a main solvent is preferred. Such mixed solvent is a mixed solvent of three or more solvents different from each other wherein the first solvent is at least one solvent selected from among methyl acetate, ethyl acetate, methyl formate, ethyl formate, acetone, dioxolan and dioxane or a mixture thereof, the second solvent is selected from among ketones and acetoacetates having from 4 to 7 carbon atoms, and the third solvent is selected from among alcohols and hydrocarbons containing from 1 to 10 carbon atoms, more preferably from among alcohols containing from 1 to 8 carbon atoms. Additionally, in the case where the first solvent is a mixed liquid of two or more solvents, the second solvent may be omitted. The first solvent is more preferably methyl acetate, acetone, methyl formatted, ethyl formate or a mixture thereof, and the second solvent is preferably methyl ethyl ketone, cyclopentanone, cyclohexanone or methyl acetylacetate or may be a mixed solvent thereof.

The hydrocarbon chain of the third solvent alcohol may be straight, branched or cyclic, with a saturated aliphatic hydrocarbon chain being preferred. The hydroxyl group of the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. Additionally, as the alcohols, fluorine-containing alcohols wherein part or the whole of hydrogen atoms of the hydrocarbon chain are substituted by fluorine atom may also be used. Examples thereof include 2-fluoroethanol, 2,2,2-trifluoroethanol and 2,2,3,3-tetrafluoro-1-propanol.

Further, the hydrocarbons may be straight, branched or cyclic. Either of aromatic hydrocarbons and aliphatic hydrocarbons may be used. The aliphatic hydrocarbons may be saturated or unsaturated. Examples of the hydrocarbons include cyclohexane, hexane, benzene, toluene and xylene.

These third solvent alcohols may be used alone or as a mixture of two or more thereof with no particular limitation. As the third solvent, preferred specific examples of alcohols include methanol, ethanol, 1-propanol, 2-propanol, 1-butanol, 2-butanol and cyclohexanol and preferred specific examples of hydrocarbons include cyclohexane and hexane, with methanol, ethanol, I-propanol, 2-propanol and 1-butanol being particularly preferred

As to the mixing proportion of the three kinds of solvents in the mixed solvent, the first solvent is preferably contained in a content of from 20 to 95% by mass, the second solvent is preferably contained in a content of from 2 to 60% by mass, and the third solvent is preferably contained in a content of from 2 to 30% by mass. More preferably, the first solvent is contained in a content of from 30 to 90% by mass, the second solvent is contained in a content of from 3 to 50% by mass, and the third solvent alcohol is contained in a content of from 3 to 25% by mass. Particularly preferably, the first solvent is contained in a content of from 30 to 90% by mass, the second solvent is contained in a content of from 3 to 30% by mass, and the third solvent alcohol is contained in a content of from 3 to 15% by mass.

The chlorine-free organic solvents to be used in the invention are described in more detail in Hatsumei Kyokai Kokai Giho, Kogi-No. 2001-1745 (published on 15, Mar., 2001 by Hatsumei Kyokai), pp. 12-16.

Preferred combinations of the chlorine-free organic solvents are illustrated below which, however, do not limit the invention in any way.

Methyl acetate/acetone/methanol/ethanol/butanol=75/10/5/5/5 (parts by mass)
Methyl acetate/acetone/methanol/ethanol/propanol=75/10/5/5/5 (parts by mass)
Methyl acetate/acetone/methanol/butanol/cyclohexane=75/10/5/5/5 (parts by mass)
Methyl acetate/acetone/ethanol/butanol=81/8/7/4 (parts by mass)
Methyl acetate/acetone/ethanol/butanol=82/10/4/4 (parts by mass)
Methyl acetate/acetone/ethanol/butanol=80/10/4/6 (parts by mass)
Methyl acetate/methyl ethyl ketone/methanol/butanol=80/10/5/5 (parts by mass)
Methyl acetate/acetone/methyl ethyl ketone/ethanol/iso-propanol=75/8/5/5/7 (parts by mass)
Methyl acetate/cyclopentanone/methanol/isopropanol=80/7/5/8 (parts by mass)
Methyl acetate/acetone/butanol=85/10/5 (parts by mass)
Methyl acetate/cyclopentanone/acetone/methanol/butanol=60/15/14/5/6 (parts by mass)
Methyl acetate/cyclohexanone/methanol/hexane=70/20/5/5 (parts by mass)
Methyl acetate/methyl ethyl ketone/acetone/methanol/ethanol=50/20/20/5/5 (parts by mass)
Methyl acetate/1,3-dioxolan/methanol/ethanol=70/20/5/5 (parts by mass)
Methyl acetate/dioxane/acetone/methanol/ethanol=60/20/10/5/5 (parts by mass)
Methyl acetate/acetone/cyclopentanone/ethanol/isopropanol/cyclohexane=65/10/10/5/5/5 (parts by mass)
Methyl formate/methyl ethyl ketone/acetone/methanol/ethanol=50/20/20/5/5 (parts by mass)
Methyl formate/acetone/ethyl acetate/ethanol/butanol/hexane=65/10/10/5/5/5 (parts by mass)
Acetone/methyl acetacetate/methanol/ethanol=65/20/10/5 (parts by mass)
Acetone/cyclopentanone/ethanol/butanol=65/20/10/5 (parts by mass)
Acetone/1,3-dioxolan/ethanol/butanol=65/20/10/5 (parts by mass)
1,3-Dioxolan/cyclohexanone/methyl ethyl ketone/methanol/butanol=55/20/10/5/5/5 (parts by mass)

Further, a cellulose acylate solution prepared by the following method can also be used.

A method of preparing a cellulose acylate solution using a mixed solvent of methyl acetate/acetone/ethanol/butanol=81/8/7/4 (parts by mass) and, after filtration and concentration of the resulting solution, additionally adding thereto 2 parts by mass of butanol.

A method of preparing a cellulose acylate solution using a mixed solvent of methyl acetate/acetone/ethanol/butanol=84/10/4/2 (parts by mass) and, after filtration and concentration of the resulting solution, additionally adding thereto 4 parts by mass of butanol.

A method of preparing a cellulose acylate solution using a mixed solvent of methyl acetate/acetone/ethanol=84/10/6 (parts by mass) and, after filtration and concentration of the resulting solution, additionally adding thereto 5 parts by mass of butanol.

To the dope to be used in the invention may be incorporated dichloromethane in a content of 10% by mass or less based on the amount of all of the organic solvents in addition to the chlorine-free organic solvents of the invention.

### [Characteristic Properties of Cellulose Acylate Solution]

The cellulose acylate solution is a solution prepared by dissolving cellulose acylate in the organic solvents. In view of adaptability to formation of a film by casting, the concentration is preferably in the range of from 10 to 30% by mass, more preferably from 13 to 27% by mass, particularly preferably from 15 to 25% by mass.

In order to adjust the concentration of the cellulose acylate solution to a level within the range, the concentration may be adjusted to a predetermined level at the stage of dissolution, or a solution of a low concentration (e.g., 9 to 14% by mass) may previously be prepared, and the concentration is adjusted to a predetermined high level in the concentrating step to be described hereinafter. Further, after previously preparing a cellulose acylate solution with a high concentration, various additives may be added thereto to lower the concentration to thereby prepare a cellulose acylate solution with a predetermined low concentration. Any of these methods does not involve particular problems as long as they are conducted so as to provide a cellulose acylate solution with a concentration which can preferably be used in the invention.

Next, in the invention, it is preferred that the molecular mass of associated molecules of cellulose acylate in a dilute solution thereof obtained by adjusting the concentration of cellulose acylate in an organic mixed solvent of the same formulation as that for the dope solution to 0.1 to 5% by mass be 150,000 to 9,000,000 from the point of view of solubility into the solvent. The molecular mass of the associated molecules is more preferably from 180,000 to 9,000,000. This molecular mass of associated molecules can be determined by the static light-scattering method. Dissolution of the molecules is preferably conducted so that the inertia radius simultaneously determined becomes from 10 to 200 nm, more preferably from 20 to 200 nm. Further, dissolution is preferably conducted so that the second virial coefficient becomes from −2×10⁻⁴ to +4×10⁻⁴, more preferably from −2×10⁴ to +2×10⁴.

Here, definitions of the molecular mass of associated molecules, inertia radius and second virial coefficient are described below. These are measured in the following manner according to the static light-scattering method. Although measurements are conducted in a dilute region for device's convenience, the measured values reflect the behavior of the dope of the invention in a high concentration region.

First, cellulose acylate is dissolved in a solvent to be used for the dope, thus solutions of 0.1% by mass, 0.2% by mass, 0.3% by mass and 0.4% by mass in concentration being prepared. Additionally, cellulose acylate is weighed at 25° C. and 10% RH using a sample having been dried at 120° C. for 2 hours in order to avoid absorption of moisture by the sample. The dissolving method is conducted according to the method employed upon dissolving the dope (a method of dissolving at an ordinary temperature, a method of dissolving under cooling or a method of dissolving at an elevated temperature). Subsequently, these solutions and solvents are filtered through a 0.2-μm Teflon-made filter. Then, static light scattering of each of the thus-filtered solutions is measured at 25° C. from 30° to 140° at 100 intervals using a light scattering-measuring apparatus “DLS-700” (manufactured by OTSUKA ELECTRONICS CO., LTD.). The thus-obtained data are analyzed according to the BERRY plot method. Additionally, as the refractive index necessary for this analysis, that of the solvent determined by means of an Abbe's refractometer is used, and the concentration gradient of refractive index (dn/dc) is measured by means of a differential refractometer “DRM-1021” (manufactured by OTSUKA ELECTRONICS CO., LTD.) using the solvent and the solution having been used for measuring light scattering.

### [Preparation of Dope]

Next, preparation of a solution (dope) for casting and filming cellulose acylate will be described below.

Methods for dissolving cellulose acylate are not particularly limited, and dissolution may bed conducted by a method of dissolving at a room temperature, a method of dissolving under cooling, a method of dissolving at an elevated temperature or by a combination thereof. As to dissolution, descriptions are given in, for example, JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017 and JP-A-11-302388 as methods for preparing a cellulose acylate solution.

Of these methods of dissolving cellulose acylate in an organic solvent, techniques within the scope of the invention can properly be employed. Detailed descriptions on these, particularly chlorine-free solvent system, are given in Hatsumei Kyokai Kokai Giho Kogi No. 2001-1745 (published on 15, Mar. 2001 by Hatsumei Kyokai), pp. 22-25, and dissolution can be conducted according to the methods described there. Further, as to a dope solution of cellulose acylate to be preferably used in the invention, concentration and filtration of the solution are usually conducted, and detailed description thereon are similarly given in Hatsumei Kyokai Kokai Giho Kogi No. 2001-1745 (published on 15, Mar. 2001 by Hatsumei Kyokai), p. 25. Additionally, in the case of dissolving at an elevated temperature, dissolving procedure is in most cases conducted at a temperature higher than the boiling point of the organic solvent and, in such cases, the procedure is conducted under pressure.

The cellulose acylate solution preferably has a viscosity and a dynamic storage modulus of elasticity within the following ranges, respectively, which serves to facilitate casting. These are measured on 1 mL of a sample solution using “Steel Cone” of 4 cm/2° in diameter in a rheometer “CLS 500” (both being manufactured by TA Instruments). As to measuring conditions, a static non-Newtonian viscosity n*(Pa·s) at 40° C. and a storage modulus of elasticity G′(Pa) at −5° C. are determined by measuring in the range of from 40° C. to −10° C. with varying at a rate of 2°/min in Oscillation Step/Temperature Ramp. Additionally, a sample solution is kept at a temperature for measurement till the solution temperature becomes constant before initiation of the measurement.

In the invention, the viscosity at 40° C. is preferably from 1 to 400 Pa·s, more preferably from 10 to 200 Pa·s, and the dynamic storage modulus of elasticity at 15° C. is preferably 500 Pa or more, more preferably from 100 to 1,000,000. Further, the larger the dynamic storage modulus of elasticity at a low temperature, the more preferred. For example, in the case where a support for casting is at −5° C., the dynamic storage modulus of elasticity at −5° C. is preferably from 10,000 to 1,000,000 Pa whereas, in the case where the support is at −50° C., the dynamic storage modulus of elasticity at −50° C. is preferably from 10,000 to 5,000,000 Pa.

In the invention, use of the aforesaid specific cellulose acylate permits to obtain a highly concentrated dope. That is, a highly concentrated cellulose acylate solution having an excellent stability can be obtained without the particular procedure of concentration. It is also possible to first dissolve cellulose acylate at a low concentration in order to facilitate dissolution, and then concentrate the solution using a concentrating means. The concentrating method is not particularly limited, but concentration can be conducted by a method of introducing a low-concentration solution between a housing and a rotation locus of a rotating blade which is provided in the housing and rotates in the peripheral direction while giving a temperature difference from the solution temperature, thus obtaining a highly concentrated solution with evaporating the solvent (e.g., JP-A-4-259511) or a method of blowing a heated low-concentration solution into a vessel through a nozzle to thereby flash evaporate the solvent while the solution travels from the nozzle to the inner wall of the vessel, with removing the solvent vapor from the vessel and recovering a highly concentrated solution from the bottom of the vessel (e.g., U.S. Pat. Nos. 2,541,012, 2,858,229, 4,414,341 and 4,504,355).

The dope solution is preferably filtered using a filter member such as a wire gauze or flannel to remove insolubles, dusts and impurities before casting. In filtering the cellulose acylate solution, use of a filter of 0.1 to 100 μm in absolute filtration accuracy is preferred, and use of a filter of 0.5 to 25 μm in absolute filtration accuracy is more preferred. The thickness of the filter is preferably from 0.1 to 10 mm, more preferably from 0.2 to 2 mm. In such case, filtration is conducted under a filtering pressure of preferably 1.6 MPa or less, more preferably 1.2 MPa or less, still more preferably 1.0 MPa or less, particularly preferably 0.2 MPa or less. As the filter member, conventionally known materials such as glass fibers, cellulose fibers, filter paper and fluorine-containing resins such as tetrafluoroethylene resin can preferably be used. In particular, ceramics and metals are preferably used. The viscosity of the cellulose acylate solution immediately before forming a film may be within a range which permits casting upon formation of the film, and is usually adjusted to a range of preferably from 10 Pa·s to 2,000 Pa·s, more preferably from 30 Pa·s to 1,000 Pa·s, still more preferably from 40 Pass to 500 Pa·s. Additionally, the temperature at this stage is not particularly limited as long as it is the temperature upon casting, but is preferably from −5 to +70° C., more preferably from −5 to +55° C.

The cellulose acylate film to be preferably used in the invention can be obtained by forming a film using the aforesaid cellulose acylate solution (dope). As a method of forming a film and an apparatus for the method, a method of forming a film by casing a solution and an apparatus for forming a filn by casting a solution having conventionally been employed for producing a cellulose triacetate film can be employed. A dope (cellulose acylate solution) prepared in a dissolving machine (tank) is once stored in a storage tank to remove foams contained in the dope for preparing a final dope. The dope is discharged through a dope-discharging outlet to a pressure type die via a pressure type quantity-measuring gear pump capable of transporting a definite quantity of a liquid with a high accuracy by controlling rotation number, and the dope is uniformly cast onto an endlessly running metal support in the casting section and, at the peeling point where the metal support makes a round, the half-dried dope film (also called web) is peeled from the metal support. The resulting web is gripped by clips at both edges thereof, and is conveyed by means of a tenter to dry while keeping the width, and subsequently conveyed by a group of rolls of a drying apparatus to complete drying, followed by winding the web in a predetermined length using a winding machine. A combination of the tenter and a group of the rolls varies depending upon the purpose. In a method of forming a functional protective film for an electronic display by solution casting, an coating apparatus is often provided, in addition to the machine of forming a film by solution casting, in order to conduct surface processing of the film such as formation of an undercoat layer, an antistatic layer, an antihalation layer or a protective layer. Each of the production steps will be simply described hereinafter which, however, is not limitative at all.

In preparing a cellulose acylate film by the solvent cast method, a prepared cellulose acylate solution (dope) is first cast onto a drum or a band to evaporate the solvent and form a film. The concentration of the dope before casting is preferably adjusted to 5 to 40% by mass in solid content. The surface of the drum or the band is preferably mirror finished. A method of casting the dope on a drum or a band having a surface temperature of 30° C. or lower is preferably employed. In particular, the temperature of the metal support is preferably in the range of from −10 to 20° C. Further, in the invention, methods described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650 can be employed.

### [Multi-Layer Casting]

The cellulose acylate solution may be cast as a single layer onto a metal support of a smooth band or drum, or two or more cellulose acylate solutions may be cast thereonto. In the case of casting two or more cellulose acylate solutions, the solutions containing cellulose acylate are cast respectively through a plurality of casting slits provided at intervals in the metal support-traveling direction to thereby laminate the layers one over the other to form a film. For example, methods described in JP-A-61-158414, JP-A-1-122419 and JP-A-11-198285 can be applied. Also, it is possible to cast a cellulose acylate solution through two casting slits to form a film. This can be conducted according to methods described in JP-B-60-27562, JP-A-61-94724, JP-A-61-947245, JP-A-61-104813, JP-A-61-158413 and JP-A-6-134933. Further, there may be employed a cellulose acylate film-casting method described in JP-A-56-162617 wherein a flow of a cellulose acylate solution having a higher viscosity is surrounded by a cellulose acylate solution having a lower viscosity, and the cellulose acylate solution having a higher viscosity and the cellulose acylate solution having a lower viscosity are extruded at the same time. Further, an embodiment described in JP-A-61-94724 and JP-A-61-94725 wherein the outside solution contains a bad solvent of an alcohol component in a more content than in the inside solution is also a preferred embodiment. Still further, a film comprising a plurality of layers can be prepared by using two casting slits, peeling a film formed on the metal support by casting through the first casting slit, and conducting second casting onto the side of the film which side has been in contact with the metal support surface. For example, there is illustrated a method described in JP-B-44-20235. The plural cellulose acylate solutions to be cast may be the same solution or different cellulose acylate solutions, thus not being particularly limited. In order to impart functions to the plural cellulose acylate layers, it suffices to extrude cellulose acylate solutions respectively having corresponding functions through respective casting slits. It is also possible to cast the cellulose acylate solution simultaneously with other functional layers (e.g., an adhesive layer, a dye layer, an antistatic layer, an antihalation layer, a UV ray-absorbing layer and a polarizing layer).

With the conventional single layer solution, it has been necessary to extrude a cellulose acylate solution having a high concentration and a high viscosity in order to form a film having a necessary thickness. In such cases, stability of the cellulose acylate solution is liable to be deteriorated, and solids are formed to cause seeding trouble or deteriorate plane properties, thus many problems being involved. As a method for solving the problems, it has become possible extrude a plurality of solutions having a high viscosity at the same time onto a metal support by casting a plurality of cellulose acylate solutions through plurality of casting slits in relatively small amounts. Thus, plane properties are improved to prepare a film having an excellent surface state and, in addition, use of a thick cellulose acylate solution serves to reduce a drying load and increase the speed of producing films.

In the case of co-casting, the thickness of the inside layer and the thickness of the outside layer are not particularly limited, but the thickness of the outside layer is preferably 10 to 50% of the thickness of the whole film, more preferably 2 to 30%. In the case of co-casting three or more layers, sum of the thickness of the layer in contact with the metal support and the thickness of the layer in contact with the air is defined as the thickness of the outside layer. In the case of co-casting, cellulose acylate solutions different from each other in concentration of an additive such as the plasticizer, the UV ray absorbent or the matt agent may be co-cast to form a cellulose acylate film of a laminate structure. For example, there can be formed a cellulose acylate film having a structure of skin layer/core layer/skin layer. For example, the matt agent can be incorporated in a more amount in the skin layer or can be incorporated only in the skin layer. The plasticizer and the UV ray absorbent can be incorporated in a more amount in the core layer than in the skin layer, or may be incorporated only in the core layer. It is also possible to change the kind of the plasticizer or the UV ray absorbent between the core layer and the skin layer. For example, at least one of a low volatile plasticizer and a UV ray absorbent can be incorporated in the skin layer, and a plasticizer having excellent plasticizing ability or a UV ray absorbent having an excellent UV ray-absorbing ability can be incorporated in the core layer. Further, it is a preferred embodiment to incorporate a peeling accelerator only in the skin layer on the metal support side. Still further, in order to gel the solution by cooling a metal support in the cooling drum method, it is also preferred to add a bad solvent of an alcohol in the skin layer in a larger amount than in the core layer. The skin layer and the core layer may be different from each other in Tg, with Tg of the core layer being preferably lower than Tg of the skin layer. Further, the viscosity of the cellulose acylate-containing solution upon casting for the skin layer may be different from that for the core layer. The viscosity of the solution for the skin layer is preferably smaller than that of the core layer, though the viscosity of the solution for the core layer may be smaller than that of the skin layer.

### [Casting Method]

As the casting method, there are illustrated a method of uniformly extruding a prepared dope onto a metal support through a pressure die, a doctor blade method of adjusting the thickness of the dope film once cast on a metal support by using a blade, and a reverse roll coater method of adjusting by means of reversely rotating rolls, with a pressure die method being preferred. The pressure die include a coat hunger type die and a T-die type die, with either of them being preferably used. In addition to the above-illustrated methods, various conventionally known methods of forming a film by casting a cellulose triacetate solution can be employed. The same effects as described in respective official gazettes can be obtained by selecting respective conditions in consideration of difference in boiling points of solvents to be used.

As the endlessly running metal support to be used in production of a cellulose acylate film to be preferably used in the invention, a drum whose surface is mirror finished by chromium plating or a stainless steel belt (also referred to as band) which is mirror finished by surface abrading is used. As to the number of the pressure dies to be used, one or more dies may be provided above the metal support, with one or two dies being preferred. In the case of providing two or more dies, the quantity of each dope to be cast may be variously changed according to each die, and the dope may be fed to individual dies at respective rates through plural accurately quantity-measuring gear pumps. The temperature of the cellulose acylate solution to be used for casting is preferably from −10 to 55° C., more preferably from 25 to 50° C. In this occasion, the solution temperature may be the same all through the steps, or may be different between the steps. In the case where the temperature is different, it suffices that the temperature is at a desired temperature immediately before casting.

### [Drying]

As to drying of a dope on the metal support to be conducted in the production of a cellulose acylate film, there are generally a method of applying hot blast from the surface side of the metal support (drum or belt), i.e., from the surface side of the web on the metal support, a method of applying hot blast from the back side of the drum or belt, and a back side-liquid-conducting method of bringing a temperature-controlled liquid into contact with the back side of the belt or drum which side is opposite to the dope-cast side to heat the drum or belt through heat conduction to thereby control the surface temperature, with the back side-liquid-conducting method being preferred. The surface temperature of the metal support before casting may be at any level as long as it is equal to or lower than the boiling point of the solvent used for the dope. However, in order to accelerate drying and remove fluidity on the metal support, the temperature is preferably set at a level lower than the boiling point of the solvent having the lowest boiling point among the solvents used by 1 to 10° C. Additionally, this does not apply in the case of cooling and peeling the cast dope without drying.

A method of applying a heated air to the surface of a web placed on a metal support is also preferred. In the case where the temperature of the heated air is high or where the amount of the heated air is large, the web is rendered to be in a rapidly dried state, resulting in a film having a small density which serves to render the modulus of elasticity of the film to be small.

In view of obtaining a desired modulus of elasticity suited in the invention, the temperature of the heated air is preferably from 140 to 190° C., more preferably from 145 to 190° C., particularly from 150 to 190° C.

### [Stretching Treatment]

The cellulose acylate film to be preferably used in the invention is preferably subjected to stretching treatment to adjust retardation. In particular, in the case of obtaining a high in-plane retardation value of a cellulose acylate film, there can be employed a method of actively stretching in the transverse direction, for example, a method of stretching a produced film described in JP-A-62-115035, JP-A-4-152125, JP-A-4-284211, JP-A-4-298310 and JP-A-11-48271.

Stretching of the film is performed at ordinary temperature or under heating. The heating temperature is preferably equal to the glass transition temperature of the film or lower than that. Stretching of the film may be a monoaxial stretching in a longitudinal or transverse direction or a spontaneous or successive biaxial stretching. The stretching is conducted with a stretch ratio of usually from 1 to 200%, preferably from 1 to 100%, particularly preferably from 1 to 50%. With a polarizing plate for a VA mode liquid crystal display device as in the invention, it is preferred to perform stretching with a stretch ratio of from 5 to 200%, more preferably from 10 to 150%, particularly preferably from 15 to 100%.

In order to prevent leakage of light in the case of viewing an optical anisotropy compensatory and polarizing plate of a liquid crystal cell from the inclined direction, use of a protective film having a in-plane retardation value of 30 nm or more. For this, a cellulose acylate film having been stretch-treated is used. In order to obtain optical properties, specifically, a film having been stretched 10% or more is preferred, and a film having been stretched 15% or more is more preferred.

However, in order to reduce the modulus of elasticity, a smaller stretch ratio is more preferred.

In order to suppress leakage of light upon viewing the polarizing plate from an inclined direction, it is necessary to dispose so that the transmission axis of the polarizer becomes parallel to the in-plane slow axis of the cellulose acylate film. The transmission axis of a polarizer in a roll film form having been continuously produced is generally parallel to the transverse direction of the roll film. Therefore, in order to continuously laminate the roll film-shaped polarizer and the protective film comprising a roll film-shaped acylate film, the in-plane slow axis of the roll film-shaped protective film must be parallel to the transverse direction of the film. Thus, it is preferred to more stretch in the transverse direction. Also, the stretching treatment may be conducted during the film-forming process, or raw film wound after filming may be subjected to the stretching treatment. In the former case, stretching may be conducted in the state of a residual solvent being contained. Preferred stretching can be conducted when the content of the residual solvent is from 2 to 30% by mass.

The content of the residual solvent (%) is defined by (A−B)/B×100. Here, A is a mass of the web, and B is a mass of the web after being dried for 60 minutes at 140° C.

The thickness of the cellulose acylate film to be preferably used in the invention obtained after drying varies depending upon its end-use, and is preferably in the range of from 5 to 500 μm, more preferably from 20 to 300 μm, particularly preferably from 30 to 150 μm. As the film for optical use, particularly for VA mode liquid crystal display devices, the thickness is preferably from 35 to 140 μm. Adjustment of the film thickness can be conducted by adjusting the concentration of solids contained in the dope, slit-to-slit gap in the nozzle of the die, the pressure for extruding through the die and the running speed of the metal support so as to obtain a desired thickness.

Also, with a polarizing plate for a VA-mode liquid crystal display device wherein absorption axes of polarizing plates on both sides of a liquid crystal cell cross at right angles with each other and the absorption axes are parallel to the longer side or the shorter side of the liquid crystal cell as in the invention, the thickness is preferably from 20 to 200 μm, more preferably from 25 to 180 μm, particularly preferably from 30 to 150 μm.

Of these, a protective film having a smaller film thickness is more preferred due to its excellent reworkability.

The width of the thus-obtained cellulose acylate film is preferably from 0.5 to 3 m, more preferably from 0.6 to 2.5 m, still more preferably from 0.8 to 2.2 m. As to the length of the film, it is preferred to wind with a length of from 100 to 10000 m per roll, more preferably from 500 to 7000, still more preferably from 1000 to 6000 m. Upon winding up the film, it is preferred to provide knurling on at least one edge with a width of preferably from 3 mm to 50 mm, more preferably from 5 mm to 30 mm, and a height of preferably from 0.5 to 500 μm, more preferably from 1 to 200 μm. This may be one-side press or both-side press.

Fluctuation of the Re₅₉₀ value of the film in the transverse direction is preferably within ±5 nm, more preferably within ±3 nm. Also, fluctuation of the Rth₅₉₀ value of the film in the transverse direction is preferably within ±10 nm, more preferably within ±5 nm. Also, fluctuation of the Re value and the Rth value in the longitudinal direction is preferably within the same range as with the transverse direction.

### [Optical Characteristics of Cellulose Acylate Film]

In this specification, Re_{λ} and Rth_{λ} respectively represent in-plane retardation and retardation along the thickness. Re_{λ} can be measured by irradiating with an incident light of λ nm in wavelength in the normal direction of the film using KOBRA 21ADH (manufactured by Ohji Measurement Co., Ltd.). Rth_{λ} can be calculated by KOBRA 21ADH based on retardation values measured in three directions, i.e., the aforementioned Re_{λ}, a retardation value measured by irradiating with an incident light of λ nm in wavelength in the direction inclined at an angle of +400 from the normal line of the film with taking the slow axis in plane (determined by KOBRA 21ADH) as an inclination axis (rotation axis), and a retardation value measured by irradiating with an incident light of λ nm in wavelength in the direction inclined at an angle of −40° from the normal line of the film with taking the slow axis in plane as an inclination axis (rotation axis).

Here, as an assumed value of average refractive index, those described in a polymer handbook (John Wiley & Sons, Inc.) and catalogues of various optical films can be used. As to films whose average refractive index is unknown, it can be known by measuring with an Abbe's refractometer. Values of average refractive index of main films are illustrated below. Cellulose acylate (1.48), cycloolefin polymer (1.52), polycarbonate (1.59), polymethyl methacrylate (1.49) and polystyrene (1.59).

nₓ (refractive index in the slow axis direction), n_{y} (refractive index in the fast axis) and n_{z} (refractive index in the depth direction) are calculated by imputing these assumed average refractive index values and the thickness into KOBRA 21ADH. Also, “KOBRA 21ADH” calculates an angle β to the direction of the normal line of film at which angle the retardation value becomes minimum to a light diffusing through the interior of the film taking the in-plane slow axis as an inclined axis.

In view of enlarging the viewing angle of a liquid crystal display device, particularly a VA-mode liquid crystal display device, it is preferred for the Re) retardation value and the Rth_{λ} retardation value to satisfy the following numerical formulae (2) and (3), respectively. It is particularly preferred in the case where the cellulose acylate film is used as a protective film for a polarizing plate on the liquid crystal cell side.

0≦Re₅₉₀≦200 Numerical formula (2)

0≦Rth₅₉₀≦400 Numerical formula (3)

[In the formulae, Re_{λ} and Rth_{λ} each represents a value at a wavelength of λ nm (unit: nm).]

In the case of reducing influence of optical anisotropy of the cellulose acylate film, it is preferred for Re_{λ} and Rth_{λ} of a protective film (cellulose acylate film) to be disposed on the liquid crystal cell side to satisfy the following numerical formulae (8) to (11):

0≦|Re₅₉₀|≦10 numerical formula (8)

|Rth₅₉₀|≦25 numerical formula (9)

|Re₄₀₀−Re₇₀₀|≦10 numerical formula (10)

|Rth₄₀₀−Rth₇₀₀|≦35 numerical formula (11)

wherein Re_{λ} and Rth_{λ} each represents a value at a wavelength of λ nm (unit: nm).

In the case of using the cellulose acylate film to be preferably used in the invention for a VA mode, there are two embodiments: one being an embodiment wherein one sheet of the film is used on each side of the cell (two-sheet type); and the other being an embodiment wherein the film is used only on one side (upper side or lower side) of the cell (one-sheet type).

With the two-sheet type, Re₅₉₀ is preferably from 20 to 100 nm, more preferably from 30 to 70 nm, and Rth₅₉₀ is preferably from 70 to 300 nm, more preferably from 100 to 200 nm.

With the one-sheet type, Re₅₉₀ is preferably from 30 to 150 nm, more preferably from 40 to 100 nm, and Rth₅₉₀ is preferably from 100 to 300 nm, more preferably from 150 to 250 nm.

Fluctuation of the in-plane slow axis angle of the cellulose acylate film to be preferably used in the invention is preferably within the range of from −2° to +2°, more preferably from −1′ to +10, most preferably from −0.5° to +0.5° with respect to the standard direction of the roll film. Here, the standard direction means the longitudinal direction of a roll film when the cellulose acylate film has been stretched in the longitudinal direction or the transverse direction of a roll film when stretched in the transverse direction.

Also, with the cellulose acylate film to be preferably used in the invention, the difference between Re value at 25° C. and 10% RH and Re value at 25° C. and 80% RH, ΔRe (=Re_{10%}-Re_{80%}), is preferably from 0 to 10 nm, the difference between Rth value at 25° C. and 10% RH and Rth value at 25° C. and 80% RH, ΔRth (=Rth_{10%}-Rth_{80%}), is preferably from 0 to 30 nm, in view of reducing change in tint with the elapse of time of a liquid crystal display device.

Further, the cellulose acylate film to be preferably used in the invention preferably has an equilibrium moisture content at 25° C. and 80% RH of 3.2% or less, in view of reducing change in tint with the elapse of time of a liquid crystal display device.

The moisture content is measured according to Karl Fischer's method using a moisture content-measuring apparatus and a sample-drying apparatus (“CA-03” and “V A-05”; both being manufactured by Mitsubishi Kagaku K.K.) and a 7 mm×35 mm cellulose acylate film sample. The amount (g) of water in the sample was divided by the mass (g) of the sample to calculate the moisture content.

Further, the cellulose acylate film to be preferably used in the invention preferably has a moisture permeability at 60° C., 95% RH and 24 hours (converted to a value for a film thickness of 80 μm) of from 400 g/m²·24 hr to 1800 g/m²·24 hr in view of reducing change in tint with the elapse of time of a liquid crystal display device.

The moisture permeability becomes smaller as the thickness is increased, whereas it becomes larger as the thickness is decreased. Thus, it is necessary to provide a standard film thickness which enables one to convert the thickness with respect to a sample with any thickness. Thus, in the invention, the film thickness is converted according to the following numerical formula (13) taking the standard thickness as 80 μm.

Moisture permeability for the converted film thickness of 80 μm=moisture permeability found×film thickness found (μm)/80 μm Numerical formula (13)

As a method for measuring moisture permeability, the method described in Kobunshi No Bussei II, (Kobunshi Jikken Koza 4; Kyoritsu Shuppan), pp. 285-294: Measurement of the amount of permeated steam (method of measuring mass, method of using a thermometer, method of measuring vapor pressure, and method of measuring absorption amount) can be applied.

In the measurement of glass transition temperature, a 5 mm×30 mm cellulose acylate film sample (non-stretched) was conditioned at 25° C. and 60% RH for 2 hours or longer, and measurement was conducted using a dynamic viscoelasticity measuring device (Vibron DVA-225 (manufactured by IT Keisoku Seigyo K.K.) with a grip-to-grip distance of 20 mm, a temperature-raising rate of 2° C./min, a measuring temperature range of from 30° C. to 200° C. and a frequency of 1 Hz. The data were plotted, with storage modulus of elasticity as logarithmic ordinate and temperature (° C.) as linear abscissa. A temperature at which a sharp reduction in storage modulus of elasticity observed when the film sample moves from a solid region to a glass transition region is taken as the glass transition temperature Tg. Specifically, a line 1 is drawn in the solid region, and a line 2 is drawn in the glass transition region, and an intersection point of lines 1 and 2 corresponds to the temperature at which the storage elasticity of modulus sharply decreases upon increasing temperature and the film initiates to soften and at which the film initiates to migrate to the glass transition region. Thus, the temperature is taken as the glass transition temperature Tg (dynamic viscoelasticity).

In measuring modulus of elasticity, a 10 mm×150 mm cellulose acylate film sample was conditioned at 25° C. and 60% RH for 2 hours, and measurement was conducted with a chuck-to-chuck distance of 100 mm at a temperature of 25° C. with a drawing speed of 10 mm/min using a tensile tester (Strograph-R2 manufactured by Toyo Seiki).

The coefficient of expansion due to absorption of moisture was determined from the dimension value of a film having been left at 25° C. and 80% RH for 2 hours or more, L_{80%}, measured by means of a pin gauge and the dimension value of a film having been left at 25° C. and 10% RH for 2 hours or more, L_{10%}, measured by means of a pin gauge according to the following numerical formula (14):

L_{80%}−L_{10%})/(80% RH−10% RH)×10⁶ numerical formula (14)

The cellulose acylate film to be preferably used in the invention preferably has a haze in the range of from 0.01% to 2%. Here, the haze can be measured in the following manner.

Haze of a 40 mm×80 mm cellulose acylate film sample was measured at 25° C. and 60% RH according to JIS K6714 using a haze meter (HGM-2DP; manufactured by SUGA TEST INSTRUMENTS CO., LTD.).

Further, the cellulose acylate film to be preferably used in the invention preferably undergoes a mass change in the range of from 0 to 5% by mass when allowed to stand at 80° C. and 90% RH for 48 hours.

Still further, the cellulose acylate film to be preferably used in the invention preferably undergoes a small dimensional change in the range of from 0 to 5% when allowed to stand at 60° C. and 95% RH and when allowed to stand at 90° C. and 5% RH for 24 hours.

The optical elasticity coefficient is preferably 50×10⁻¹³ cm²/dyne or less in view of reducing change in tint with the elapse of time of a liquid crystal display device.

As to a specific measuring method, a tensile stress was applied to a 10 mm×100 mm cellulose acylate film sample in the longitudinal direction, and retardation of the film was measured thereupon using an elipsometer (M150; manufactured by Nihon Bunko K.K.). The optical elasticity coefficient was calculated from the variation amount of retardation for the stress.

As the protective film, a cyclic polyolefin resin can be used in place of cellulose acylate.

In the invention, the term “cyclic polyolefin resin” means a polymer resin having a cyclic polyolefin structure. In the invention, the cyclic polyolefin resin is also referred to as “cyclic polyolefin”.

Examples of the polymer resins having the cyclic polyolefin structure to be used in the invention include (1) norbornene series polymers, (2) polymers of a monocyclic olefin, (3) polymers of a cyclic conjugated diene, (4) vinyl alicyclic hydrocarbon polymers, and hydrogenated products of (1) to (4). Polymer resins to be preferably used in the invention are addition (co)polymerized cyclic polyolefins containing at least one kind of repeating unit represented by the following general formula (II) and addition (co)polymerized cyclic polyolefins which further contain, as needed, at least one kind of repeating unit represented by the following general formula (I). Also, ring-opening (co)polymerized polymers having at least one kind of a cyclic repeating unit represented by the general formula (III) can preferably be used.

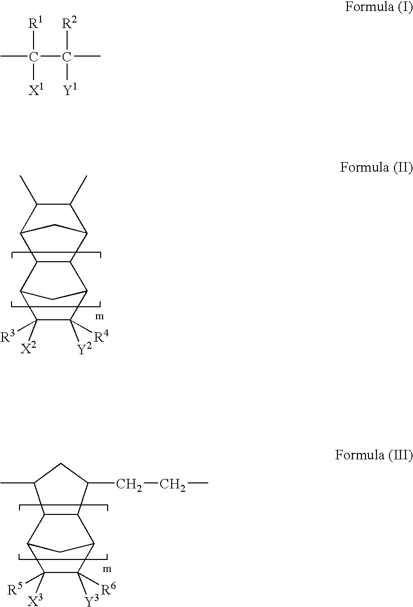

In the formulae, m represents an integer of from 0 to 4, R¹ to R⁶ represent a hydrogen atom or a hydrocarbon group having 1 to 10 carbon atom(s), X¹ to X³, Y¹ to Y³ represent a hydrogen atom, a hydrocarbon group having 1 to 10 carbon atom(s), a halogen atom, a hydrocarbon group having 1 to 10 carbon atom(s) substituted with a halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, (CH₂)ₙNR¹³R¹⁴, —(CH₂)ₙOZ or —(CH₂)ₙW, or (—CO)₂O, (—CO)₂NR¹⁵ composed of X¹ and Y′, X² and Y² or X³ and Y³. Here, R¹¹, R¹², R¹³, R¹⁴ and R¹⁵ represent a hydrogen atom or a hydrocarbon group having 1 to 20 carbon atom(s), Z represents a hydrocarbone group or a hydrocarbone group substituted with a halogen, W represents SiR¹⁶ₚD₃₋ₚ (R¹⁶ represents a hydrocarbon group having 1 to 10 carbon atom(s), D represents a halogen atom, —OCOR₁₆ or —OR¹⁶, p represents an integer of from 0 to 3), n represents an integer of from 0 to 10.

By introducing a functional group having high polarizability into substituents of X₁ to X₃, Y₁ to Y₃, it is possible to increase a retardation along a thickness of a film (Rth), and increase a developability of a retardation in plane of a film (Re). A film having a high Re developability is capable of increasing Re value by stretching during filming.

As norbornene series (co)polymers, ones described in JP-A-10-7732, JP-T-2002-504184, US 2004-229157 A1 specification or WO 2004/070463 A1 pamphlet can be used. These norbornene series (co)polymers can be obtained by addition polymerizing norbornene series polycyclic unsaturated compounds with each other. In addition, in response to necessity, addition polymerization of norbornene series polycyclic unsaturated compounds with conjugated diene such as ethylene, propylene, butene, butadiene, isoprene; non-conjugated diene such as ethylidene norbornene; or linear diene compound such as acrylonitrile, acrylic acid, methacrylic acid, maleic acid anhydride, acrylic acid ester, methacrylic acid ester, maleimide, vinyl acetate, vinyl chloride can be conducted. As norbornene series (co)polymers, commercially available products also can be used. For example, there is a grade such as APL8008T (Tg 70° C.), APL6013T (Tg 125° C.) or APL6015T (Tg 145° C.), which are sold as a commercial product name APEL by Mitsui Chemicals and different in glass transition temperature (Tg). Pellets such as TOPAS8007, TOPAS6013 and TOPAS6015 are sold by Polyplastics Co., Ltd. Further, Appear 3000 is sold by Promerus LLC.

As disclosed in JP-A-1-240517, JP-A-7-196736, JP-A-60-26024, JP-A-62-19801, JP-A-2003-1159767 or JP-A-2004-309979, norbornene series polymer hydride produced by addition of hydrogen after addition polymerization or ring-opening metathesis polymerization of polycyclic unsaturated compounds can be used. In the norbornene series polymers used in the invention, R⁵ to R⁶ preferably represent a hydrogen atom or —CH₃, X³ and Y³ represent a hydrogen atom, Cl or —COOCH₃, and the other groups are optionally selected. Commercially available products can be used for norbornene series resins, for example, commercial product name Arton G or Arton F sold by JSR Co., Ltd., or commercial product name Zeonor ZF14, ZF16, Zeonex 250 or Zeonex 280 sold by Nihon Zeon Co., Ltd. can be used.

The above cyclic polyolefin resin used in the invention has mass average molecular mass (Mw) measured by gel permeation chromatography (GPC) of preferably from 5,000 to 1,000,000, more preferably from 10,000 to 500,000, further more preferably from 50,000 to 300,000 in terms of polystyrene molecular mass. Further, molecular mass distribution (Mw/Mn; Mn is number average molecular mass measured by GPC) is preferably 10 or less, more preferably 5.0 or less, further more preferably 3.0 or less. Glass transition temperature (Tg; measured by DSC) is preferably 50 to 350° C., more preferably 80 to 330° C. and further more preferably 100 to 300° C.

In the case of reducing the influence of the cyclic polyolefin film on optical anisotropy, it is preferred for the Re(λ) and the Rth(λ) of the protective film (cyclic polyolefin film) to be disposed on the liquid crystal cell side to satisfy the foregoing numerical formulae (8) to (11).

### <Polarizing Plate>

Next, the polarizing plate relating to the invention will be described below.

With the polarizing plate relating to the invention, it is preferred for the thickness d₁ of a protective film to be disposed on the liquid crystal cell side and the thickness d₂ of a protective film to be disposed on the opposite side to the liquid crystal side to satisfy the following numerical formula (15):

0.3×d₁≦d₂≦1.3×d₁ numerical formula (15)

When the numerical formula (15) is satisfied, curling of the polarizing plate becomes within the range of from −30 mm to +15 mm in the case where protective films having about the same modulus of elasticity and about the same coefficient of expansion due to absorption of moisture are combined, thus preferred results being obtained.

Also, with the polarizing plate relating to the invention, it is preferred for the modulus of elasticity E₁ of a protective film to be disposed on the liquid crystal cell side and the modulus of elasticity E₂ of a protective film to be disposed on the opposite side to the liquid crystal side to satisfy the following numerical formula (16). When the numerical formula (16) is satisfied, curling of the polarizing plate becomes within the range of from −30 mm to +15 mm in the case where protective films having about the same modulus of elasticity and about the same coefficient of expansion due to absorption of moisture are combined, thus preferred results being obtained.

0.3×E₁≦E₂≦1.3×E₁ Numerical formula (16)

Further, the thickness d₁ and the modulus of elasticity E₁ of a protective film to be disposed on the liquid crystal cell side and the thickness d₂ and the modulus of elasticity E₂ of a protective film to be disposed on the opposite side to the liquid crystal cell side preferably satisfy the following formula (17):

0.3×E₁×d₁≦E₂×d₂≦1.3×E₁×d₁ numerical formula (17)

When the numerical formula (17) is satisfied, curling of the polarizing plate becomes within the range of from −30 mm to +15 mm even in the case where protective films having different thickness and different modulus of elasticity are combined.

Further, with the polarizing plate relating to the invention, it is preferred for the coefficient of expansion due to absorption of moisture C, of a protective film to be disposed on the liquid crystal cell side and the coefficient of expansion due to absorption of moisture C₂ of a protective film to be disposed on the opposite side to the liquid crystal side to satisfy the following numerical formula (18):

0.3×C₁≦C₂≦1.3×C₁ numerical formula (18)

When the numerical formula is satisfied, curling of the polarizing plate becomes within the range of from −30 mm to +15 mm in the case where humidity upon laminating the polarizing plate onto a liquid crystal cell is at a high level upon formation of the polarizing plate, thus preferred results being obtained.

The polarizer of the polarizing plate includes an iodine-containing polarizer, a dye-containing polarizer using a dichroic dye and a polyene series polarizer. The iodine-containing polarizer and the dye-containing polarizer are generally produced by using a polyvinyl alcohol series film.

In the case of using the cellulose acylate film to be preferably used in the invention as a protective film for the polarizing plate, the method for preparing the polarizing plate is not particularly limited, and the polarizing plate can be prepared according to general methods. For example, there is illustrated a method of alkali-treating the resulting cellulose acylate film and laminating the film on both sides of a polarizer prepared by dip-stretching a polyvinyl alcohol film in an iodine solution using an aqueous solution of a completely saponified polyvinyl alcohol. An easily sticking treatment may be conducted as described in JP-A-6-94915 and JP-A-6-118232 in place of the alkali treatment. As the adhesive for sticking the treated surface of the protective layer and the polarizer to each other, there are illustrated, for example, polyvinyl alcohol series adhesives such as polyvinyl alcohol and polyvinyl butyral and vinyl series latexes such as butyl acrylate.

In the case of using the cyclic polyolefin film as a protective film for the polarizing plate, adhesives such as acrylic polymers, epoxy series polymers, modified olefin polymers, styrene-butadiene series polymers and special synthetic rubbers can be used as well as the polyvinyl alcohol series adhesives such as polyvinyl alcohol and polyvinyl butyral and the vinyl series latexes such as butyl acrylate.

In order to enhance adhesive properties, surface treatment may be conducted. Specific methods for such surface treatment include a corona discharge treatment, a glow discharge treatment, a flame treatment, an acid treatment, an alkali treatment and a UV ray-irradiating treatment. It is also preferred to provide an undercoat layer as described in JP-A-7-333433. In view of maintaining plane properties of the film, the temperature of the polymer film is preferably kept at a level of Tg (glass transition temperature) or lower than that in these treatments.

The polarizing plate is constituted by a polarizer, protective films protecting both sides of the polarizer and an adhesive layer on at least one side. Further, a separate film may be laminated on the adhesive layer surface, and a protect film may be laminated on the opposite side of the polarizing plate to the separate film side. The protect film and the separate film are used for protecting the polarizing plate upon shipping the polarizing plate and upon checking the product. In this occasion, the protect film is used for the purpose of protecting the surface of the polarizing plate, and is applied to the opposite side of the polarizing plate to the side to be laminated onto a liquid cell. Also, the separate film is used for the purpose of covering the adhesive layer to be used for laminating the polarizing plate to the liquid crystal cell, and is applied to the side of the polarizing plate to be laminated onto a liquid cell.

The adhesive layer is formed by coating a solution of a composition containing a (meth)acrylic copolymer (A) {or a high molecular (meth)acrylic copolymer (A₁) and a low molecular (meth)acrylic (co)polymer (A₂)) on the separate film using a coater such as a die coater and, after drying, transferring onto the protective film of the polarizing plate together with the separate film. Alternatively, the solution of the composition may be coated on the protective film of the polarizing plate and, after drying, the thus-formed adhesive layer may be covered by the separate film.

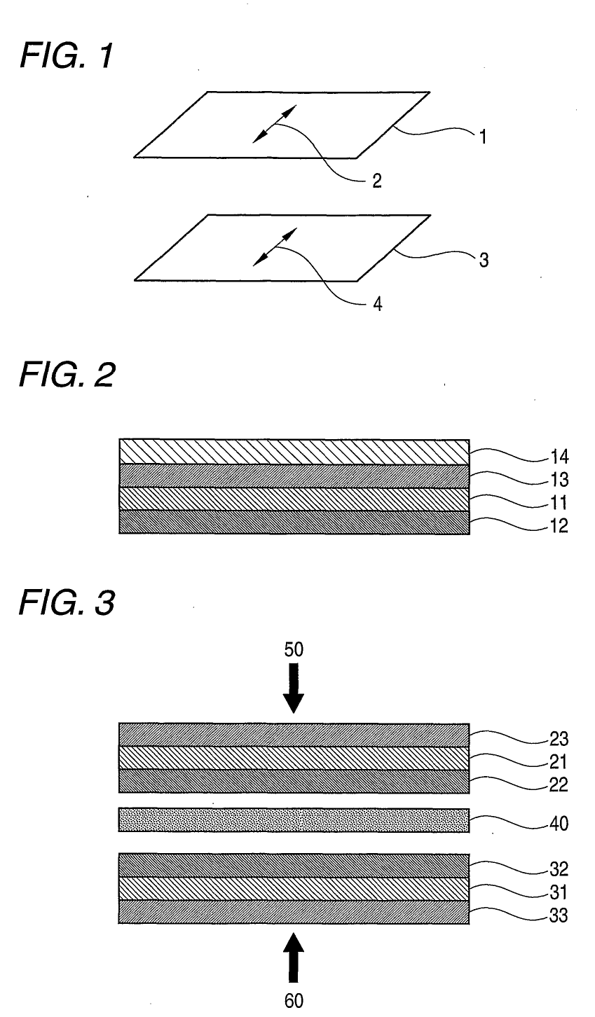

As to a manner of laminating the stretched cellulose acylate film onto a polarizer, it is preferred to laminate, as shown in FIG. 1, a polarizer 1 and a cellulose acylate film 3 so that a transmission axis 2 of the polarizer 1 coincides with a slow axis 4 of the cellulose acylate film 3.

Additionally, with a polarizing plate prepared under a cross-Nicol position, if the slow axis of the cellulose acylate film to be preferably used in the invention crosses at right angles with the absorption axis of the polarizer (axis crossing at right angles with the transmission axis) with an accuracy within 1°, troubles such as reduction of polarizing performance under a cross-Nicol position to cause light omission or failure not to obtain a sufficient black level or a sufficient contrast when combined with a liquid crystal cell are difficultly caused. Thus, deviation between the direction of the slow axis of the cellulose film to be preferably used in the invention and the direction of the transmission axis of the polarizing plate is preferably within 1°, more preferably within 0.5°.

Lamination of the polarizing plate to a liquid crystal cell is generally conducted by setting the polarizing plate on a suction jig having a number of perforations, delaminating a separate film on the surface of an adhesive layer formed by coating an adhesive, bringing the adhesive layer surface into contact with the liquid crystal cell, and applying pressure using rollers. In this occasion, if the polarizing plate is concavely curled toward the liquid crystal side, suction to the suction jig becomes insufficient, which leads to deviation in the angle of setting the polarizing plate to the suction jig and deviation in the laminating angle to the liquid crystal cell, thus designed display characteristics not being obtained. In some cases, the polarizing plate drops from the suction jig, and the laminating work must be stopped.

In order to prevent such troubles in laminating the polarizing plate, the curling degree of the polarizing plate is preferably suppressed to a range of from −30 mm to +15 mm, more preferably from −20 mm to +5 mm, most preferably from −10 mm to 0 mm. Here, the case where the polarizing plate curls convexly to the side to be laminated onto the liquid crystal cell (adhesive-cated surface=adhesive layer surface) is referred to as + (plus) curl, and the case where the polarizing plate curls concavely to the side to be laminated onto the liquid crystal cell is referred to as − (minus) curl. The degree of curl can be controlled by adjusting the relation between the thickness, modulus of elasticity and coefficient of expansion due to absorption of moisture of the protective film on the liquid crystal cell side and those of the protective film on the side opposite to the liquid crystal cell side.

The degree of curl is measured as follows. A 230 mm×305 mm size polarizing plate is placed on a flat support with the edge-rising surface facing downward. After leaving for 2 hours or longer in an environment of 25 C and 60% RH, the height of the edge of the polarizing plate most isolated from the surface of the support is measured, with the height being taken as the degree of curl. When the polarizing plate has a separate film or a protect film, measurement is conducted with such film thereon.

### [Surface Treatment of Cellulose Acylate Film]

The cellulose acylate film to be preferably used in the invention can be, in some cases, subjected to surface treatment to improve adhesion between the cellulose acylate film and various functional layers (e.g., an undercoat layer and a back layer). As the surface treatment, there can be employed a glow discharge treatment, a UV ray irradiation treatment, a corona treatment, a flame treatment or a treatment with an acid or an alkali. The glow discharge treatment may be a low-temperature plasma treatment conducted under a 10⁻³ to 20 Torr low-pressure gas, or may be a plasma treatment under the atmospheric pressure. Plasma-forming gases mean gases forming plasma under the above-described conditions and include argon, helium, neon, krypton, xenon, nitrogen, carbon dioxide, flons such as tetrafluoromethane, and a mixture thereof. These are described in detail in Hatsumei Kyokai Kokai Giho, Kogi No. 2001-1745 (published on 15, Mar. 2001 by Hatsumei Kyokai), pp. 30-32. Additionally, a plasma treatment under the atmospheric pressure, which has been noted in recent years, uses an irradiation energy of from 20 to 500 Kgy under 10 to 1,000 Kev, more preferably from 20 to 300 Kgy under 30 to 500 Kev. Of these treatments, an alkali saponification treatment is particularly preferred, which is extremely effective as a surface treatment for the cellulose acylate film.

### [Alkali Saponification Treatment]

The alkali saponification treatment is preferably conducted according to a method of directly dipping a cellulose acylate film into a tank of a saponification solution or a method of coating the saponification solution onto a cellulose acylate film. Examples of the coating method include a dip coating method, a curtain coating method, an extrusion coating method, a bar coating method and an E-type coating method.

As to a solvent for the coating solution of alkali saponification treatment, it is preferred to select a solvent which has good wetting properties and can keep the surface state in a good state without forming unevenness on the surface of the cellulose acylate film. Specifically, alcohol series solvents are preferred, with isopropyl alcohol being particularly preferred. Also, an aqueous solution of a surfactant can be used as a solvent. As the alkali for the coating solution of alkali saponification, alkalis which dissolve in the above-mentioned solvents are preferred, with KOH and NaOH being more preferred. The pH of the coating solution of saponification is preferably 10 or more, more preferably 12 or more. As to the reaction conditions upon alkali saponification, the reaction is conducted preferably at room temperature for 1 second to 3 minutes, more preferably for 5 seconds to 5 minutes, particularly preferably for 20 seconds to 3 minutes. After the alkali saponification reaction, the surface having been coated with the saponification solution is preferably washed with water, or washed with successive, an acid and water.

The polarizing plate relating to the invention preferably has an optically anisotropic layer on the protective layer. The optically anisotropic layer may comprise a liquid crystalline compound, a non-liquid crystalline compound or an inorganic compound an organic/inorganic composite compound and is not particularly limited as to its materials. As the liquid crystalline compound to be used, there are illustrated a low molecular compound having a polymerizable group which is aligned and polymerized by light or heat to fix the alignment and a liquid crystalline high molecular compound which is aligned by heating and cooled to fix the alignment in a glass state. As the liquid crystalline compound, those can be used which have a discotic structure, a rod-like structure or a structure showing optically biaxial properties. As the non-liquid crystalline compound, high molecular compounds having aromatic rings such as polyimides and polyesters can be used.

The optically anisotropic layer can be formed by various techniques such as coating, vacuum deposition and sputtering.

In the case of providing the optically anisotropic layer on the protective layer of the polarizing plate, the adhesive layer is provided outside the optically anisotropic layer with respect to the polarizer side.

Further, with the polarizing plate in accordance with the invention, it is preferred to provide at least one of a hard coat layer, an anti-glare layer or an anti-reflection layer on the surface of a protective film provided on at least one side of the polarizing plate. That is, as is shown in FIG. 2, a polarizing plate is preferred wherein protective films 12 and 13 are respectively provided on both sides of a polarizer 11, the protective film 12 disposed on the liquid crystal cell side satisfies the modulus of elasticity E when the polarizing plate is used in a liquid crystal display device, and the protective film 12 disposed on the opposite side to the liquid crystal cell has a functional film 14 such as an anti-reflection layer. As such functional film, it is preferred to provide at least one of a hard coat layer, an anti-glare layer and an anti-reflection layer. Additionally, it is not necessary to provide the individual layers as separate layers and, for example, it may be possible to impart an anti-glare function to the anti-reflection layer or the hard coat layer to thereby provide an anti-glare, anti-reflection layer in place of providing two layers of the anti-reflection layer and the anti-glare layer.

### [Anti-Reflection Layer]

In the invention, an anti-reflection layer comprising at least a light-scattering layer and a low-refractive-index layer laminated in this order or an anti-reflection layer comprising a middle-refractive-index layer, a high-refractive-index layer and a low-refractive-index layer laminated in this order is preferably provided on the protective film of the polarizing plate. Preferred embodiments thereof will be described below. Additionally, in the former constitution, the specular surface reflectance becomes 1% or more, and the film is called Low Reflection (LR) film. In the latter constitution, the specular surface reflectance can be reduced to 0.5% or less, and the film is called Anti Reflection (AR) film.

### [LR Film]

A preferred embodiment of an anti-reflection film (LR film) formed on the protective film of the polarizing plate by providing a light-scattering layer and a low-refractive-index layer will be described below.

The light-scattering layer preferably contains matt particles dispersed therein. The refractive index of other materials than the matt particles in the light-scattering layer is preferably in the range of from 1.50 to 2.00, and the refractive index of the low-refractive-index layer is preferably in the range of from 1.20 to 1.49. In the invention, the light-scattering layer has both anti-glare properties and hard coat properties, and may comprise a single layer or a plurality of layers, for example, 2 to 4 layers.

The surface profile of the anti-reflection layer is preferably designed so that the center-line roughness Ra is between 0.08 and 0.40 μm, the 10-point average roughness Rz is 10 times as much as Ra or less than that, the average peak-valley distance Sm is between 1 and 100 μm, the standard deviation of the height of peak from the deepest valley is 0.5 μm or less, the standard deviation of the average peak-valley distance Sm taking the center line as a standard is 20 μm or less, and the plane with an inclined angle of 0 to 5° accounts for 10% or more, which serves to obtain sufficient anti-glare properties and uniform matt appearance when viewed with the eye.

When the color tint of a reflected light under a light source C is −2 to 2 in a* value and −3 to 3 in b* value and the ratio of the minimum reflectance to the maximum reflectance is from 0.5 to 0.99 in the range between 380 nm and 780 nm, the reflected light has a neutral color tint, thus such layer being preferred. Further, when b* value of the transmission light under the light source C is adjusted to 0 to 3, a yellowish tint upon displaying white color on a display device using the film can be reduced, thus such layer being preferred. Still further, when the standard deviation of luminance distribution measured on the film with inserting a 120 μm×40 μm lattice between a plane light source and the anti-reflection layer is 20 or less, dazzling can be reduced in the case of applying the polarizing plate of the invention to a highly fine panel, thus such layer being preferred.

The anti-reflection layer to be used in the invention preferably has optical characteristics of 2.5 or less in secular surface reflectance, 90% or more in transmittance and 70% or less in 60° surface gloss, which serve to suppress reflection of external light and improve viewability. In particular, the specular surface reflectance is more preferably 1% or less, most preferably 0.5% or less. The anti-reflection layer preferably has a haze of from 20% to 50%, an internal haze/total haze ratio of from 0.3 to 1, a reduction in haze value from formation of the light-scattering layer to formation of the low-refractive-index layer of within 15%, a transmitted image distinctness in an optical comb width of 0.5 mm of from 20% to 50% and a transmission ratio of a vertical transmission light/a light inclined 2° from the vertical direction of from 1.5 to 5.0, which serves to prevent dazzling on a highly fine LCD panel and reduce unsharpness of letters.

### (Low-Refractive-Index Layer)

The low-refractive-index layer to be used in the invention has a refractivity of preferably from 1.20 to 1.49, more preferably from 1.30 to 1.44. Further, the low-refractive-index layer preferably satisfies the following numerical formula (19) in view of reducing reflectance:

(m/4)λ×0.7<n_{L}d_{L}<(m/4)λ×1.3 numerical formula (19)

In the numerical formula, m represents a positive odd number, n_{L} represents a reflectance of the low-refractive-index layer, and d_{L} represents the thickness (nm) of the low-refractive-index layer. Also, λ represents a wavelength and is a value in the range of from 500 to 550 nm.

Materials forming the low-refractive-index layer are described below.

The low-refractive-index layer preferably contains a fluorine-containing polymer as a low-refractive binder. As the fluorine-containing polymer, fluorine-containing polymers having a kinetic friction coefficient of from 0.03 to 0.20, a contact angle to water of from 90 to 120° and a pure water-dropping angle of 70° or less and capable of cross-linking by heat or ionizing radiation are preferred. In the case of mounting the polarizing plate relating to the invention on an image display device, a smaller peeling force required for peeling a commercially available adhesive tape provides an easier peeling of a seal or a memo adhesively applied thereto, thus being preferred. Such peeling force is preferably 500 gf or less, more preferably 300 gf or less, most preferably 100 gf or less, when measured by means of a tensile tester. A higher surface hardness measured by means of a microhardness tester provides a less scratchable surface, and the surface hardness is preferably 0.3 GPa or more, more preferably 0.5 GPa or more.

As the fluorine-containing polymer to be used for the low-refractive-index layer, there are illustrated a hydrolyzate and a dehydration condensate of a perfluoroalkyl group-containing silane compound {e.g., (heptadecafluoro-1,1,2,2-tetrahydrodecyl}-triethoxysilane} and a fluorine-containing copolymer containing a fluorine-containing monomer unit and a constituting unit for imparting cross-linking reactivity.

Specific examples of the fluorine-containing monomer include fluoroolefines (e.g., fluoroethylene, vinylidene fluoride, tetrafluoroethylene, perfluorooxtylethylene, hexafluoropropylene and perfluoro-2,2-dimethyl-1,3-dioxol), partially or completely fluorinated alkyl ester derivatives of (meth)acrylic acid [e.g., “Viscoat 6FM” (manufactured by Osaka Organic Chemical Industry Ltd.) and “M-2020” (manufactured by Daikin Kogyo K.K.)] and partially or completely fluorinated vinyl ethers, with perfluoroolefins being preferred. In view of refractive index, solubility, transparency and availability, hexafluoropropylene is particularly preferred.

As a constituting unit for imparting cross-linking reactivity, there are illustrated a constituting unit obtained by polymerization of a monomer having a self-cross-linking functional group within the molecule such as glycidyl (meth)acrylate or glycidyl vinyl ether, a constituting unit obtained by polymerization of a monomer having a carboxyl group, a hydroxyl group, an amino group or a sulfo group {e.g., (meth)acrylic acid, methylol (meth)acrylate, hydroxyalkyl (meth)acrylate, allyl acrylate, hydroxyethyl vinyl ether, hydroxybutyl vinyl ether, maleic acid or a crotonic acid} and a constituting unit obtained by introducing a cross-linkable group such as a (meth)acryloyl group into the above-mentioned constituting unit by a high-molecular reaction (for example, introduction being conducted by acting acryloyl chloride on hydroxyl group).

In view of solubility in a solvent and transparency of the film, a fluorine atom-free monomer can properly be copolymerized in addition to the fluorine-containing monomer unit and the constituting units for imparting the cross-linking reactivity. The monomer unit to be used in combination is not particularly limited, and examples thereof include olefins (e.g., ethylene, propylene, isoprene, vinyl chloride and vinylidene chloride), acrylates (e.g., methyl acrylate, ethyl acrylate and 2-ethylhexyl acrylate), methacrylates (e.g., methyl methacrylate, ethyl methacrylate, butyl methacrylate and ethylene glycol dimethacrylate), styrene derivatives (e.g., styrene, divinylbenzene, vinyltoluene and α-methylstyrene), vinyl ethers (e.g., methyl vinyl ether, ethyl vinyl ether and cyclohexyl vinyl ether), vinyl esters (e.g., vinyl acetate, vinyl propionate and vinyl cinnamate), acrylamides (e.g., N-t-butylacrylamide and N-cyclohexylacrylamide), methacrylamides and acrylonitrile derivatives.

A curing agent may properly be used in combination with the above-described polymers as described in JP-A-10-25388 and JP-A-10-147739.

### (Light-Scattering Layer)

A light-scattering layer is formed for the purpose of imparting to the film light-scattering properties by at least either of surface scattering and internal scattering and hard coat properties for improving scratching resistance of the film. Therefore, it is formed by incorporating a binder for imparting hard coat properties, matt particles for imparting light-scattering properties and, as needed, an inorganic filler for increasing refractive index, preventing contraction due to cross-linking and increasing strength. The thus-provided light-scattering layer also functions as an anti-glare layer, thus the polarizing plate having an anti-glare layer at the same time.

The thickness of the light-scattering layer is preferably from 1 to 10 μm, more preferably from 1.2 to 6 μm for the purpose of imparting hard coat properties. When the light-scattering layer has a thickness larger than the lower limit, there difficultly arises the problem of insufficient hardness whereas, when less than the upper limit, such troubles as deteriorated working adaptability due to curling or increased brittleness, thus such range being preferred.

As the binder for the light-scattering layer, polymers having a saturated hydrocarbon chain or a polyether chain as a main chain are preferred, with polymers having a saturated hydrocarbon chain as a main chain being more preferred. Also, the binder polymer preferably has a cross-linked structure. As the binder polymer having a saturated hydrocarbon chain as a main chain, polymers of an ethylenically unsaturated monomer are preferred. As the binder polymer having a saturated hydrocarbon chain as a main chain and having a cross-linked structure, (co)polymers of a monomer having two or more ethylenically unsaturated groups are preferred. In order to impart a high refractive index to the binder polymer, it is also possible to select a monomer having within its structure an aromatic ring or at least one atom selected from among a halogen atom other than fluorine atom, a sulfur atom, a phosphorus atom and a nitrogen atom.

As the monomer having two or more ethylenically unsaturated groups, there are illustrated esters between a polyhydric alcohol and (meth)acrylic acid {e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexameth}acrylate, 1,2,3-cyclohexane tetramethacrylate, polyurethane polyacrylate and polyester polyacrylate}, ethylene oxide-modified products of the above-described esters, vinylbenzene and the derivatives thereof (e.g., 1,4-divinylbenzene, 4-vinylbenzoic acid-2-acryloylethyl ester and 1,4-divinylcyclohexanone), vinylsulfones (e.g., divinylsulfone), acrylamides (e.g., methylenebisacrylamide) and methacrylamides. These monomers may be used in combination of two or more thereof.

Specific examples of the highly refractive monomer include bis(4-methacryloylthiophenyl)sulfide, vinylnaphthalene, vinylphenylsulfide and 4-methacryloxyphenyl-4′-methoxyphenyl thioether. These monomers may also be used in combination of two or more thereof.

Polymerization of these monomers having an ethylenically unsaturated group or groups can be conducted by irradiating with ionizing radiation or by heating in the presence of a photo radical initiator or a heat radical initiator. Therefore, the anti-reflection layer can be formed by preparing a coating solution containing the ethylenically unsaturated group-having monomer, the photo radical initiator or heat radical initiator, matt particles and an inorganic filler and, after coating the coating solution on the protective film, conducting polymerization reaction by polymerization reaction caused by ionizing radiation or by heat. As the photo radical initiator, known ones may be used.

The polymer having a polyether as a main chain is preferably a ring-opening polymerization product of a multi-functional epoxy compound. The ring-opening polymerization of the multi-functional epoxy compound can be conducted by irradiating with ionizing radiation or by heating in the presence of a photo acid generator or a heat acid generator. Therefore, the anti-reflection layer can be formed by preparing a coating solution containing the multi-functional epoxy compound, the photo acid generator or heat acid generator, matt particles and an inorganic filler and, after coating the coating solution on the protective film, conducting polymerization reaction by polymerization reaction caused by ionizing radiation or by heat to cure.

It is also possible to use a monomer having a cross-linkable functional group in place of or in addition to the monomer having two or more ethylenically unsaturated groups to thereby introduce the cross-linkable functional group into the polymer and introduce a cross-linked structure into the binder polymer through reaction of the cross-linkable functional group.

Examples of the cross-linkable functional group include an isocyanato group, an epoxy group, an aziridine group, an oxazoline group, an aldehydro group, a carbonyl group, a hydrazon group, a carboxyl group, a methylol group and an active methylene group. Vinylsulfonic acid, acid anhydrides, cyanoacrylate derivatives, melamine, etherified methylol, esters, urethane and metal alkoxides such as tetramethoxysilane can also be utilized as the monomer for introducing the cross-linked structure. It is also possible to use a functional group which shows cross-linkability as a result of decomposition reaction such as a blocked isocyanato group. That is, in the invention, the cross-linkable functional group may be a group which does not immediately show its cross-linking ability but shows it as a result of its decomposition.

These binder polymers having the cross-linkable functional groups can form a cross-linked structure when heated after being coated.

Matt particles having an average particle size of from 1 to 10 μm, preferably from 1.5 to 7.0 μm, larger than the filler particles, are incorporated in the light-scattering layer for the purpose of imparting anti-glare properties. Preferred specific examples of the matt particles include particles of inorganic compounds such as silica particles and TiO2 particles; and resin particles such as acryl particles, cross-linked acryl particles, polystyrene particles, cross-linked polystyrene particles, melamine resin particles and benzoguanamine resin particles. Of these, cross-linked styrene particles, cross-linked acryl particles, cross-linked acrylstyrene particles and silica particles are preferred. As to the shape of matt particles, either of spherical particles and amorphous particles may be used.

Further, as to particle size distribution of the matt particles, a monodisperse distribution is most preferred, and the particle sizes of individual particles are preferably as near as possible to each other. For example, the proportion of coarse particles which are defined as particles having a particle size larger then the average particle size by 20% or more is preferably 1% or less in number based on the number of the total particles, more preferably 0.1% or less, still more preferably 0.01% or less. Matt particles having such particle size distribution can be obtained by classification after usual synthesis reaction. A matt agent having more preferred distribution can be obtained by increasing the number of times of classification or by intensifying the degree of classification.

The matt particles are incorporated in the light-scattering layer so that the amount of matt particles in the formed light-scattering layer becomes 10 to 1,000 mg/m², more preferably 100 to 700 mg/m². The particle size distribution of matt particles is measured according to the Coulter counter method, and the measured distribution is converted to particle number distribution.

In order to increase the refractive index of the layer, the light-scattering layer preferably contains an inorganic filler, in addition to the matt particles, which comprises at least an oxide of a metal selected from among titanium, zirconium, aluminum, indium, zinc, tin and antimony and has an average particle size of 0.2 μm or less, preferably 0.1 μm or less, more preferably 0.06 μm or less.

To the contrary, in order to increase difference in refractive index from the matt particles, it is also preferred to use a silicon oxide in a light-scattering layer using highly refractive matt particles for the purpose of keeping the refractive index of the layer at a low level. As to preferred particle size, the same applies as with the inorganic filler.

Specific examples of the inorganic filler to be used in the light-scattering layer include TiO₂, ZrO₂, Al₂O₃, In₂O₃, ZnO, SnO₂, Sb₂O₃, ITO and SiO₂, with TiO₂ and ZrO₂ being particularly preferred in view of increasing refractive index. The surface of the inorganic filler may preferably be subjected to silane coupling treatment or titanium coupling treatment. A surface treating agent having a functional group capable of reacting with the binder species and the filler surface is preferably used.

The addition amount of the inorganic filler is preferably from 10 to 90%, more preferably from 20 to 80%, particularly preferably from 30 to 75%, based on the total mass of the light-scattering layer.

Additionally, since such filler has a particle size enough smaller than wavelength of light, it does not cause scattering, and the dispersion wherein the filler is dispersed in the binder polymer behaves as an optically uniform substance.

The bulk refractive index of the mixture of the binder and the inorganic filler of the light-scattering layer is preferably from 1.50 to 2.00, more preferably from 1.51 to 1.80. In order to adjust the refractive index to the above-mentioned range, it suffices to properly select the kinds and amounts of the binder and the inorganic filler. Proper selection can be easily known previously through experiments.

The coating composition for forming the light-scattering layer contains a surfactant of either fluorine-containing type or silicone type or both of them in order to ensure surface uniformity free of coating unevenness, drying unevenness and spot defect. In particular, the fluorine-containing surfactant is preferably used because it exhibits the effect of removing surface troubles of the anti-reflection layer to be preferably used in the invention such as coating unevenness, drying unevenness and spot defect when used in a smaller amount.

### [AR Film]

Next, an anti-reflection layer formed by laminating a middle-refractive-index layer, a high-refractive-index layer and a low-refractive-index layer in this order on the protective film (AR film) will be described below.

The anti-reflection layer formed on the protective layer and having a layered structure wherein at least a middle-refractive-index layer, a high-refractive-index layer and a low-refractive-index layer (outermost layer) are provided in this order is designed to have the refractive indexes satisfying the following relation:

refractive index of the high-refractive-index layer>refractive index of the middle-refractive-index layer>the refractive index of the protective film>the refractive index of the low-refractive-index layer/.

It is also possible to provide a hard coat layer between the protective film and the middle-refractive-index layer. Further, the AR film may comprise a middle-refractive-index layer, a hard coat layer, a high-refractive-index layer and a low-refractive-index layer. There can be illustrated, for example, anti-reflection layers described in JP-A-8-122504, JP-A-8-110401, JP-A-10-300902, JP-A-2002-243906 and JP-A-2000-111706.

Further, each layer may have other function. For example, there are illustrated a stain-proof low-refractive-index layer and an antistatic high-refractive-index layer (e.g., JP-A-10-206603 and JP-A-2002-243906).

The haze of the anti-reflection layer is preferably 5% or less, more preferably 3% or less. Also, the surface strength of the film is preferably H or more, more preferably 2H or more, most preferably 3H or more, in the pencil hardness test according to JIS K-5400.

### (High-Refractive-Index Layer and Middle-Refractive-Index Layer)

The layer having a high refractive index in the anti-reflection layer comprises a cured film containing at least highly refractive inorganic compound fine particles of 100 nm or less in average particle size and a matrix binder.

The highly refractive inorganic compound fine particles include inorganic compounds of 1.65 or more in refractive index, with those of 1.9 or more in refractive index being more preferred. For example, there are illustrated oxides of Ti, Zn, Sb, Sn, Zr, Ce, Ta, La and In and composite oxides containing these metal atoms.

In order to obtain such fine particles, there are illustrated a technique of treating the particle surface with a surface treating agent (e.g., silane coupling agents described in JP-A-11-295503, JP-A-11-153703 and JP-A-2000-9908; anionic compounds or organometallic coupling agents described in JP-A-2001-310432), a technique of forming a core-shell structure wherein highly refractive particles form a core (JP-A-2001-166104), and a technique of using a specific dispersing agent in combination (e.g., JP-A-11-153703, U.S. Pat. No. 6,210,858 and JP-A-2002-277609).

As the material for forming the matrix, there are illustrated conventionally known thermoplastic resins and curable resin films.

As more preferred materials, there are illustrated at least one composition selected from among a composition containing a multi-functional compound having 2 or more polymerizable groups (at least either of radical-polymerizable and cation-polymerizable groups), a composition containing an organometallic compound having a hydrolysable group, and a composition containing the partial condensate thereof. For example, there are illustrated those compounds which are described in JP-A-2000-47004, JP-A-2001-315242, JP-A-2001-31871 and JP-A-2001-296401.

Also, a curable film obtained from a colloidal metal oxide obtained from a hydrolysis condensate of a metal alkoxide and a metal alkoxide composition are preferred, which is described in, for example, JP-A-2001-293818.

The refractive index of the high-refractive-index layer is preferably from 1.70 to 2.20. The thickness of the high-refractive-index layer is preferably from 5 nm to 10 μm, more preferably from 10 nm to 1 μm.

The refractive index of the middle-refractive-index layer is adjusted to be a value between the refractive index of the low-refractive-index layer and the high-refractive-index layer. The refractive index of the middle-refractive-index layer is preferably from 1.50 to 1.70. Also, the thickness is preferably from 5 nm to 10 μm, more preferably from 10 nm to 1 μm.

### (Low-Refractive-Index Layer)

The low-refractive-index layer is laminated in order on the high-refractive-index layer. The refractive index of the low-refractive-index layer is preferably from 1.20 to 1.55, more preferably from 1.30 to 1.50.

The low-refractive-index layer is preferably constituted as the outermost layer having anti-scratching and stain-proof properties. As a means to largely improve scratching resistance, it is effective to impart sliding properties to the surface, and conventionally known means such as introduction of silicone or fluorine can be applied.

As the fluorine-containing compound, those compounds are preferred which contain fluorine atom in a content of from 35 to 80% by mass and have a cross-linkable or polymerizable functional group. For example, there are illustrated compounds described in JP-A-9-222503, paragraphs [0018] to [0026], JP-A-11-38202, paragraphs [0019] to [0030], JP-A-2001-40284, paragraphs [0027] to [0028] and JP-A-2000-2841-2.

The refractive index of the fluorine-containing compound is preferably from 1.35 to 1.50, more preferably from 1.36 to 1.47.

As the silicone compound, compounds having a polysiloxane structure and having a curable functional group or a polymerizable functional group in the high molecular chain which functions to form a cross-linked structure in the film are preferred. For example, there are illustrated a reactive silicone (e.g., “SILAPLANE” manufactured by Chisso Corporation) and polysiloxane having a silanol group on each end (JP-A-11-258403).

At least either of the cross-linking reaction and the polymerization reaction of the fluorine-containing polymer and the siloxane polymer having a cross-linkable or a polymerizable group is preferably conducted by irradiation with light or by heating simultaneously with or after coating of the coating composition for forming the outermost layer containing a polymerization initiator and a sensitizing agent to thereby form the low-refractive-index layer.

A sol/gel cured film obtained by conducting condensation reaction between an organometallic compound such as a silane coupling agent and a silane coupling agent having a specific fluorine-containing hydrocarbon group in the copresence of a catalyst to cure is also preferred. For example, there are illustrated a polyfluoroalkyl group-having silane compound or a partially hydrolyzed product thereof (JP-A-58-142958, JP-A-58-147483, JP-A-58-147484, JP-A-59-157582 and JP-A-11-106704), and a silyl compound having a poly(perfluoroalkyl ether) group which is a fluorine-containing long-chain group (JP-A-2000-117902, JP-A-2001-48590 and JP-A-2002-53804).

In addition to the above-described additives, the low-refractive-index layer can contain a filler {e.g., a low-refractive inorganic compound having a primary particle size of from 1 to 150 nm such as silicon dioxide (silica) and fluorine-containing particles (e.g., magnesium fluoride, calcium fluoride and barium fluoride) and organic fine particles described in JP-A-11-3820, paragraphs [0020] to [0038]}, a silane coupling agent, a sliding agent and a surfactant.

In the case where the low-refractive-index layer is positioned under the outermost layer, the low-refractive-index layer may be formed by a gas-phase method (e.g., a vacuum deposition method, a sputtering method, an ion plating method or a plasma CVD method). A coating method is preferred in the point of its low production cost.

The thickness of the low-refractive-index layer is preferably from 30 to 200 nm, more preferably from 50 to 150 nm, most preferably from 60 to 120 nm.

### (Hard Coat Layer)

The hard coat layer is provided on the surface of the protective film in order to impart physical strength to the protective film having provided thereon the anti-reflection layer. It is particularly preferred to provide the hard coat layer between the protective film and the high-refractive-index layer. The hard coat layer is preferably formed by cross-linking reaction or polymerization reaction of a photo-curable and/or heat-curable compound. As the curable functional group in the curable compound, a photo-polymerizable functional group is preferred. Also, an organometallic compound or organic alkoxysilyl compound having a hydrolyzable functional group is also preferred.

As specific examples of these compounds, there are illustrated the same ones as have been illustrated with respect to the high-refractive-index layer.

As a specific composition for constituting the hard coat layer, there are illustrated those which are described in JP-A-2002-144913, JP-A-2000-9908 and WO00/46617 pamphlet.

The high-refractive-index layer can also function as the hard coat layer. In such cases, the layer is preferably formed by incorporating fine particles in the hard coat layer in a finely dispersed state by employing the technique described with respect to the high-refractive-index layer.

The thickness of the hard coat layer can properly be designed according to use. The thickness of the hard coat layer is preferably from 0.2 to 10 μm, more preferably from 0.5 to 7 μM.

The surface strength of the hard coat layer is preferably H or more, more preferably 2H or more, most preferably 3H or more, in the pencil hardness test according to JIS K-5400. Also, as to an abrasion amount of a test piece after Taber test according to JIS K-5400, the smaller, the more preferred.

### (Other Layers of Anti-Reflection Layer)

Further, a forward scattering layer, a primer layer, an antistatic layer, an undercoat layer and a protective layer may be provided.

### (Antistatic Layer)

In the case of providing an antistatic layer, it is preferred to impart a conductivity of 10⁻⁸ (Ωcm⁻³) or less in volume resistivity. It is possible to impart a volume resistivity of 10⁻⁸ (Ωcm⁻³) by using a hygroscopic substance, a water-soluble inorganic salt, a certain kind of a surfactant, a cation polymer, an anion polymer or colloidal silica. However, there is involved a problem that the conductivity has a large dependence upon temperature and humidity and that a sufficient conductivity can not be obtained at a low humidity. Therefore, a metal oxide is preferred as a material for the conductive layer. Some metal oxides are colored, and use of such metal oxide as a material for the conductive layer causes coloration of the whole film, thus not being preferred. As metals forming a colorless metal oxide, there are illustrated Zn, Ti, Sn, Al, In, Si, Mg, Ba, Mo, W and V. Use of metal oxides containing them as a major component is preferred.

As specific examples of the metal oxides, ZnO, TiO₂, SnO₂, Al₂O₃, In₂O₃, SiO₂, MgO, BaO, MoO₃, WO₃, V₂O₅ and the composite oxides thereof are preferred, with ZnO, TiO₂ and SnO₂ being particularly preferred. As examples containing foreign atoms, addition of Al and In to ZnO, addition of Sb, Nb and halogen element to SnO₂, and addition of Nb and Ta to TiO₂ are effective.

Further, as is described in JP-B-59-6235, materials obtained by depositing the metal oxide onto other crystalline metal particles or fibrous materials (e.g., titanium oxide) may be used. Additionally, volume resistivity and surface resistivity are different physical properties and can not simply be compared with each other. However, in order to ensure a conductivity of 10⁻⁸ (Ωcm⁻³) or less in volume resistivity, it suffices for the antistatic layer to have a surface resistivity of about 10⁻¹⁰ (Ω/□), more preferably 10⁻⁸ (Ω/□) or less. The surface resistivity of the antistatic layer must be measured when the layer constitutes the outermost layer, and can be measured at a stage in the course of forming the laminate film.

### <Liquid Crystal Display Device>

The liquid crystal display device of the invention has at least the polarizing plate of the invention. The liquid crystal display device is a liquid crystal display device wherein a pair of the polarizing plates are used, with one being on a liquid crystal cell and the other being under the liquid crystal cell, particularly preferably, a liquid crystal display device wherein a pair of the polarizing plates are used, with one being on a VA-mode liquid crystal cell and the other being under the VA-mode liquid crystal cell. Also, at least one protective film of the polarizing plate is preferably the aforesaid protective film, i.e., the aforesaid cellulose acylate film or the cyclic polyolefin film. Further, the protective film disposed on the liquid crystal cell side of the polarizing plate in the liquid crystal display device is preferably a protective film which satisfies the foregoing numerical formulae (6) and (7). Further, an embodiment wherein an optically anisotropy layer is provided on the protective film and/or an embodiment wherein an anti-reflection layer is provided on the protective film is also preferred. A light and thin liquid crystal display device can be obtained by employing such constitution.

Examples of the liquid crystal cell which permits use of the polarizing plate of the invention to fabricate a liquid crystal display device are given below.

The polarizing plate of the invention can be applied to liquid crystal cells of various display modes. There can be illustrated various display modes such as TN (Twisted Nematic), IPS (In-Plane Switching), FLC (Ferroelectric Liquid Crystal), AFLC (Ant-Ferroelectric Liquid Crystal), OCB (Optically Compensatory Bend), STN (Super Twisted Nematic), VA (Vertically Aligned) and HAN (Hybrid Aligned Nematic). Of these, VA mode and OCB modes are particularly adapted for the use of the polarizing plates, with VA mode being particularly preferred.

In the VA mode liquid crystal cell, rod-shaped liquid crystal molecules are aligned substantially vertically upon no voltage being applied thereto.

The VA mode liquid crystal cell includes (1) a VA mode liquid crystal cell in the narrow sense wherein rod-shaped liquid crystalline molecules are aligned substantially vertically while no voltage being applied thereto and are aligned substantially horizontally while a voltage being applied thereto (JP-A-2-176625) and, in addition, (2) an MVA mode liquid crystal cell wherein the VA mode is modified to be multi-domain by projections so as to enlarge the viewing angle {described in SID97, Digest of tech. Papers, 28 (1997), p. 845}, (3) a n-ASM mode or CPA mode liquid crystal wherein rod-like liquid crystalline molecules are aligned substantially vertically while no voltage being applied thereto, and the molecules are oriented in twisted multi-domain alignment while a voltage being applied thereto {described in Abstracts of Japanese Forum of Liquid Crystal (written in Japanese), (1998), pp. 58 to 59 and Sharp Giho, No. 80, p. 11} and (4) a liquid crystal cell of SURVAIVAL mode wherein molecules are oriented in multi-domain alignment by an oblique electric field {Gekkan Display, No. 5, p. 14 (1999)} and a PVA mode liquid crystal cell {18^{th}, IDRC Proceedings, p. 383 (1998)}.

As the VA mode liquid crystal display device, there is illustrated a device which comprises a liquid crystal cell (VA mode cell) and two polarizing plates each provided on each side thereof {polarizing plates having a cellulose acylate film TAC1(22), a cellulose acylate film TAC2(23, 33), a cellulose acylate film TAC3(32), a polarizer (21, 31) and an adhesive layer (not shown)}. The liquid crystal cell comprises a liquid crystal supported between two electrode substrates, though not particularly shown.

In an embodiment of the transmission type liquid crystal display device of the invention shown in FIG. 3, of the cellulose acylate films used as the protective films, protective films TAC1 and TAC3 used on the liquid crystal cell side may be the same or different films. Also, TAC1 and TAC3 may be used as both a protective film and an optically compensatory sheet.

The protective film (TAC2) in FIG. 3 may be a common cellulose acylate film and is preferably thinner than the cellulose acylate film to be preferably used in the invention. For example, it has a thickness of from 40 to 80 μm is preferred. Examples thereof include commercially available “KC4UX2M (manufactured by Konica Opto, Inc.; 40 μm), “KC4UX2M (manufactured by Konica Opto, Inc.; 60 μm) and “TD80UL” (manufactured by Fuji Photo Film Co., Ltd.) which, however, are not limitative at all.

### EXAMPLES

The invention will be described specifically based on Examples, Production Examples and Synthesis Examples which, however, do not limit the invention in any way.

### Production Example 1

### Formation of a Cellulose Acylate Film Using a Band Casting Machine

### Films 1 to 18

### (1) Cellulose Acylate

Cellulose acylates having different kinds of acyl groups and different substitution degrees as shown in Table 1 were prepared. Acylation reaction was conducted by adding sulfuric acid (7.8 parts by mass per 100 parts by mass of cellulose) as a catalyst and carboxylic acids as a raw material for the acyl substituent and performing the reaction at 40° C. In this occasion, the kind of acyl group, total substitution degree and substitution degree at 6-position were controlled by adjusting the amount of the sulfuric acid catalyst, the amount of water and the ripening period. The ripening was conducted at 40° C. After the acylation, ripening was conducted at 40° C. Further, a low molecular component of the cellulose acylate was removed by washing with acetone.

Additionally, in the table, CAB is an abbreviation for cellulose acetate butyrate (cellulose ester derivative wherein the acyl group comprises an acetyl group and a butanoyl group (Bu)), CAP is an abbreviation for cellulose acetate propionate (cellulose ester derivative wherein the acyl group comprises an acetyl group and a propionyl group (Pr)), and CTA means cellulose triacetate (cellulose ester derivative wherein the acyl group comprises only an acetyl group).

TABLE 1

| | | | | | | | Substitution |
|---|---|---|---|---|---|---|---|
| | | | | | | | Degree at 6- |
| | Kind of | | Substitution | | Total Substitution | Substitution | Position/ |
| Film | Cellulose | Substitution | Degree B | | Degree | Degree | Total Substitution |
| No. | Acylate | Degree A | Kind | | A + B | at 6-Position | Degree |
| 1 | CAP | 1.9 | Pr | 0.8 | 2.7 | 0.897 | 0.332 |
| 2 | CAP | 0.18 | Pr | 2.47 | 2.65 | 0.883 | 0.333 |
| 3 | CAB | 1.4 | Bu | 1.3 | 2.7 | 0.880 | 0.326 |
| 4 | CAB | 0.3 | Bu | 2.5 | 2.8 | 0.890 | 0.318 |
| 5 | CTA | 2.785 | — | 0 | 2.785 | 0.910 | 0.327 |
| 6 | CTA | 2.849 | — | 0 | 2.849 | 0.934 | 0.328 |
| 7 | CTA | 2.87 | — | 0 | 2.87 | 0.907 | 0.316 |
| 8 | CAP | 1.9 | Pr | 0.8 | 2.7 | 0.897 | 0.332 |
| 9 | CAP | 0.18 | Pr | 2.47 | 2.65 | 0.883 | 0.333 |
| 10 | CAB | 1.1 | Bu | 1.6 | 2.7 | 0.881 | 0.326 |
| 11 | CAB | 0.3 | Bu | 2.5 | 2.8 | 0.890 | 0.318 |
| 12 | CTA | 2.785 | — | 0 | 2.785 | 0.910 | 0.327 |
| 13 | CTA | 2.847 | — | 0 | 2.847 | 0.947 | 0.333 |
| 14 | CTA | 2.87 | — | 0 | 2.87 | 0.907 | 0.316 |
| 15 | CTA | 2.87 | — | 0 | 2.87 | 0.907 | 0.316 |
| 16 | CTA | 2.785 | — | 0 | 2.785 | 0.910 | 0.327 |
| 17 | CTA | 2.92 | — | 0 | 2.92 | 0.923 | 0.316 |
| 18 | CTA | 2.785 | — | 0 | 2.785 | 0.910 | 0.327 |
| 19 | CAP | 1.9 | Pr | 0.8 | 2.7 | 0.897 | 0.332 |
| 20 | CTA | 2.785 | — | 0 | 2.785 | 0.910 | 0.327 |
| 21 | CAP | 1.9 | Pr | 0.8 | 2.7 | 0.897 | 0.332 |
| 22 | CAB | 0.3 | Bu | 2.5 | 2.8 | 0.890 | 0.318 |
| 23 | CTA | 2.87 | — | 0 | 2.87 | 0.907 | 0.316 |
| 24 | CTA | 2.785 | — | 0 | 2.785 | 0.910 | 0.327 |

### (2) Preparation of Dope

### [1-1. Cellulose Acylate Solution]

A composition of the following formulation was placed in a mixing tank and stirred to dissolve and, after heating at 90° C. for about 10 minutes, filtered through a filter paper of 34 μm in average pore size and a sintered metal filter of 10 μm in average pore size.

Additionally, the addition amounts of triphenyl phosphate and biphenyldiphenyl phosphate were different with respect to individual films as shown in Table 2.

(Formulation of the cellulose acylate solution)

| | |
|---|---|
| Cellulose acylate described | 100.0 parts by mass |
| in Table 1 | |
| Triphenyl phosphate | (described in Table 2) |
| Biphenyldiphenyl phosphate | (described in Table 2) |
| Methylene chloride | 403.0 parts by mass |
| Methanol | 60.2 parts by mass |

### [1-2. Matt Agent Dispersion]

Then, the following composition containing the cellulose acylate solution prepared in the above-described manner was placed in a dispersing machine to prepare a matt agent dispersion.

(Formulation of matt agent dispersion)

| | |
|---|---|
| Silica particles of 16 nm | 2.0 parts by mass |
| in average particle size | |
| (aerosol R972; manufactured | |
| by Nippon Aerosil Co., Ltd.) | |
| Methylene chloride | 72.4 parts by mass |
| Methanol | 10.8 parts by mass |
| Cellulose acylate solution | 10.3 parts by mass |
| described above | |

### [1-3. Retardation Increasing Agent Solution A]

Then, the following composition containing the cellulose acylate solution prepared in the above-described manner was placed in a mixing tank, followed by stirring under heating to dissolve. Thus, a retardation increasing agent solution A was prepared. Additionally, in the following formulation, a retardation increasing agent (RP1) is a compound represented by the following formula.

(Formulation of retardation increasing agent solution A)

| | |
|---|---|
| Retardation increasing agent (RP1) | 20.0 parts by mass |
| Methylene chloride | 58.3 parts by mass |
| Methanol | 8.7 parts by mass |
| Cellulose acylate solution | 12.8 parts by mass |
| described above | |

100 Parts by mass of the cellulose acylate solution, 1.35 parts by mass of a matt agent dispersion and, further, a retardation-increasing agent solution A in a proportion as shown in Table 2 were mixed to prepare a dope for forming a film. The dope was used for preparing films 2, 5 to 7, and 9 to 15. The amount of the retardation-increasing agent solution A was shown in Table 2 in terms of parts by mass of the retardation-increasing agent per 100 parts by mass of cellulose acylate.

### [1-4. Retardation Increasing Agent Solution B

Further, the following composition containing the cellulose acylate solution prepared in the above-described manner was placed in a mixing tank, followed by stirring under heating to dissolve. Thus, a retardation increasing agent solution B was prepared. Additionally, in the following composition, a retardation increasing agent (RP1) is a compound represented by the following formula, and a retardation increasing agent (30) is a compound represented by the following formula (30).

(Formulation of retardation increasing agent solution B)

| | |
|---|---|
| Retardation increasing agent (RP1) | 7.8 parts by mass |
| Retardation increasing agent (30) | 12.2 parts by mass |
| Methylene chloride | 58.3 parts by mass |
| Methanol | 8.7 parts by mass |
| Cellulose acylate solution | 12.8 parts by mass |
| described above | |

100 Parts by mass of the above-mentioned cellulose acylate solution, 1.35 parts by mass of the matt agent dispersion and, further, the retardation increasing agent solution B were mixed so that the proportion thereof became that shown in Table 2 to thereby prepare a dope for forming a film. The dopes were used for preparing film 16. The retardation increasing agent solution B is shown in Table 2 in terms of parts by mass per 100 parts by mass of cellulose acylate.

### [1-5. Retardation Decreasing Agent Solution]

Further, the following composition containing the cellulose acylate solution prepared in the above-described manner was placed in a mixing tank, followed by stirring under heating to dissolve. Thus, a retardation decreasing agent solution and a wavelength distribution controlling agent solution were prepared. Additionally, in the following formulation, a retardation decreasing agent (119) is a compound represented by the foregoing formula (119). Also, in the following formulation, a wavelength distribution controlling agent HOBP is 2-hydroxy-4-n-octoxybenzophenone.

(Formulation of retardation decreasing agent solution)

| | |
|---|---|
| Retardation decreasing agent (119) | 20.0 parts by mass |
| Methylene chloride | 58.3 parts by mass |
| Methanol | 8.7 parts by mass |
| Cellulose acylate solution | 12.8 parts by mass |
| described above | |

(Formulation of wavelength distribution controlling agent solution)

| | |
|---|---|
| Wavelength distribution controlling | 20.0 parts by mass |
| agent HOBP | |
| Methylene chloride | 58.3 parts by mass |
| Methanol | 8.7 parts by mass |
| Cellulose acylate solution | 12.8 parts by mass |
| described above | |

100 Parts by mass of the cellulose acylate solution, 1.35 parts by mass of a matt agent dispersion and, further, a retardation-decreasing agent solution and a wavelength distribution-adjusting agent solution in proportions as shown in Table 2 were mixed to prepare a dope for forming a film. The dope was used for preparing a film 17. The amounts of the retardation-decreasing agent solution and the wavelength distribution-adjusting agent were shown in Table 2 in terms of parts by mass of the retardation-decreasing agent and the wavelength distribution-adjusting agent per 100 parts by mass of cellulose acylate.

### [1-6. UV Ray Absorbent Solution]

Further, the following composition containing the cellulose acylate solution prepared by the above-described process was placed in a mixing tank and stirred under heating to dissolve, thus a UV ray absorbent solution being prepared.

(Formulation of the UV ray absorbent solution)

| | |
|---|---|
| UV ray absorbent UV1 or UV2 | 20.0 parts by mass |
| Methylene chloride | 58.3 parts by mass |
| Methanol | 8.7 parts by mass |
| Cellulose acylate solution | 12.8 parts by mass |
| described above | |

100 Parts by mass of the cellulose acylate solution, 1.35 parts by mass of a matt agent dispersion and, further, a UV ray absorbent solution in a proportion as shown in Table 2 were mixed to prepare a dope for forming a film. The dope was used for preparing films 1, 3, 4 and 8.

The amount of the UV ray absorbent solution was shown in Table 2 in terms of parts by mass of the UV ray absorbent per 100 parts by mass of cellulose acylate.

In Table 2, the UV ray absorbent UV1 means 2-[2′-hydroxy-3′,5′-di-t-butylphenyl]benzotriazole, and UV2 means 2-[2′-hydroxy-3′,5′-diamylphenyl]-5-chlorobenzotriazole].

### Retardation-Increasing Agent (RP1):

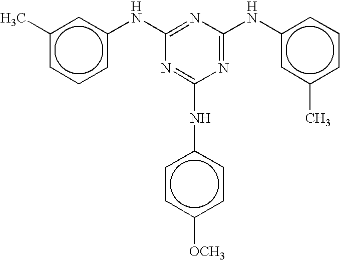

100 Parts by mass of the cellulose acylate solution and 1.35 parts by mass of a matt agent were mixed to prepare a dope for forming a film. The dope was used for preparing a film 18.

### (3) Casting

The dope was cast using a band casting machine. A heated air was applied to the surface of the web on the metal support. The temperature and the amount of the heated air were as shown in Table 2. A film peeled from the band when the amount of residual solvent reached 25 to 35% by mass was stretched in the transverse direction with a stretching ratio shown in Table 2 under the condition that the stretching temperature was in a range of from a temperature lower than the glass transition temperature of the cellulose acylate film by about 5° C. to a temperature higher than the glass transition temperature by about 5° C. (hereinafter also described as “a range of from about Tg−5° C. to about Tg+5° C. using a tenter to thereby form a cellulose acylate film. Both ends of the film were cut off before a winding section to adjust the width to 2,000 mm, and the film was wound up as a roll film of 4,000 m in length. The stretching ratios of the tenter are shown in Table 2. With the thus-prepared cellulose acylate films, Re₅₉₀ value and Rth₅₉₀ value at a wavelength of 590 nm were measured at 25° C. and 60% RH using a birefringence-measuring apparatus of KOBRA 21ADH (Ohji Measurement Co., Ltd.). In order to calculate Rth₅₉₀ value, 1.48 was inputted as an average refractive index. The modulus of elasticity was determined in the manner described hereinbefore. The results thus obtained are shown in Table 2. Further, with film 17, Re₄₀₀ value, Re₇₀₀ value, Rth₄₀₀ value and Rth₇₀₀ value were measured at a wavelength of 400 nm or 700 nm. In order to calculate Rth₄₀₀ value and Rth₇₀₀ value, 1.48 was inputted as an average refractive index. As a result, Re₄₀₀ value was found to be −1 nm, Re₇₀₀ value was found to be 3 nm, Rth₄₀₀ value was found to be −3 nm, and Rth₇₀₀ value was found to be 6 nm.

With all films obtained in this Production Example, the haze was from 0.1 to 0.9, the average particle size of secondary particles of the matt agent was 1.0 μm or less, and change in mass after being allowed to stand for 48 hours at 80° C. and 90% RH was from 0 to 3% by mass. Also, dimensional change after being allowed to stand for 24 hours at 60° C. and 95% RH or at 90° C. and 5% RH was from 0 to 4.5%. Further, every sample had a photoelasticity coefficient of 50×10⁻¹³ cm²/dyne (5×10⁻¹³ N/m²) or less.

Additionally, results of using “Fuji TAC TD80UL”, Fuji TAC TF80UL”, “Fuji TAC TDY80UL” (these being manufactured by Fuji Photo Film Co., Ltd.) and “KC80UVSFD” (manufactured by Konica Opto K.K.) as commercially available cellulose acylate films are also shown in Table 2 for reference.

TABLE 2

| | | | | | | | Processing | | | | | | |
|---|---|---|---|---|---|---|---|---|---|---|---|---|---|
| | | | | | | | Heated | | Stretch | | Film Characteristics | | |
| Production | | Compounding | | | | | Wind to | | Ratio | | | | Modulus of |
| Example | Film | | *6 | | Additive | | Web Surface | | (Times the | Thickness | | | Elasticity |
| No. | No. | *5 | *7 | *8 | Kind | Amount | *9 | *10 | Original) | (μm) | Re (nm) | Rth (nm) | (Mpa) |
| Production | 1 | CAP | 13 | 6.5 | UV1/ | 1.4/0.6 | 180 | 300 | 15 | 80 | 45 | 125 | 950 |
| Ex. 1-1 | | | | | UV2*¹ | | | | | | | | |
| Production | 2 | CAP | 9 | 4.5 | RP1*² | 5 | 160 | 250 | 20 | 93 | 39 | 138 | 2000 |
| Ex. 1-2 | | | | | | | | | | | | | |
| Production | 3 | CAB | 12 | 6 | UV1/ | 1.05/ | 180 | 300 | 15 | 75 | 24 | 140 | 1250 |
| Ex. 1-3 | | | | | UV2*¹ | 0.45 | | | | | | | |
| Production | 4 | CAB | 9 | 4.5 | UV1/ | 1.05/ | 170 | 250 | 18 | 92 | 28 | 138 | 1750 |
| Ex. 1-4 | | | | | UV2*¹ | 0.45 | | | | | | | |
| Production | 5 | CTA | 8 | 4 | RP1*² | 7 | 160 | 220 | 21 | 62 | 48 | 132 | 2500 |
| Ex. 1-5 | | | | | | | | | | | | | |
| Production | 6 | CTA | 7 | 4.5 | RP1*² | 6 | 155 | 220 | 22 | 92 | 51 | 130 | 2750 |
| Ex. 1-6 | | | | | | | | | | | | | |
| Production | 7 | CTA | 8 | 4 | RP1*² | 3.2 | 165 | 250 | 20 | 70 | 33 | 136 | 2000 |
| Ex. 1-7 | | | | | | | | | | | | | |
| Production | 8 | CAP | 8 | 4 | UV1/ | 0.7/0.3 | 160 | 250 | 22 | 100 | 70 | 210 | 2500 |
| Ex. 1-8 | | | | | UV2*¹ | | | | | | | | |
| Production | 9 | CAP | 11 | 5.5 | RP1*² | 7 | 175 | 275 | 16 | 40 | 50 | 240 | 1500 |
| Ex. 1-9 | | | | | | | | | | | | | |
| Production | 10 | CAB | 8 | 4 | RP1*² | 6 | 160 | 250 | 20 | 65 | 60 | 180 | 2000 |
| Ex. 1-10 | | | | | | | | | | | | | |
| Production | 11 | CAB | 8 | 4.5 | RP1*² | 6 | 160 | 250 | 20 | 60 | 60 | 240 | 2000 |
| Ex. 1-11 | | | | | | | | | | | | | |
| Production | 12 | CTA | 7 | 3.5 | RP1*² | 7 | 155 | 220 | 24 | 92 | 74 | 220 | 2800 |
| Ex. 1-12 | | | | | | | | | | | | | |
| Production | 13 | CTA | 10 | 5 | RP1*² | 7 | 170 | 250 | 17 | 85 | 55 | 220 | 1700 |
| Ex. 1-13 | | | | | | | | | | | | | |
| Production | 14 | CTA | 11 | 5.5 | RP1*² | 7.5 | 175 | 275 | 16 | 75 | 50 | 200 | 1500 |
| Ex. 1-14 | | | | | | | | | | | | | |
| Production | 15 | CTA | 11 | 5.5 | RP1*² | 7 | 180 | 300 | 15 | 80 | 37 | 176 | 1250 |
| Ex. 1-15 | | | | | | | | | | | | | |
| Production | 16 | CTA | 9 | 4.5 | RP1/ | 4.2/6.6 | 170 | 250 | 18 | 90 | 60 | 200 | 1750 |
| Ex. 1-16 | | | | | (30)*² | | | | | | | | |
| Production | 17 | CTA | 9 | 5.5 | (119)*³/ | 12/1.5 | 170 | 250 | 1 | 65 | 2 | 1 | 1750 |
| Ex. 1-17 | | | | | HOBP*⁴ | | | | | | | | |
| Production | 18 | CTA | 15 | 7.5 | — | — | 180 | 300 | 1 | 80 | 2 | 56 | 750 |
| Ex. 1-18 | | | | | | | | | | | | | |
| Comparative | 19 | CAP | 0 | 2 | UV1/ | 1.4/0.6 | 110 | 150 | 32 | 80 | 45 | 125 | 5900 |
| Production | | | | | UV2*¹ | | | | | | | | |
| Ex. 1-1 | | | | | | | | | | | | | |
| Comparative | 20 | CTA | 1 | 0.5 | RP1*² | 7 | 110 | 150 | 33 | 60 | 48 | 132 | 6000 |
| Production | | | | | | | | | | | | | |
| Ex. 1-2 | | | | | | | | | | | | | |
| Comparative | 21 | CAP | 0 | 1.5 | UV1/ | 2.1/0.9 | 95 | 150 | 35 | 134 | 76 | 210 | 6200 |
| Production | | | | | UV2*¹ | | | | | | | | |
| Ex. 1-3 | | | | | | | | | | | | | |
| Comparative | 22 | CAB | 1 | 1 | RP1*² | 5 | 95 | 150 | 30 | 93 | 56 | 229 | 6100 |
| Production | | | | | | | | | | | | | |
| Ex. 1-4 | | | | | | | | | | | | | |
| Comparative | 23 | CTA | 1 | 0.5 | RP1*² | 6 | 120 | 150 | 30 | 92 | 37 | 176 | 5800 |
| Production | | | | | | | | | | | | | |
| Ex. 1-5 | | | | | | | | | | | | | |
| Production | 24 | CTA | 7.8 | 3.9 | — | — | 160 | 250 | 1 | 80 | 12 | 85 | 2800 |
| Example 2-1 | | | | | | | | | | | | | |
| Reference | TD80UL | — | — | — | — | — | — | — | — | 80 | 4 | 45 | 3900 |
| Reference | TF80UL | — | — | — | — | — | — | — | — | 80 | 3 | 50 | 3800 |
| Reference | TDY80UL | — | — | — | — | — | — | — | — | 80 | 4 | 45 | 3900 |
| Reference | KC80UVSFD | — | — | — | — | — | — | — | — | 80 | 3 | 48 | 3800 |

UV1/UV2*¹: UV ray absorbents
RP1(30)*²: Retardation increasing agent
(119)*³: Retardation decreasing agent
HOBP*⁴: Wavelength distribution controlling agent
*5: Kind of cellulose acylate
*6: Addition amount of plasticizer
*7: Triphenyl phosphate Parts by mass
*8: Biphenyldiphenyl phosphate Parts by mass
*9: Temperature (° C.)
*10: Amount of wind (m³/min)

### Comparative Production Example 1

Films 19 to 23 were prepared in the same manner as in Production Example 1 under the conditions described in Table 2.

### Production Example 2

### Formation of a Cellulose Acylate Film

### (Film 24) Using a Drum Casting Machine

### (1) Dissolution

The following composition was placed in a mixing tank and stirred while heating to 30° C. to dissolve the components to thereby obtain a cellulose acetate solution.

| (Formulation of cellulose acetate solution) | | |
|---|---|---|
| (parts by mass) | Inner Layer | Outer Layer |
| Cellulose acetate (acetylation | 100 | 100 |
| degree: 60.9%) | | |
| Triphenyl hosphate (plasticizer) | 7.8 | 7.8 |
| Biphenyldiphenyl phosphate | 3.9 | 3.9 |
| (plasticizer) | | |
| Methylene chloride (first solvent) | 293 | 314 |
| Methanol (second solvent) | 71 | 76 |
| 1-Butanol (third solvent) | 1.5 | 1.6 |
| Silica fine particles | 0 | 0.8 |
| (“AEROSIL R972” manufactured by | | |
| Nippon Aerosil K.K.) | | |
| Retardation increasing agent (RP2) | 1.4 | 0 |

The above-described cellulose acylate had the substitution degrees as follows.

Substitution degree A: 2.87; Substitution degree B: 0;
Total substitution degree A+B: 2.87; Substitution degree at 6-position: 0.907; Substitution degree at 6-position/Total substitution degree: 0.316

### Retardation Increasing Agent (RP2)

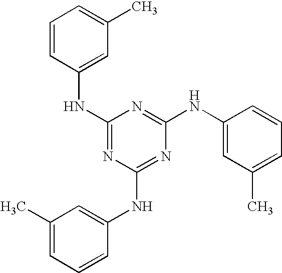

The thus-obtained dope for inner layer and the dope for outer layer were cast onto a drum cooled to 0° C. using a three-layer-co-casting die. A heated air was applied to the surface of the web on the metal support. The temperature and the amount of the heated air were as shown in Table 2. A film of 70% by mass in residual solvent amount was peeled from the drum, dried at 80° C. while conveying with fixing both edges by means of a pin tenter and with a draw ratio in the conveyance direction being 100% (stretch ratio: 1%) and, when the residual solvent amount was reduced to 10% by mass, dried at 110° C. Then, the film was dried at a temperature of 140° C. for 30 minutes. Both ends of the film were cut off before the winding section to adjust the width to 2000 mm, and the film was wound up as a roll film of 4000 m in length. Thus, there was prepared a film 24 containing 0.3% by mass of the residual solvent (outer layer: 3 μm; inner layer: 74 μm; outer layer: 3 μm). With the thus-prepared cellulose acylate film 24, Re₅₉₀ value and Rth₅₉₀ value at a wavelength of 590 nm were measured at 25° C. and 60% RH using a birefringence-measuring apparatus of KOBRA 21ADH (Ohji Measurement Co., Ltd.). In order to calculate Rth₅₉₀ value, 1.48 was inputted as an average refractive index. The modulus of elasticity and the coefficient of expansion due to absorption of moisture were determined in the manner described hereinbefore. As a result, Re₅₉₀ value was found to be 12 nm, Rth₅₉₀ was found to be 85 nm, the modulus of elasticity was found to be 2800 MPa, and the coefficient of expansion due to absorption of moisture was found to be 55 ppm/% RH.

With the film obtained in Production Example 2, the haze was 0.3, the average particle size of secondary particles of the matt agent was 1.0 μm or less, and change in mass after being allowed to stand for 48 hours at 80° C. and 90% RH was 0.5% by mass. Also, dimensional change after being allowed to stand for 24 hours at 60° C. and 95% RH or at 90° C. and 5% RH was within 0.1%. Further, the film had a photoelasticity coefficient of 13×10⁻¹³ cm²/dyne (1.3×10⁻¹³ N/m²).

### Production Example 3

### Preparation of a Cyclic Polyolefin Biaxially Stretched Film

### Film 25

“ZEONOR 1420R” (manufactured by Nippon Zeon K.K.; 100 μl thick) was stretched in the longitudinal direction with a stretch ratio of 30% at a delivery temperature of 140° C. and a film surface temperature of 130° C. Then, the film was stretched in the transverse direction with a stretch ratio of 40% at a delivery temperature of 140° C. and a film surface temperature of 130° C. using a tenter stretching machine. Both ends of the film were cut off before the winding section to adjust the width to 1500 mm, and the film was wound up as a roll film of 4000 m in length. Thus, a biaxially stretched film 25 was prepared. The thickness of the thus-obtained film 25 was 60 μm. With the thus-prepared film 25, Re₅₉₀ value and Rth₅₉₀ value at a wavelength of 590 nm were measured at 25° C. and 60% RH using a birefringence-measuring apparatus of KOBRA 21ADH (Ohji Measurement Co., Ltd.). In order to calculate Rth₅₉₀ value, 1.51 was inputted as an average refractive index. The modulus of elasticity and the coefficient of expansion due to absorption of moisture were determined in the manner described hereinbefore. As a result, Re₅₉₀ was found to be 47 nm, Rth₅₉₀ was found to be 128 nm, the modulus of elasticity was found to be 1800 MPa, and the coefficient of expansion due to absorption of moisture was found to be 1 ppm/% RH.

### Production Example 4

### Preparation of a Protective Film

### Film 26

A polyimide synthesized from 2,2′-bis(3,4-discarboxyphenyl)hexafluoropropane and 2,2′-bis(trifluoromethyl)-4,4′-diaminobiphenyl was dissolved in cyclohexanone to prepare a 15% by mass solution. This polyimide solution was coated on a substrate film of film 17 prepared in Production Example 1 in a dry thickness of 6 μm, followed by drying at 150° C. for 5 minutes. Subsequently, the film was heated at 150° C. for 10 minutes while stretching 15% in the transverse direction with a tenter stretching machine in the atmosphere of 150° C. Both ends of the film were cut off before the winding section to adjust the width to 1800 mm, and the film was wound up as a roll film of 4000 m in length to thereby obtain a film 26. The thickness of the film 26 was 60 μm. With the thus-prepared film 26, Re₅₉₀ value and Rth₅₉₀ value at a wavelength of 590 nm were measured at 25° C. and 60% RH using a birefringence-measuring apparatus of KOBRA 21ADH (Ohji Measurement Co., Ltd.). In order to calculate Rth₅₉₀ value, 1.58 was inputted as an average refractive index. The modulus of elasticity and the coefficient of expansion due to absorption of moisture were determined in the manner described hereinbefore. As a result, Re₅₉₀ was found to be 60 nm, Rth₅₉₀ was found to be 230 nm, the modulus of elasticity was found to be 1800 MPa, and the coefficient of expansion due to absorption of moisture was found to be 45 ppm/% RH.

### Reference Production Example

### Preparation of a Protective Film

### Film 27

A film 27 was prepared in the same manner as in Production Example 4 except for changing the substrate film from the film 17 to “Fuji Tac TD80UL” (manufactured by Fuji Photo Film Co., Ltd.), coating in a dry thickness of 5.5 μm and changing the stretch ratio by the tenter stretching machine to 20%. Both ends of the film were cut off before the winding section to adjust the width to 1450 mm, and the film was wound up as a roll film of 3800 m in length. The thickness of the film 27 was 70 μm. With the thus-prepared film 27, Re₅₉₀ value and Rth₅₉₀ value at a wavelength of 590 nm were measured using a birefringence-measuring apparatus of KOBRA 21ADH (Ohji Measurement Co., Ltd.). The modulus of elasticity and the coefficient of expansion due to absorption of moisture were determined in the manner described hereinbefore. As a result, Re₅₉₀ was found to be 61 min, Rth₅₉₀ was found to be 236 nm, the modulus of elasticity was found to be 4000 MPa, and the coefficient of expansion due to absorption of moisture was found to be 47 ppm/% RH.

### Production Example 5-1

### Preparation of a Protective Film

### Film 31

### <Synthesis of a Cyclic Polyolefin Polymer P-1>

100 Parts by mass of purified toluene and 100 parts by mass of methyl norbornenecarboxylate were added to a reactor. Subsequently, 25 mmol % (based on the weight of the monomer) of Ni ethyl hexanoate dissolved in toluene, 0.225 mol % (based on the weight of the monomer) of tri(pentafluorophenyl)boron and 0.25 mol % (based on the weight of the monomer) of triethylaluminum dissolved in toluene were added to the reactor. The reaction was conducted at room temperature for 18 hours. After completion of the reaction, the reaction mixture was added to an excessive amount of ethanol to form a polymer precipitate. The precipitate was purified, and the resulting polymer (P-1) was vacuum-dried for 24 hours at 65° C.

A composition of the following formulation was placed in a mixing tank and stirred to dissolve each component, followed by filtering through a filter paper of 34 μm in average pore size and then through a sintered metal filter of 10 μm in average pore size.

Cyclic polyolefin solution D-1

| | |
|---|---|
| Cyclic polyolefin P-1 | 150 parts by mass |
| Dichloromethane | 380 parts by mass |
| Methanol | 70 parts by mass |

Next, a composition of the following formulation containing the cyclic polyolefin solution prepared by the above-described method was placed in a dispersing machine to prepare a dispersion of fine particles.

Dispersion of fine particles M-1

| | |
|---|---|
| Silica particles of 16 nm in | 2 parts by mass |
| average particle size (aerosol | |
| R972; manufactured by Nippon Aerosil | |
| K.K.) | |
| Dichloromethane | 73 parts by mass |
| Methanol | 10 parts by mass |
| Cyclic polyolefin solution D-1 | 10 parts by mass |

100 Parts by mass of the cyclic polyolefin solution D-1 and 1.35 parts by mass of the dispersion of fine particles M-1 were mixed with each other to prepare a dope for forming a film.

The dope was cast using a band casting machine. A heated air was applied to the surface of the web on the metal support. The temperature of the heated air was 140° C., and the amount of the heated air was 200 m³/min. A film peeled from the band when the amount of residual solvent reached 43% by mass was stretched at a stretching temperature of 140° C. in the transverse direction with a stretching ratio of 8% using a tenter to thereby form a cyclic polyolefin film. Both ends of the film were cut off before a winding section to adjust the width to 2,000 mm, and the film was wound up as a roll film 31 of 4,000 m in length.

The thickness of the thus-obtained film 31 was 80 μm. With the thus-prepared film 31, Re₅₉₀ value and Rth₅₉₀ value at a wavelength of 590 in were measured at 25° C. and 60% RH using a birefringence-measuring apparatus of “KOBRA 21ADH” (Ohji Measurement Co., Ltd.). In order to calculate Rth₅₉₀ value, 1.51 was inputted as an average refractive index. The modulus of elasticity and the hygroscopic expansion coefficient were determined in the manner described hereinbefore. As a result, Re₅₉₀ was found to be 60 nm, Rth was found to be 220 nm, the modulus of elasticity was found to be 2000 MPa, and the hygroscopic expansion coefficient was found to be 1 ppm/% RH.

### Production Example 5-2

### Preparation of a Protective Film

### Film 32

A composition of the following formulation was placed in a mixing tank and stirred to dissolve each component, followed by filtering through a filter paper of 34 μm in average pore size and then through a sintered metal filter of 10 μm in average pore size.

Cyclic polyolefin solution D-2

| | |
|---|---|
| Cyclic polyolefin: Appear 3000 | 100 parts by mass |
| produced by Promerus LLC | |
| Dichloromethane | 380 parts by mass |
| Methanol | 70 parts by mass |

Next, a composition of the following formulation containing the cyclic polyolefin solution prepared by the above-described method was placed in a dispersing machine to prepare a dispersion of fine particles.

Dispersion of fine particles M-2

| | |
|---|---|
| Silica particles of 16 nm in | 2 parts by mass |
| average particle size (aerosol | |
| R972; manufactured by Nippon Aerosil | |
| K.K.) | |
| Dichloromethane | 73 parts by mass |
| Methanol | 10 parts by mass |
| Cyclic polyolefin solution D-2 | 10 parts by mass |

100 Parts by mass of the cyclic polyolefin solution D-2 and 1.35 parts by mass of the dispersion of fine particles M-2 were mixed with each other to prepare a dope for forming a film.

The dope was cast using a band casting machine. A heated air was applied to the surface of the web on the metal support. The temperature of the heated air was 140° C., and the amount of the heated air was 200 m³/min. A film peeled from the band when the amount of residual solvent reached 38% by mass was stretched at a stretching temperature of 140° C. in the transverse direction with a stretching ratio of 15% using a tenter to thereby form a cyclic polyolefin film. Both ends of the film were cut off before a winding section to adjust the width to 2,000 mm, and the film was wound up as a roll film 32 of 4,000 m in length.

The thickness of the thus-obtained film 32 was 55 μm. With the thus-prepared film 32, Re₅₉₀ value and Rth₅₉₀ value at a wavelength of 590 nm were measured at 25° C. and 60% RH using a birefringence-measuring apparatus of “KOBRA 21ADH” (Ohji Measurement Co., Ltd.). In order to calculate Rth₅₉₀ value, 1.51 was inputted as an average refractive index. The modulus of elasticity and the hygroscopic expansion coefficient were determined in the manner described hereinbefore. As a result, Re₅₉₀ was found to be 56 nm, Rth was found to be 210 nm, the modulus of elasticity was found to be 1800 MPa, and the hygroscopic expansion coefficient was found to be 1 ppm/% RH.

### Production Example 6

### Preparation of Protective Films

### Films 28, 29, 33

### [Preparation of a Coating Solution for a Light-Scattering Layer]

50 g of a mixture of pentaerythritol triacrylate and pentaerythritol tetraacrylate (PETA; manufactured by Nippon Kayaku) was diluted with 38.5 g of toluene. Further, 2 g of a polymerization initiator (Irgacure 184; manufactured by Ciba Specialty Chemicals) was added thereto, and the mixture was stirred. A coat film obtained by coating this solution and curing by UV rays had a refractive index of 1.51.

Further, to this solution were added 1.7 g of a 30% toluene dispersion of cross-linked polystyrene particles (refractive index: 1.60; SX-350; manufactured by Soken Kagaku K.K.) of 3.5 μm in average particle size and 13.3 g of a 30% toluene dispersion of cross-linked acryl-styrene particles (refractive index: 1.55; manufactured by Soken Kagaku K.K.) of 3.5 μm in average particle size, having been dispersed for 20 minutes in a polytron dispersing machine at 10,000 rpm. Finally, 0.75 g of a fluorine-containing surface modifier (FP-132) and 10 g of a silane coupling agent (KBM-5103; manufactured by Shin-Etsu Chemical Co., Ltd.) were added thereto, and the resultant mixed solution was filtered through a polypropylene-made filter of 30 μm in pore size to prepare a coating solution for forming an optical scattering layer.

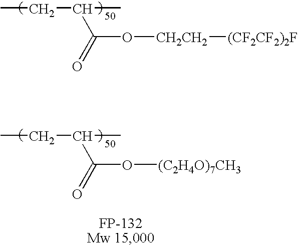

### [Preparation of a Coating Solution Forming a Low-Refractive-Index Layer)

First, a sol solution a was prepared in the following manner.

To a reaction vessel equipped with a stirrer and a reflux condenser were added 120 parts of methyl ethyl ketone, 100 parts of acryloyloxypropyltrimethoxysilane (“KBM503”; manufactured by Shin-Etsu Chemical Co., Ltd.) and 3 parts of diisopropoxyaluminum ethyl acetoacetate and, after mixing, 30 parts of deionized water was added, followed by reacting at 60° C. for 4 hours. The reaction mixture was then cooled to room temperature to obtain a sol solution a. The mass-average molecular mass was 1600 and, of the oligomer components and components having a larger molecular mass, components of 1,000 to 20,000 in molecular mass accounted for 100%. Also, analysis by gas chromatography revealed that absolutely no starting acryloyloxypropyltrimethoxysilane remained.

13 g of a thermally cross-linkable, fluorine-containing polymer (JN-7228; solid content: 6%; manufactured by JSR) having a refractive index of 1.42, 1.3 g of silica sol (silica; same as MEK-ST except for particle size; average particle size: 45 nm; solid content: 30%; manufactured by Nissan Kagaku K.K.), 0.6 g of the above-described sol solution a, 5 g of methyl ethyl ketone and 0.6 g of cyclohexanone were mixed and, after stirring, filtered through a polypropylene-made filter of 1 μm in pore size to thereby prepare a coating solution for forming a low-refractive-index layer.

### [Preparation of a Protective Film Having an Anti-Reflection Layer]

A substrate film of 80-μm thick triacetyl cellulose film (FUJI TAC TD80UF; manufactured by Fuji Photo Film Co., Ltd.) was wound off from a roll, and the coating solution forming the functional layer (light scattering layer) was coated thereon under the conditions of 30 rpm in gravure roll rotation number and 30 m/min in conveying speed using a gravure roll of 50 mm in diameter having a gravure pattern of 180 lines/inch and 40 μm in depth and using a doctor blade. After drying at 60° C. for 150 seconds, the coated layer was cured by irradiating with UV rays with a illuminance of 400 mW/cm² and an irradiation amount of 250 mJ/cm² using a 160 W/cm air-cooled metal halide lamp (manufactured by EYEGRAPHICS Co., Ltd.) while purging with nitrogen. Thus, a 6-μm thick functional layer was formed and wound up.

The triacetyl cellulose film having provided thereon the functional layer (light scattering layer) was again wound off, and the above-prepared coating solution for forming a low-refractive-index layer was coated on the light scattering layer-coated side of the film under the conditions of 30 rpm in gravure roll rotation number and 15 m/min in conveying speed using a gravure roll of 50 mm in diameter having a gravure pattern of 180 lines/inch and 40 μm in depth and using a doctor blade. After drying at 120° C. for 150 seconds then at 140° C. for 8 minutes, the coated layer was cured by irradiating with UV rays with a illuminance of 400 mW/cm² and an irradiation amount of 900 mJ/cm² using a 240 W/cm air-cooled metal halide lamp (manufactured by EYEGRAPHICS Co., Ltd.) while purging with nitrogen. Thus, a 100-nm thick low-refractive-index layer was formed and wound up to prepare a protective film having an anti-reflection layer (film 28).

With the thus-prepared film 28, Re₅₉₀ value and Rth₅₉₀ value at a wavelength of 590 nm were measured at 25° C. and 60% RH using a birefringence-measuring apparatus of KOBRA 21ADH (Ohji Measurement Co., Ltd.). In order to calculate Rth₅₉₀ value, 1.48 was inputted as an average refractive index. The modulus of elasticity and the coefficient of expansion due to absorption of moisture were determined in the manner described hereinbefore. As a result, Re₅₉₀ was found to be 5 nm, Rth₅₉₀ was found to be 46 nm, and the modulus of elasticity was found to be 3900 MPa.

Also, a protective film (film 29) having an antireflective layer was prepared in the same manner except for changing the substrate film to the film 18 prepared in Production Example 1.

With the thus-prepared film 29, Re₅₉₀ was found to be 3 nm, Rth₅₉₀ was found to be 58 nm, and the modulus of elasticity was found to be 1550 MPa.

Further, a protective film (film 33) having an antireflective layer was prepared in the same manner except for changing the substrate film to a cyclic polyolefin film ZEONOR ZF14 (manufactured by OPTES INC.).

With the thus-prepared film, Re₅₉₀ was found to be 3 nm, Rth was found to be 10 nm, and the modulus of elasticity was found to be 2200 MPa.

### Production Example 7

### Preparation of a Protective Film

### (Film 30) Having an Anti-Reflection Layer

### [Preparation of a Coating Solution for Forming a Hard Coat Layer]

To 750.0 parts by mass of trimethylolpropane triacrylate (TMPTA; manufactured by Nippon Kayaku) were added 270.0 parts by mass of poly(glycidyl methacrylate) having a mass-average molecular mass of 3,000, 730.0 g of methyl ethyl ketone, 500.0 g of cyclohexanone and 50.0 g of a photo polymerization initiator (Irgacure 184; Nihon Ciba Geigy K.K.), and the mixture was stirred. The mixture was then filtered through a polypropylene-made filter of 0.4 μm in pore size to prepare a coating solution for forming a hard coat layer.

### [Preparation of a Dispersion of Titanium Dioxide Fine Particles]

As titanium dioxide fine particles, titanium dioxide fine particles (MPT-129; manufactured by Ishihara Sangyo K.K.) containing cobalt and having been subjected to surface treatment with aluminum hydroxide and zirconium hydroxide were used.

To 257.1 g of the particles were added 38.6 g of the following dispersing agent and 704.3 g of cyclohexanone, followed by dispersing in a dynomil to thereby prepare a dispersion of titanium dioxide of 70 nm in mass-average size.

### Dispersing Agent

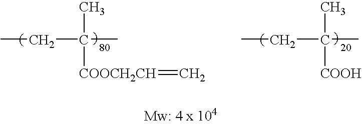

### [Preparation of a Coating Solution for Forming a Middle-Refractive-Index Layer]

To 88.9 g of the titanium dioxide dispersion were added 58.4 g of a mixture of dipentaerythritol pentaacrylate and dipentaerythritol hexaacrylate “DPHA”, 3.1 g of a photo polymerization initiator “Irgacure 907”, 1.1 g of a photo sensitizer “Kayacure DETX” (manufactured by Nippon Kayaku), 482.4 g of methyl ethyl ketone and 1869.8 g of cyclohexanone, followed by stirring. After sufficient stirring, the solution was filtered through a polypropylene-made filter of 0.4 μm in pore size to thereby prepare a coating solution for forming a middle-refractive-index layer.

### [Preparation of a Coating Solution for Forming a High-Refractive-Index Layer]

To 586.8 g of the titanium dioxide dispersion were added 47.9 g of a mixture of dipentaerythritol pentaacrylate and dipentaerythritol hexaacrylate “DPHA” (manufactured by Nippon Kayaku), 4.0 g of a photo polymerization initiator “Irgacure 907” (manufactured by Ciba Specialty Chemicals), 1.3 g of a photo sensitizer “Kayacure DETX” (manufactured by Nippon Kayaku), 455.8 g of methyl ethyl ketone and 1427.8 g of cyclohexanone, followed by stirring. The solution was filtered through a polypropylene-made filter of 0.4 μm in pore size to thereby prepare a coating solution for forming a high index layer.

### [Preparation of a Coating Solution for Forming a Low-Refractive-Index Layer]

A copolymer (P-1) of the following structure was dissolved in methyl isobutyl ketone so that the concentration became 7% by mass, and 3% by mass, based on solid components, of a terminal methacrylate group-containing silicone resin “X-22-164C” (manufactured by Shin-Etsu Chemical Co., Ltd.) and 5% by mass, based on solid components, of a photo radical generator Irgacure 907 (trade name) were added thereto to thereby prepare a coating solution for forming a low-refractive-index layer.

### Copolymer (P-1)

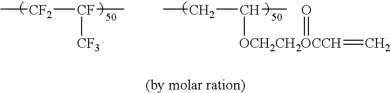

### [Preparation of a Protective Film Having an Anti-Reflection Layer)

On a substrate film of a 80-μm thick triacetyl cellulose film “FUJI TAC TD80UF” (manufactured by Fuji Photo Film Co., Ltd.) was coated a coating solution forming a hard coat layer using a gravure coater. After drying at 100° C., the coated layer was cured by irradiating with UV rays with a illuminance of 400 mW/cm² and an irradiation amount of 300 mJ/cm² using a 160 W/cm air-cooled metal halide lamp (manufactured by EYEGRAPHICS Co., Ltd.) while purging with nitrogen so that the oxygen concentration in the atmosphere became 1.0% by volume or less. Thus, a 8-μm thick hard coat layer was formed.

On the hard coat layer were consecutively coated the coating solution for forming a middle-refractive-index layer, the high-refractive-index layer and the low-refractive-index layer using a gravure coater having three coating stations.

The drying conditions for the middle-refractive-index layer were 100° C. and 2 minutes, and curing with UV rays was conducted under the conditions of 400 mW/cm² in illuminance and 400 mJ/cm² in irradiation amount using a 180 W/cm air-cooled metal halide lamp (manufactured by EYEGRAPHICS Co., Ltd.) while purging with nitrogen so that the oxygen concentration in the atmosphere became 1.0% by volume or less. After curing, the middle-refractive-index layer had a refractive index of 1.630 and a film thickness of 67 nm.

The drying conditions for the high-refractive-index layer and the low-refractive-index layer were 90° C. and 1 minute, then 100° C. and 1 minute. Curing with UV rays was conducted under the conditions of 600 mW/cm² in illuminance and 600 mJ/cm² in irradiation amount using a 240 W/cm air-cooled metal halide lamp (manufactured by EYEGRAPHICS Co., Ltd.) while purging with nitrogen so that the oxygen concentration in the atmosphere became 1.0% by volume or less.

After curing, the high-refractive-index layer had a refractive index of 1.905 and a film thickness of 107 nm, and the low-refractive-index layer had a refractive index of 1.440 and a film thickness of 85 nm. Thus, there was prepared a protective film (film 30) having an anti-reflection layer.

With the thus-prepared film 30, Re₅₉₀ value and Rth₅₉₀ value at a wavelength of 590 nm were measured at 25° C. and 60% RH using a birefringence-measuring machine KOBRA 21ADH (Ohji Measurement Co., Ltd.). In order to calculate Rth₅₉₀ value, 1.48 was inputted as an average refractive index. The modulus of elasticity and the coefficient of expansion due to absorption of moisture were determined in the manner described hereinbefore. As a result, Re₅₉₀ was found to be 6 nm, Rth₅₉₀ was found to be 48 nm, and the modulus of elasticity was found to be 3950 MPa.

The structure of each protective film prepared in Production Examples 4 to 7 and the functional layers are tabulated in Table 3.

TABLE 3

| | Substrate | Protective Film | | |
|---|---|---|---|---|
| Production | or Support | (Film) | Layer Structure on Substrate or | |
| Example No. | Film No. | No. | Support | Functional Layer |
| Production | 17 | 26 | polyimide layer | |
| Example 4 | | | | |
| Reference | TD80UL | 27 | polyimide layer | |
| Production | | | | |
| Example | | | | |
| Reference | TD80UL | 28 | light-scattering layer/low- | anti-reflection layer |
| Production | | | refractive-index layer | |
| Example | | | | |
| Production | 18 | 29 | light-scattering layer/low- | anti-reflection layer |
| Example 6 | | | refractive-index layer | |
| Production | TD80UL | 30 | hard coat layer/middle-refractive- | hard coat layer/anti- |
| Example 7 | | | index layer/high-refractive-index | reflection layer |
| | | | layer/low-refractive-index layer | |

TD80UL: “Fuji Tac TD80UL” (manufactured by Fuji Photo Film Co., Ltd.)

### Synthesis Example 1

### (1) Preparation of a (Meth)Acrylic Copolymer (A) Solution

A (meth)acylate (a1) whose homopolymer has a Tg of less than −30° C., a vinyl group-having compound (a2) whose homopolymer has a Tg of −30 C or more, a monomer (a3) having a functional group capable of reacting with a multi-functional compound, and a polymerization initiator were placed in a reaction vessel with a composition ratio shown in Table 4 and, after purging the atmosphere of this reaction vessel with a nitrogen gas, reaction was conducted at a reaction temperature and a reaction time shown in Table 4 under stirring and in the nitrogen atmosphere. With (meth)acrylic copolymers No. 1, 2, 3, 5 and 6, the reaction solution was diluted with ethyl acetate after completion of the reaction to adjust the solid concentration to 20% by mass, thus (meth)acrylic copolymer solutions being obtained. With (meth)acrylic copolymers No. 4 and 7, the reaction solution was diluted with toluene after completion of the reaction to adjust the solid concentration to 20% by mass, thus (meth)acrylic copolymer solutions being obtained.

### [Measurement of Mass-Average Molecular Mass]

Mass-average molecular mass (Mw) in terms of styrene of each of the copolymers in the (meth)acrylic copolymer solutions was determined according to gel permeation chromatography (GPC). Measuring conditions are shown below. The results thus-obtained are shown in Table 4.
Name of apparatus: “HLC-8120” (manufactured by Toso K.K.)
Column: “G7000HXL”, 7.8 mmID×30 cm; one column (manufactured by Toso K.K.) “GMHXL”, 7.8 mmID×30 cm; two columns (manufactured by Toso K.K.) “G2500HXL”, 7.8 mmID×30 cm; one columns (manufactured by Toso K.K.)
Sample concentration: Diluted with tetrahydrofuran to a concentration of 1.5 mL/mL.
Solvent of mobile phase: tetrahydrofuran
Flow rate: 1.0 mL/min
Column temperature: 40° C.

TABLE 4

| (Meth)acrylic Copolymer (A) | | | | | | Reatction | |
|---|---|---|---|---|---|---|---|
| Copolymer | Formulation | | | | Polymerization | Temperature/ | |
| No. | a₁ | a₂ | a₃ | Solvent Formulation | Initiator | Time | Mw (×10000) |
| 1 | BA: 100 | | AA: 5 | EAc: 120/toluene: 30 | BPO: 0.3 | 70° C./10 hr | 80 |
| 2 | BA: 80 | MA: 20 | AA: 5 | EAc: 120/toluene: 30 | AIBN: 0.3 | 70° C./10 hr | 70 |
| 3 | BA: 100 | | AA: 5 | EAc: 100 | BPO: 0.2 | 66° C./10 hr | 150 |
| 4 | BA: 90 | BzA: 10 | HEA: 1 | toluene: 100 | AIBN: 2/LaSH: 2 | 110° C./10 hr | 1 |
| 5 | BA: 50 | MA: 50 | AA: 5 | EAc: 120/toluene: 30 | AIBN: 0.3 | 70° C./10 hr | 75 |
| 6 | BA: 80 | MA: 20 | AA: 15 | EAc: 120/toluene: 30 | AIBN: 0.3 | 70° C./10 hr | 70 |
| 7 | BA: 90 | BzA: 10 | HEA: 0.1 | toluene: 100 | AIBN: 2/LaSH: 2 | 110° C./6 hr | 1 |

Formulation ratio: parts by mass
BA: butyl acrylate;
EAc: ethyl acetate;
BPO: benzoyl peroxide;
MA: methyl acrylate;
AIBN: azobisisobutyronitrile;
AA: actylic acid;
LaSH: lauryl-mercaptan;
BzA: benzyl acrylate;
HEA: 2-hydroxyethyl acrylate

### (2) Preparation of an Adhesive Solution

The (meth)acrylic copolymer (A) solutions prepared in Synthesis Example 1 were mixed in the solid component ratios shown in Table 5, multi-functional compounds (cross-linking agents) shown in Table 5 were added thereto, followed by sufficient stirring to obtain adhesive solutions 1 to 12.

### [Measurement of Gel Fraction]

Measurement of gel fraction was conducted as follows. An adhesive solution was coated on a 25-μm thick PET film using a die coater, then dried. The coating amount was adjusted so that the dry thickness became 25 μm. About 20 mL of the dried adhesive layer was dipped in about 10 mL of chloroform, and an insoluble component was collected by filtering through a 0.45-μm filter. The component remaining on the filter was dried and weighed. The mass was taken as Mg of a gel component (cross-linked component). Further, the filtrate was dried, and the mass of the residue was weighed. The mass was taken as Ms of a sol component (non-cross-linked component). The gel fraction was calculated according to the following formula:

Gel fraction (%)=Mg/(Mg+Ms)×100

### (Formation of an Adhesive Layer by Coating)

Formation of an adhesive layer on a polarizing plate by coating was conducted as follows.

Each of the adhesive solutions 1 to 12 was coated on a 25-μm thick PET film using a die coater, and then dried. Here, the thickness of the coated solution was adjusted so that the dry thickness became 25 μm. Further, the adhesive layer coat-formed on the PET film was transferred onto a polarizing plate, followed by ripening at 25 C and 60% RH for 7 days. Thus, the adhesive solutions 1 to 12 were coated to form adhesive layers 1 to 12.

### [Measurement of Creep Value]

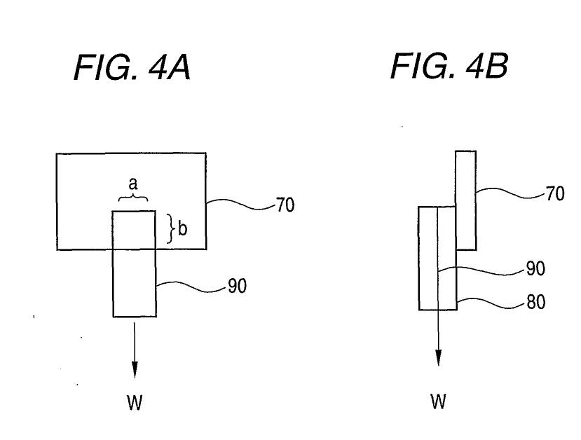

The polarizing plate having formed thereon the adhesive layer was stuck onto a washed and dried, alkali-free glass plate (product No. 1737; manufactured by Corning) as shown in FIGS. 4A and 4B. FIG. 4A is a plane view, and FIG. 4B is a side view. Numeral 70 represents a glass plate, 80 represents an adhesive layer, and 90 represents a polarizing plate. The stuck area was 10 mm (vertical length a)×10 mm (horizontal length b). The initial adhesion pressure was adjusted to 5 kg/cm² (0.49 MPa). Then, the adhesion pressure was removed, and a load W of 200 g was applied thereto for 1 hour in an atmosphere of 50° C., followed by taking out in an atmosphere of room temperature. Then, the load was removed, and the creep deformation was measured. As is the same with the case of 50° C., the creep deformation was measured by changing the polarizing plate having formed thereon the adhesive layer to a non-tested one and changing the temperature of the atmosphere to 25° C., 70° C. and 90° C.

Physical properties of the adhesives 1 to 12 were tabulated in Table 5.

TABLE 5

| | | | | Functional | | | | | |
|---|---|---|---|---|---|---|---|---|---|
| Adhesive | Compounding of | | Gel | Group | | | | | |
| Solution | (meth)acrylic | Multi-functional | Fraction | Fraction | Creep Value (μm) | | | | |
| No. | Copolymer (A) | Compound (B) | (wt %) | (wt %) | 25° C. | 50° C. | 70° C. | 90° C. | Note |
| 1 | No. 1: 100 | TetradX: 0.02 | 50 | 0 | 12 | 18 | 18 | 38 | present invention |
| 2 | No. 1: 100 | TetradX: 0.04 | 75 | 0 | 8 | 14 | 18 | 22 | present invention |
| 3 | No. 2: 100 | CoronateL: 0.03 | 60 | 0 | 10 | 13 | 20 | 25 | present invention |
| 4 | No. 3: 100/No. 4: 50 | CoronateL: 0.04 | 70 | 10 | 14 | 20 | 30 | 45 | present invention |
| 5 | No. 3: 100 | CoronateL: 0.04 | 70 | 0 | 5 | 8 | 12 | 18 | present invention |
| 6 | No. 3: 100/No. 4: 5 | CoronateL: 0.04 | 70 | 1 | 10 | 15 | 25 | 35 | present invention |
| 7 | No. 1: 100 | TetradX: 0.005 | 30 | 0 | 38 | 65 | 86 | 98 | present invention |
| 8 | No. 1: 100 | TetradX: 2 | 95 | 0 | 80 | 162 | 189 | 225 | comparative sample |
| 9 | No. 5: 100 | Coronate L: 0.03 | 60 | 0 | 62 | 105 | 115 | 135 | comparative sample |
| 10 | No. 6: 100 | Coronate L: 2 | 97 | 0 | 100 | 125 | 145 | 163 | comparative sample |
| 11 | No. 3: 100/No. 4: 200 | Coronate L: 0.04 | 85 | 40 | 150 | 192 | 235 | 268 | comparative sample |
| 12 | No. 3: 100/No. 7: 300 | Coronate L: 0.04 | 85 | 6 | 120 | 165 | 201 | 235 | comparative sample |

Formulation ratio: parts by mass
No. assigned for (meth)acrylic copolymer (A): copolymer No.
“Tetrad X”: N,N,N′,N′-Tetraglycidyl-m-xylenediamine: manufactured by Mitsubishi Gas Kagaku K.K.
“Coronate L”: Tolylene diisocyanate trimethylolpropane adduct: manufactured by Nippon Polyurethane Industry Co., Ltd.

### [Preparation of Polarizing Plate]

### Example 1 and Comparative Example 1

### Preparation of Polarizer

A 80-μm thick polyvinyl alcohol (PVA) film was dipped in a 0.05% by mass aqueous solution of iodine at 30° C. for 60 seconds to dye, then longitudinally stretched 5 times as long as the original length while dipping in a 4% by mass aqueous solution of boric acid for 60 seconds, followed by drying at 50° C. for 4 minutes to thereby obtain a 20-μm thick polarizer.

### (Surface Treatment of Cellulose Acylate Film)

Protective films prepared in Production Examples 1, 2, 4 to 7 and Comparative Production Example 1 and commercially available cellulose acylate films described blow were dipped in a 55° C., 1.5 mol/L sodium hydroxide aqueous solution, then well washed with water to remove sodium hydroxide. Subsequently, they were dipped in a 35° C., 0.005 mol/L dilute sulfuric acid aqueous solution for 1 minute, then dipped in water to sufficiently wash away the dilute sulfuric acid aqueous solution. Finally, the samples were sufficiently dried at 120° C.

### (Preparation of a Polarizing Plate)

The polarizer was adhesively sandwiched between a combination of the thus-saponification-treated protective films and the commercially available cellulose acylate films as shown in Tables 6 and 7 using a polyvinyl alcohol adhesive to prepare polarizing plates.

As the commercially available cellulose acylate film, “Fuji Tac T40UZ”, “Fuji Tac TF80UL”, “Fuji Tac TD80UL” and “Fuji Tac TDY80UL” (these being manufactured by Fuji Photo Film Co., Ltd.) and “KC80UVSFD” (manufactured by Konica Opto K.K.) were used.

In this occasion, the polarizer and the protective film on each side are prepared in a roll form, and hence the longitudinal directions of the roll films are parallel to each other, thus being continuously laminated one over the other. Also, as is shown in FIG. 1, with the protective film 3 disposed on the cell side of the polarizing plate, the transmission axis of the polarizer is parallel to the slow axis of each of the cellulose acylate films prepared in Production Examples 1, 2, 4 to 7 and Comparative Production Example 1.

### (Formation of an Adhesive Layer by Coating)

An adhesive layer was formed on the polarizing plate by coating in the following manner.

An adhesive solution was coated on a 25-μm thick PET film using a die coater, and then dried. The coating amount was adjusted to that the dry thickness of the adhesive layer became 25 μm. Further, the adhesive layer coat-formed on the PET film was transferred onto the above-prepared polarizing plate, with a combination shown in Tables 6 and 7, followed by ripening at 25° C. and 60% RH for 7 days.

A PET separator was applied to the adhesive layer side of the thus-prepared polarizing plate, and a PET-made protect film was applied to the side opposite to the adhesive layer side.

### Example 2

A polarizing plate was prepared by laminating a cellulose acetate film 29 having been saponification-treated as in Example 1 on one side of a polarizer prepared in the same manner as in Example 1 using a polyvinyl alcohol series adhesive, laminating a film 25 having been prepared in Production Example 3 on the opposite side using an acrylic adhesive “DD624” (manufactured by Nogawa Chemical K.K.), and conducting the subsequent procedures in the same manner as in Example 1 to form an adhesive layer.

Each of cellulose acylate film 6, cellulose acylate film FUJITAC TDY80UL (manufactured by Fuji Photo Film Co., Ltd.) and cellulose acylate film 13 were subjected to the same saponification treatment as in Example 1, and was stuck onto one side of a polarizer prepared in the same manner as in Example 1 using a polyvinyl alcohol series adhesive.

Also, each of the cyclic polyolefin film 25, the cyclic polyolefin film 33, cyclic polyolefin film ZEONOR ZF14 (manufactured by OPTES INC.), the cyclic polyolefin film 31 and the cyclic polyolefin film 32 was stuck onto one side of a polarizer in the same manner as in Example 1 using an acrylic adhesive “DD624” (manufactured by NOGAWA CHEMICAL Co., Ltd.).

Polarizing plates described in Table 6 or 7 were prepared in the above-described manner, followed by providing an adhesive layer by coating in the same manner as in Example 1.

### (Reworkability)

100×100 mm size samples were punched from each of the thus-prepared polarizing plates and were stuck onto a glass substrate. Each of the polarizing plate samples was peeled a bit from the glass substrate at one of the 4 corners of each sample, and the polarizing plate was peeled in the diagonal direction with gripping the peeled portion of the polarizing plate. The same procedure was performed with 10 samples in total, and the samples were evaluated according to the following standard.

OO: All of 10 samples were completely peeled.
O: Only one sample suffered partial remaining of the polarizing plate due to unpeeling.
Δ: 2 to 5 samples suffered partial remaining of the polarizing plate due to unpeeling.
x: 6 or more samples suffered partial remaining of the polarizing plate due to unpeeling.

Constitution and reworkability of each of the polarizing plates prepared in Examples 1 and 2 are tabulated in Tables 6 and 7. It is apparent that the polarizing plates using the films of the invention showed improved reworkability.

TABLE 6
Polarizing plate on the viewing side

| | | | Adhesive | | |
|---|---|---|---|---|---|
| | Protective Film (Film No.) | | Solution No. | | |
| | | Opposite Side to | For | | |
| Polarizing | Liquid Crystal Cell | Liquid Crystal | Adhesive | | |
| Plate No. | Side | Cell | Layer | Reworkability | |
| F-1 | 1 | 28*¹ | 1 | ◯ | Example |
| F-2 | 2 | 29*¹ | 1 | ◯◯ | Example |
| F-3 | 3 | 30*¹ | 1 | ◯ | Example |
| F-4 | 4 | 30*¹ | 2 | ◯ | Example |
| F-5 | 5 | 29*¹ | 2 | ◯◯ | Example |
| F-6 | 6 | 29*¹ | 2 | ◯◯ | Example |
| F-7 | 7 | 28*¹ | 2 | ◯ | Example |
| F-8 | 25 | 29*¹ | 2 | ◯◯ | Example |
| F-9 | KC80UVSFD | 29*¹ | 2 | ◯ | Example |
| F-10 | 24 | 28*¹ | 2 | ◯ | Example |
| F-11 | TD80UL | 29*¹ | 2 | ◯ | Example |
| F-12 | TF80UL | 29*¹ | 2 | ◯ | Example |
| F-13 | TDY80UL | 29*¹ | 2 | ◯ | Example |
| F-14 | 12 | 29*¹ | 2 | ◯◯ | Example |
| F-15 | 16 | 28*¹ | 2 | ◯ | Example |
| F-16 | TD80UL | 29*¹ | 3 | ◯ | Example |
| F-17 | 24 | 30*¹ | 3 | ◯ | Example |
| F-18 | 29*¹ | 29*¹ | 4 | ◯◯ | Example |
| F-19 | TDY80UL | 29*¹ | 4 | ◯ | Example |
| F-20 | 24 | 29*¹ | 5 | ◯◯ | Example |
| F-21 | TD80UL | 29*¹ | 6 | ◯ | Example |
| FR-1 | TD80UL | 28*¹ | 8 | X | Comparative |
| | | | | | Ex. |
| FR-2 | TD80UL | 28*¹ | 8 | X | Comparative |
| | | | | | Ex. |
| FR-3 | 29*¹ | 29*¹ | 9 | Δ | Comparative |
| | | | | | Ex. |
| FR-4 | TD80UL | 28*¹ | 10 | X | Comparative |
| | | | | | Ex. |
| FR-5 | TD80UL | 28*¹ | 11 | X | Comparative |
| | | | | | Ex. |
| FR-6 | TD80UL | 28*¹ | 12 | X | Comparative |
| | | | | | Ex. |
| F-24 | 17 | 28*¹ | 2 | Δ | Example |
| F-25 | 25 | 33*¹ | 2 | ◯◯ | Example |
| F-26 | 6 | 33*¹ | 2 | ◯◯ | Example |
| F-27 | TDY80UL | 33*¹ | 2 | ◯◯ | Example |
| FR-9 | 17 | 28*¹ | 12 | Δ | Comparative |
| | | | | | Ex. |
| FR-10 | 19 | 28*¹ | 5 | X | Comparative |
| | | | | | Ex. |
| FR-11 | 19 | 28*¹ | 10 | X | Comparative |
| | | | | | Ex. |
| FR-12 | 20 | 28*¹ | 11 | X | Comparative |
| | | | | | Ex. |
| FR-13 | TD80UL | 28*¹ | 12 | X | Comparative |
| | | | | | Ex. |
| FR-14 | TD80UL | 28*¹ | 2 | X | Comparative |
| | | | | | Ex. |
| FR-15 | TD80UL | 28*¹ | 10 | X | Comparative |
| | | | | | Ex. |
| FR-16 | TD80UL | 28*¹ | 11 | X | Comparative |
| | | | | | Ex. |

*¹having anti-reflective function

TABLE 7
Polarizing plate on the backlight side

| | Protective Film (Film No.) | | Adhesive | | |
|---|---|---|---|---|---|
| Polarizing | | Opposite Side | Solution No. | | |
| Plate | Liquid Crystal | to Liquid | For Adhesive | | |
| No. | Cell Side | Crystal Cell | Layer | Reworkability | |
| B-1 | 1 | KC80UVSFD | 1 | ◯ | Example |
| B-2 | 2 | 29*¹ | 1 | ◯◯ | Example |
| B-3 | 3 | TDY80UL | 1 | ◯ | Example |
| B-4 | 4 | T40UZ | 2 | ◯ | Example |
| B-5 | 5 | TF80UL | 2 | ◯ | Example |
| B-6 | 6 | 24 | 2 | ◯◯ | Example |
| B-7 | 7 | TD80UL | 2 | ◯ | Example |
| B-8 | 25 | 29*¹ | 2 | ◯◯ | Example |
| B-9 | 8 | KC80UVSFD | 2 | ◯ | Example |
| B-10 | 9 | T80UZ | 2 | ◯ | Example |
| B-11 | 10 | TDY80UL | 2 | ◯ | Example |
| B-12 | 11 | T40UZ | 2 | ◯ | Example |
| B-13 | 12 | 24 | 2 | ◯◯ | Example |
| B-14 | 13 | 24 | 2 | ◯◯ | Example |
| B-15 | 14 | 28*¹ | 2 | ◯ | Example |
| B-16 | 16 | 24 | 2 | ◯◯ | Example |
| B-17 | TD80UL | 29*¹ | 2 | ◯ | Example |
| B-18 | 26 | 24 | 7 | ◯ | Example |
| B-19 | 27 | 29*¹ | 2 | ◯ | Example |
| B-20 | 12 | TD80UL | 3 | ◯ | Example |
| B-21 | 16 | 24 | 3 | ◯◯ | Example |
| B-22 | 12 | 29*¹ | 4 | ◯◯ | Example |
| B-23 | 16 | 24 | 4 | ◯◯ | Example |
| B-24 | 12 | 24 | 5 | ◯◯ | Example |
| B-25 | 12 | TD80UL | 6 | ◯ | Example |
| BR-1 | 12 | TD80UL | 8 | Δ | Comparative |
| | | | | | Ex. |
| BR-2 | 12 | TD80UL | 8 | Δ | Comparative |
| | | | | | Ex. |
| BR-3 | 12 | TD80UL | 9 | Δ | Comparative |
| | | | | | Ex. |
| BR-4 | 12 | TD80UL | 10 | Δ | Comparative |
| | | | | | Ex. |
| BR-5 | 12 | TD80UL | 11 | Δ | Comparative |
| | | | | | Ex. |
| BR-6 | 12 | TD80UL | 12 | Δ | Comparative |
| | | | | | Ex. |
| B-29 | 17 | TD80UL | 2 | ◯ | Example |
| B-30 | 25 | ZEONORZF14 | 2 | ◯◯ | Example |
| B-31 | 6 | ZEONORZF14 | 2 | ◯◯ | Example |
| B-32 | 13 | ZEONORZF14 | 2 | ◯◯ | Example |
| B-33 | 31 | ZEONORZF14 | 2 | ◯◯ | Example |
| B-34 | 32 | ZEONORZF14 | 2 | ◯◯ | Example |
| B-35 | 31 | TD80UL | 2 | ◯◯ | Example |
| B-36 | 32 | TD80UL | 2 | ◯◯ | Example |
| BR-9 | 17 | TD80UL | 12 | Δ | Comparative |
| | | | | | Ex. |
| BR-10 | 19 | TD80UL | 5 | X | Comparative |
| | | | | | Ex. |
| BR-11 | 19 | TD80UL | 10 | X | Comparative |
| | | | | | Ex. |
| BR-12 | 20 | TD80UL | 11 | X | Comparative |
| | | | | | Ex. |
| BR-13 | 21 | TD80UL | 12 | X | Comparative |
| | | | | | Ex. |
| BR-14 | 22 | TD80UL | 2 | X | Comparative |
| | | | | | Ex. |
| BR-15 | 22 | TD80UL | 10 | X | Comparative |
| | | | | | Ex. |
| BR-16 | 23 | TD80UL | 11 | X | Comparative |
| | | | | | Ex. |

*¹having anti-reflective function

### [Measurement of Reflectance]

The spectral reflectance with an incident angle of 5° was measured from the functional film side in the range of from 380 to 780 nm using a spectrophotometer (manufactured by Nihon Bunko K.K.). The integrating sphere-average reflectance in the range of from 450 to 650 nm was determined to be 2.3% with the polarizing plate using the film 24 which is a protective film having an anti-reflection layer, and was 0.4% with the polarizing plate using the film 25 which is a protective film having an anti-reflection layer. Here, the reflectance was measured after peeling the protect film on the protective film having the anti-reflection layer.

### Examples 3-1 to 3-33

### Mounting on VA Panel

Each of the polarizing plates prepared in Example 1 and Example 2 was punched out in a rectangular form so that, with the polarizing plate on the viewing side, the absorption axis of the polarizer became the longer side of 26′-wide size screen and, with the polarizing plate on the backlight side, the absorption axis of the polarizer became the shorter side. Polarizing plates and retardation plates in a VA mode liquid crystal TV set “KDL-L26RX2” (manufactured by Sony K.K.) were removed from both sides, and the polarizing plates prepared in Example 1, Comparative Example 1 and Example 2 were laminated on both sides with a combination shown in Table 8, thus liquid crystal display devices VA-1 to VA-33 being prepared. After laminating the polarizing plates, each of the assemblies was kept for 20 minutes at 50° C. and 5 kg/cm² (0.49 MPa) to stick. In this occasion, the polarizing plates were disposed so that absorption axis of the polarizing plate on the viewing side was in a horizontal direction of the panel and that absorption axis of the polarizing plate on the backlight side was in a vertical direction of the panel, with the adhesive material surface being on the liquid crystal cell side.

After peeling the protect film, the viewing angle (range where the contrast ratio was 10 or more) was calculated from luminance measured upon black display and upon white display using a measuring machine “EZ-Contrast 160D” (manufactured by ELDIM). With every polarizing plate, good viewing angle characteristics of 80° or more in polar angle were obtained in all directions.

TABLE 8

| | Liquid | | | |
|---|---|---|---|---|
| | Crystal | Polarizing plate | | |
| | Display | No. on | | Polarizing plate No. |
| | Device No. | Viewing Side | Liquid Crystal Cell | on Backlight Side |
| Example 3-1 | VA-1 | F-1 | VA | B-1 |
| Example 3-2 | VA-2 | F-2 | VA | B-2 |
| Example 3-3 | VA-3 | F-3 | VA | B-3 |
| Example 3-4 | VA-4 | F-4 | VA | B-4 |
| Example 3-5 | VA-5 | F-5 | VA | B-5 |
| Example 3-6 | VA-6 | F-6 | VA | B-6 |
| Example 3-7 | VA-7 | F-7 | VA | B-7 |
| Example 3-8 | VA-8 | F-8 | VA | B-8 |
| Example 3-9 | VA-9 | F-9 | VA | B-9 |
| Example 3-10 | VA-10 | F-10 | VA | B-10 |
| Example 3-11 | VA-11 | F-11 | VA | B-11 |
| Example 3-12 | VA-12 | F-12 | VA | B-12 |
| Example 3-13 | VA-13 | F-10 | VA | B-13 |
| Example 3-14 | VA-14 | F-13 | VA | B-14 |
| Example 3-15 | VA-15 | F-10 | VA | B-15 |
| Example 3-16 | VA-16 | F-10 | VA | B-16 |
| Example 3-17 | VA-17 | F-14 | VA | B-17 |
| Example 3-18 | VA-18 | F-15 | VA | B-17 |
| Example 3-19 | VA-19 | F-10 | VA | B-18 |
| Example 3-20 | VA-20 | F-10 | VA | B-19 |
| Example 3-21 | VA-21 | F-16 | VA | B-20 |
| Example 3-22 | VA-22 | F-17 | VA | B-21 |
| Example 3-23 | VA-23 | F-18 | VA | B-22 |
| Example 3-24 | VA-24 | F-19 | VA | B-23 |
| Example 3-25 | VA-25 | F-20 | VA | B-24 |
| Example 3-26 | VA-26 | F-21 | VA | B-25 |
| Example 3-27 | VA-27 | F-25 | VA | B-30 |
| Example 3-28 | VA-28 | F-26 | VA | B-31 |
| Example 3-29 | VA-29 | F-27 | VA | B-32 |
| Example 3-30 | VA-30 | F-11 | VA | B-33 |
| Example 3-31 | VA-31 | F-11 | VA | B-34 |
| Example 3-32 | VA-32 | F-11 | VA | B-35 |
| Example 3-33 | VA-33 | F-11 | VA | B-36 |

### [Delamination of Polarizing Plate by Durability Test]

The liquid crystal display devices prepared in Example 3 were subjected to the durability test under the following two conditions.

(1) The liquid crystal display device was kept for 200 hours in an environment of 60° C. and 90% RH, then was taken out into an environment of 25° C. and 60% RH. After 24 hours, delamination of the polarizing plate from the liquid crystal panel was checked.
(2) The liquid crystal display was kept for 200 hours in an environment of 80° C. dry, then was taken out into an environment of 25° C. and 60% RH. After 1 hour, delamination of the polarizing plate from the liquid crystal panel was checked.

In the above-mentioned tests, no delamination of the polarizing plate from the liquid crystal panel was observed in the liquid crystal display device using the polarizing plate of the invention.

### [Leakage of Light]

Leakage of light was also evaluated under the two conditions employed for evaluating delamination of the polarizing plate. In the case of using any of the polarizing plates of the invention, no leakage of light was observed, thus good displaying performance being maintained.

### Example 4

### Mounting on IPS Panel

Each of the polarizing plates prepared in Examples 1 and 2 was punched out in a rectangular form so that, with the polarizing plate on the viewing side, the absorption axis of the polarizer became the longer side of 32″-wide size screen and, with the polarizing plate on the backlight side, the absorption axis of the polarizer became the shorter side. Polarizing plates and retardation plates in an IPS mode liquid crystal TV set “W32-L5000” (manufactured by Hitachi Ltd.) were removed from both sides, and the polarizing plates prepared in Examples 1 and 2 were laminated on both sides with a combination shown in Table 9, thus liquid crystal display devices IPS-1 being prepared.

After laminating the polarizing plates, the assembly was kept for 20 minutes at 50° C. and 5 kg/cm² (0.49 MPa) to stick. In this occasion, the polarizing plates were disposed so that absorption axis of the polarizing plate on the viewing side was in a horizontal direction of the panel and that absorption axis of the polarizing plate on the backlight side was in a vertical direction of the panel, with the adhesive material surface being on the liquid crystal cell side.

After peeling the protect film, the viewing angle (range where the contrast ratio was 10 or more) was calculated from luminance measured upon black display and upon white display using a measuring machine “EZ-Contrast 160D” (manufactured by ELDIM). With every polarizing plate, good viewing angle characteristics of 80° or more in polar angle were obtained in all directions.

Characteristic properties of the thus-obtained IPS mode liquid crystal display device were evaluated in the same manner as in Example 3.

TABLE 9

| | | Polarizing | | Polarizing |
|---|---|---|---|---|
| | | plate | | plate |
| | Liquid Crystal | No. on | | No. on |
| | Display Device | Viewing | Liquid | Backlight |
| | No. | Side | Crystal Cell | Side |
| Example 4 | IPS-1 | F-24 | IPS | B-29 |

### INDUSTRIAL APPLICABILITY

According to the invention, there is provided a polarizing plate which has a high optical compensatory performance and excellent reworkability and which does not suffer leakage of light at the periphery of the screen generated by change in temperature and humidity or when a liquid crystal display device is in a state of being continuously switched on, and a liquid crystal display device using the polarizing plate.

The entire disclosure of each and every foreign patent application from which the benefit of foreign priority has been claimed in the present application is incorporated herein by reference, as if fully set forth.

1. A polarizing plate comprising:
a first protective film;
a polarizer; and
a second protective film, in this order,
wherein at least one of the first protective film and the second protective film has an adhesive layer, and
wherein the at least one of the first protective film and the second protective film has a modulus of elasticity E satisfying numerical formula (1), and the adhesive layer undergoes creep deformation of less than 70 μm when a piece of which having a size of 10 mm in width and 10 mm in length is stuck on an alkali-free glass plate and a load of 200 g is applied thereto in an atmosphere of 50° C. for 1 hour:
500 MPa≦E≦3000 MPa. numerical formula (1)

2. The polarizing plate according to claim 1, wherein the adhesive layer undergoes creep deformation of less than 40 μm when a piece of which having a size of 10 mm in width and 10 mm in length is stuck on an alkali-free glass plate and a load of 200 g is applied thereto in an atmosphere of 25° C. for 1 hour.

3. The polarizing plate according to claim 1, wherein at least one of the first protective film and the second protective film has a retardation in plane of the film Re_{λ} and a retardation along a thickness of the film Rth_{λ} satisfying numerical formulae (2) and (3):
0≦Re₅₉₀≦200 numerical formula (2)
0≦Rth₅₉₀≦400 numerical formula (3)
wherein Re_{λ} and Rth_{λ} each represents a value at a wavelength of λ nm (unit: nm).

4. The polarizing plate according to claim 1,
wherein at least one of the first protective film and the second protective film is a film comprising a cellulose acylate obtained by substituting hydroxyl groups of glucose unit constituting cellulose with an acyl group containing 2 or more carbon atoms, and satisfying formulae (6) and (7):
2.0≦DS₂+DS₃+DS₆≦3.0 (6)
DS₆/(DS₂+DS₃+DS₆)≧0.315 (7)
wherein DS₂ represents a substitution degree of hydroxyl groups at 2-position of the glucose unit by the acyl group;
DS₃ represents a substitution degree of hydroxyl groups at 3-position of the glucose unit by the acyl group; and
DS₆ represents a substitution degree of hydroxyl groups at 6-position of the glucose unit by the acyl group.

5. The polarizing plate according to claim 4, wherein the acyl group is an acetyl group.

6. The polarizing plate according to claim 1,
wherein at least one of the first protective film and the second protective film is a film comprising a mixed fatty acid ester of a cellulose obtained by substituting hydroxyl groups of cellulose with an acetyl group and an acyl group containing 3 or more carbon atoms, and satisfying formulae (8) and (9):
2.0≦A+B≦3.0 (8)
0<B (9)
wherein A and B each represents a substitution degree of an acyl group substituting the hydroxyl groups of cellulose;
A represents a substitution degree by an acetyl group; and
B represents a substitution degree by an acyl group containing 3 or more carbon atoms.

7. The polarizing plate according to claim 1, wherein at least one of the first protective film and the second protective film is a film comprising a cyclic polyolefin film.

8. The polarizing plate according to claim 1, wherein the at least one of the first protective film and the second protective film comprises at least one retardation increasing agent comprising a rod-like compound or a discotic compound.

9. The polarizing plate according to claim 1, wherein an optically anisotropic layer is provided on the at least one of the first protective film and the second protective film.

10. The polarizing plate according to claim 1, wherein the at least one of the first protective film and the second protective film comprises at least one of a plasticizer, an ultraviolet ray absorbent, a peeling accelerator, a dye and a matt agent.

11. The polarizing plate according to claim 1, wherein the at least one of a hard coat layer, an anti-glare layer and an anti-reflection layer is provided on the at least one of the first protective film and the second protective film.

12. A liquid crystal display device comprising:
a liquid crystal cell; and
a pair of polarizing plates sandwiching the liquid crystal cell,
wherein the pair of polarizing plates includes a polarizing plate according to claim 1.

13. The liquid crystal display device according to claim 12, wherein the first protective film, which is provided on a liquid crystal cell side of the polarizing plate, has a modulus of elasticity E satisfying the numerical formula (1).

14. The liquid crystal display device according to claim 12, wherein the pair of polarizing plates is disposed so that transparent axes of the pair of polarizing plates cross at right angles with each other, and the transparent axes cross at right angles with, or are parallel to, sides of the polarizing plate.

15. The liquid crystal display device according to claim 12, wherein the liquid crystal cell is of VA mode.
